(19) United States
(12) Patent Application Publication
(10) Pub. No.: US 2023/0164305 A1
(43) Pub. Date: May 25, 2023

(54) INFORMATION PROCESSING DEVICE, INFORMATION PROCESSING METHOD, AND PROGRAM

(71) Applicant: SONY GROUP CORPORATION, TOKYO (JP)

(72) Inventor: SHO OGURA, TOKYO (JP)

(21) Appl. No.: 17/906,642

(22) PCT Filed: Feb. 12, 2021
(86) PCT No.: PCT/JP2021/005288

§ 371 Date: Sep. 19, 2022

(30) Foreign Application Priority Data
Mar. 30, 2020 (JP) 2020-061249

(51) Int. Cl. H04N 13/351; G06T 17/00; G06T 7/20; G06T 7/70

(52) U.S. Cl. CPC H04N 13/351; G06T 7/20; G06T 7/70; G06T 17/00

(57) ABSTRACT

An information processing device according to the present technology includes a display processing unit that performs processing of displaying a screen indicating, by filtering, camerawork information corresponding to input information of a user among a plurality of pieces of camerawork information, as a camerawork designation screen that receives designation operation of camerawork information that is information indicating at least a movement trajectory of a viewpoint in a free viewpoint image.

### TECHNICAL FIELD

The present technology relates to an information processing device, a method thereof, and a program, and particularly relates to a technology of processing related to a free viewpoint image in which a captured subject can be observed from an arbitrary viewpoint in a three-dimensional space.

### BACKGROUND ART

A technique for generating a free viewpoint image (is also referred to as a free viewpoint video, a virtual viewpoint image (video), or the like) corresponding to an observation image from an arbitrary viewpoint in a three-dimensional space on the basis of three-dimensional information representing a captured subject in the three-dimensional space is known.

Patent Document 1 below can be cited as related prior art. Patent Document 1 discloses a technique related to generation of a camerawork that can be said to be a movement trajectory of a viewpoint.

### CITATION LIST

### Patent Document

Patent Document 1: WO 2018/030206A

### SUMMARY OF THE INVENTION

### Problems to be Solved by the Invention

The free viewpoint image is also useful as broadcast content, and is also used as a replay image of sports broadcasting, for example. For example, in broadcast of soccer or basketball, a clip of several seconds such as a shoot scene is created from images recorded in real time, and broadcast as a replay image. Note that, in the present disclosure, the “clip” refers to an image of a certain scene created by cutting out or further processing from the recorded image.

Meanwhile, in a broadcasting site, particularly in the case of live broadcasting, it is required for an operator to quickly create a clip for replay and broadcast the clip. For example, there is also a demand for broadcasting a replay 10 seconds after a certain play. Such a demand is similarly applied to the creation of the clip including the free viewpoint image, and thus, it is required to quickly perform the creation work of the free viewpoint image.

The present technology has been made in view of the above circumstances, and an object of the present technology is to enable creation work of a free viewpoint image to be quickly executed.

### Solutions to Problems

An information processing device according to the present technology includes a display processing unit that performs processing of displaying a screen indicating, by filtering, camerawork information corresponding to input information of a user among a plurality of pieces of camerawork information, as a camerawork designation screen that receives designation operation of camerawork information that is information indicating at least a movement trajectory of a viewpoint in a free viewpoint image.

By filtering and displaying the camerawork information according to the input information of the user, it is possible to easily find the camerawork information desired by the user, and shorten the time required for designating the camerawork information.

In the above-described information processing device according to the present technology, the display processing unit may be configured to perform processing of filtering and displaying camerawork information according to a keyword as the input information on the camerawork designation screen.

Thus, it is possible to perform appropriate filtering of the camerawork information reflecting the intention of the user.

In the above-described information processing device according to the present technology, it is possible to configure such that filtering condition information indicating a filtering condition of camerawork information is displayed on the camerawork designation screen, and the display processing unit performs processing of filtering and displaying the camerawork information according to the filtering condition indicated by the selected filtering condition information as the input information.

As a result, the operation required for the filtering and displaying of the camerawork information can be reduced to only the operation of selecting the filtering condition information.

In the above-described information processing device according to the present technology, the display processing unit may be configured to perform processing of displaying information obtained by visualizing a movement trajectory of the viewpoint on the camerawork designation screen.

By displaying the information visualizing the movement trajectory of the viewpoint, it is easy for the user to image the camerawork.

In the above-described information processing device according to the present technology, the display processing unit may be configured to perform processing of displaying, on the camerawork designation screen, camera arrangement position information indicating arrangement positions of a plurality of cameras that performs imaging for generating a free viewpoint image.

By displaying the information indicating the arrangement position of each camera, the user can easily image what kind of image should be generated as a free viewpoint image.

In the above-described information processing device according to the present technology, the display processing unit may be configured to perform processing of displaying, on the camerawork designation screen, start point arrangement position information and end point arrangement position information indicating respective positions of a camera serving as a movement start point and a camera serving as a movement end point of the viewpoint among the plurality of cameras.

As a result, it is possible to allow the user to grasp from which camera position the movement of the viewpoint starts and ends at which camera position in the camerawork.

In the above-described information processing device according to the present technology, the display processing unit may be configured to perform processing of displaying the start point arrangement position information and the end point arrangement position information, and arrangement position information of cameras other than the camera serving as the movement start point and the camera serving as the movement end point among the plurality of cameras in different modes.

As a result, it is possible to allow the user to intuitively grasp from which camera position the movement of the viewpoint starts and ends at which camera position in the camerawork.

In the above-described information processing device according to the present technology, the display processing unit may be configured to perform processing of displaying information obtained by visualizing the moving speed of the viewpoint on the camerawork designation screen.

The period in which the moving speed of the viewpoint is changed in the period in which the viewpoint is moved is an important factor in the drawing of the free viewpoint image.

In the above-described information processing device according to the present technology, the display processing unit may be configured to perform processing of displaying information indicating a period in which the moving speed decreases as information obtained by visualizing the moving speed of the viewpoint.

The period in which the moving speed of the viewpoint is decreased in the period in which the viewpoint is moved is an important factor in the drawing of the free viewpoint image.

In the above-described information processing device according to the present technology, the display processing unit may be configured to perform processing of displaying information obtained by visualizing a field of view from the viewpoint on the camerawork designation screen.

Since the field of view is visually indicated, it is possible to facilitate grasping of the camerawork by the user.

In the above-described information processing device according to the present technology, the display processing unit may be configured to perform processing of displaying a target that defines a line-of-sight direction from the viewpoint on the camerawork designation screen.

As a result, it is possible to allow the user to easily grasp which position of the subject in the three-dimensional space the camerawork is targeted for.

The above-described information processing device according to the present technology can be configured to include a camerawork editing processing unit that updates information on the position of the target in camerawork information according to a change in the position of the target on the camerawork designation screen.

As a result, when it is desired to edit the camerawork information at the stage of designating the camerawork information to be used for generation of the free viewpoint image, it is not necessary to start software for generating the camerawork information.

In the above-described information processing device according to the present technology, the display processing unit may be configured to perform processing of displaying an image obtained by observing a three-dimensional space from the viewpoint on the camerawork designation screen.

As a result, an image similar to the free viewpoint image generated on the basis of the camerawork information can be displayed as a preview to the user, and grasping of the camerawork can be facilitated.

In the above-described information processing device according to the present technology, the display processing unit may be configured to perform processing of displaying an image obtained by rendering a virtual three-dimensional model of a real space as an image obtained by observing a three-dimensional space from the viewpoint.

As a result, when the preview display of the observation image from the viewpoint is realized, it is not necessary to perform the rendering processing using the three-dimensional model generated from the captured image of the target real space.

In the above-described information processing device according to the present technology, the display processing unit may be configured to perform processing of displaying information notifying a camera in which a change in the field of view has been detected among the plurality of cameras.

In generating a free viewpoint image, in order to accurately generate three-dimensional information from images captured by a plurality of cameras, it is necessary for each camera to maintain an assumed position and orientation in advance, and in a case where a change in position and orientation occurs in any camera, it is necessary to calibrate parameters used for generating three-dimensional information. By notifying the camera in which the change in the field of view is detected as described above, it is possible to notify the user of the camera that requires calibration.

An information processing method according to the present technology is an information processing method in which an information processing device performs processing of displaying a screen indicating, by filtering, camerawork information corresponding to input information of a user among a plurality of pieces of camerawork information, as a camerawork designation screen that receives designation operation of camerawork information that is information indicating at least a movement trajectory of a viewpoint in a free viewpoint image.

Also by such an information processing method according to the present technology, the same effects as those of the information processing device according to the present technology described above can be obtained.

A program according to the present technology is a program that can be read by a computer device, and causes the computer device to implement a function of performing processing of displaying a screen indicating, by filtering, camerawork information corresponding to input information of a user among a plurality of pieces of camerawork information, as a camerawork designation screen that receives designation operation of camerawork information that is information indicating at least a movement trajectory of a viewpoint in a free viewpoint image.

With such a program, the information processing device according to the present technology described above is realized.

### BRIEF DESCRIPTION OF DRAWINGS

FIG. 1 is a block diagram of a system configuration according to an embodiment of the present technology.

FIG. 2 is an explanatory diagram of an arrangement example of cameras for generating a free viewpoint image according to the embodiment.

FIG. 3 is a block diagram of a hardware configuration of the information processing device according to the embodiment.

FIG. 4 is an explanatory diagram of functions of an image creation controller according to an embodiment.

FIG. 5 is an explanatory diagram of functions of a free viewpoint image server according to the embodiment.

FIGS. 6A and 6B are explanatory diagrams of a viewpoint in a free viewpoint image according to the embodiment.

FIG. 7 is an explanatory diagram of an outline of a camerawork designation screen in the embodiment.

FIG. 8 is an explanatory diagram of an outline of a creation operation screen according to the embodiment.

FIG. 9 is an explanatory diagram of an output clip according to the embodiment.

FIG. 10 is an explanatory diagram of an output clip including a still image FV clip according to the embodiment.

FIG. 11 is an explanatory diagram of an output clip including a moving image FV clip according to the embodiment.

FIG. 12 is an explanatory diagram of an example of an image of an output clip according to the embodiment.

FIG. 13 is an explanatory diagram of a work procedure of clip creation according to the embodiment.

FIG. 14 is an explanatory diagram of a work procedure of camera variation detection according to the embodiment.

FIG. 15 is a diagram illustrating an initial screen of a creation operation screen according to the embodiment.

FIG. 16 is a diagram for describing an example of an operation for acquiring a preset list of cameras.

FIG. 17 is an explanatory diagram of change of a background 3D model.

FIG. 18 is similarly an explanatory diagram of the change of the background 3D model.

FIG. 19 is an explanatory diagram of addition of an entry of camerawork.

FIG. 20 is similarly an explanatory diagram of an example of displaying a field of view and an observation image of a designated camera.

FIG. 21 is similarly an explanatory diagram of an example of displaying a field of view and an observation image of a designated camera.

FIG. 22 is an explanatory diagram of an example of a method of designating an In-camera.

FIG. 23 is a diagram illustrating a screen display example in a case where an In-camera is designated.

FIG. 24 is an explanatory diagram of an example of a method of designating an Out-camera.

FIG. 25 is a diagram illustrating a screen display example in a case where an Out-camera is designated.

FIG. 26 is an explanatory diagram of a screen display change according to the operation of a seek bar in a timeline operation unit.

FIG. 27 is an explanatory diagram of an example of a method of designating a via-point of a viewpoint.

FIG. 28 is similarly an explanatory diagram of an example of a method of designating a via-point of a viewpoint.

FIG. 29 is an explanatory diagram of a screen display example in a case where designation of a via-point of a viewpoint is completed.

FIG. 30 is an explanatory diagram of a screen display example in a case where a plurality of via-points is designated.

FIG. 31 is a diagram for describing an example of a method of designating a shape type of a movement trajectory of a viewpoint.

FIG. 32 is similarly a diagram for describing an example of a method of designating the shape type of the movement trajectory of the viewpoint.

FIG. 33 is an explanatory diagram of a screen display example in a case where the shape type of the movement trajectory of the viewpoint is designated.

FIG. 34 is a diagram for describing an example of a method of designating a moving speed of a viewpoint.

FIG. 35 is an explanatory diagram of a screen display example in a case where a moving speed of a viewpoint is designated.

FIG. 36 is an explanatory diagram of significance of a target in an embodiment.

FIG. 37 is similarly an explanatory diagram of the significance of a target in the embodiment.

FIG. 38 is an explanatory diagram of designation of movement of a target according to the embodiment.

FIG. 39 is similarly an explanatory diagram of designation of movement of a target according to the embodiment.

FIG. 40 is similarly an explanatory diagram of designation of movement of a target according to the embodiment.

FIG. 41 is similarly an explanatory diagram of designation of movement of a target according to the embodiment.

FIG. 42 is similarly an explanatory diagram of designation of movement of a target according to the embodiment.

FIG. 43 is an explanatory diagram of an exemplary operation of designating a period of facing a target.

FIG. 44 is similarly an explanatory diagram of an exemplary operation of designating a period of facing a target.

FIG. 45 is similarly an explanatory diagram of an exemplary operation of designating a period of facing a target.

FIG. 46 is a diagram illustrating a display example of a preview image in a case where a target movement is designated.

FIG. 47 is similarly a diagram illustrating a display example of a preview image in a case where a target movement is designated.

FIG. 48 is similarly a diagram illustrating a display example of a preview image in a case where a target movement is designated.

FIG. 49 is similarly a diagram illustrating a display example of a preview image in a case where a target movement is designated.

FIG. 50 is a diagram illustrating another setting example for a period of facing a target.

FIG. 51 is an explanatory diagram of an example of individually designating periods of facing a plurality of added targets.

FIG. 52 is a flowchart of processing related to generation and display of a viewpoint movement trajectory according to designation of an In-camera and an Out-camera.

FIG. 53 is a flowchart illustrating processing related to generation and display of a viewpoint movement trajectory according to designation of a via-point.

FIG. 54 is a diagram illustrating an initial screen of a camerawork designation screen according to the embodiment.

FIG. 55 is an explanatory diagram of an example of a method of importing images used for generating a free viewpoint image.

FIG. 56 is similarly an explanatory diagram of an example of a method of importing images used for generating a free viewpoint image.

FIG. 57 is a diagram illustrating a screen display example after image import.

FIG. 58 is a view illustrating a display example of an image of an X-axis viewpoint.

FIG. 59 is a view illustrating a display example of an image of a Y-axis viewpoint.

FIG. 60 is a view illustrating a display example of an image of a Z-axis viewpoint.

FIG. 61 is a diagram illustrating a display example of an image of a Pe viewpoint.

FIG. 62 is a diagram illustrating a display example of an image from a Ca viewpoint.

FIG. 63 is a diagram for describing an operation procedure example for filtering and displaying of camerawork.

FIG. 64 is a diagram illustrating an example of filtering and displaying of camerawork.

FIG. 65 is an explanatory diagram of a reset button of the filtering operation unit according to the embodiment.

FIG. 66 is an explanatory diagram of a modification of the filtering operation unit.

FIG. 67 is an explanatory diagram of another modification of the filtering operation unit.

FIG. 68 is a diagram illustrating a display example of visualization information of a moving speed of a viewpoint.

FIG. 69 is a diagram illustrating another display example of the visualization information of the moving speed of the viewpoint.

FIG. 70 is an explanatory diagram of editing of a target position on a camerawork designation screen according to the embodiment.

FIG. 71 is similarly an explanatory diagram of editing of a target position on the camerawork designation screen according to the embodiment.

FIG. 72 is a diagram illustrating a display example of notification information of a camera in which variation is detected.

FIG. 73 is a flowchart illustrating processing related to filtering of camerawork based on tag information displayed on a screen.

FIG. 74 is a flowchart illustrating processing related to filtering of a camerawork corresponding to an input keyword.

FIG. 75 is a flowchart illustrating processing related to notification of a camera that requires calibration.

### MODE FOR CARRYING OUT THE INVENTION

### 1. System Configuration

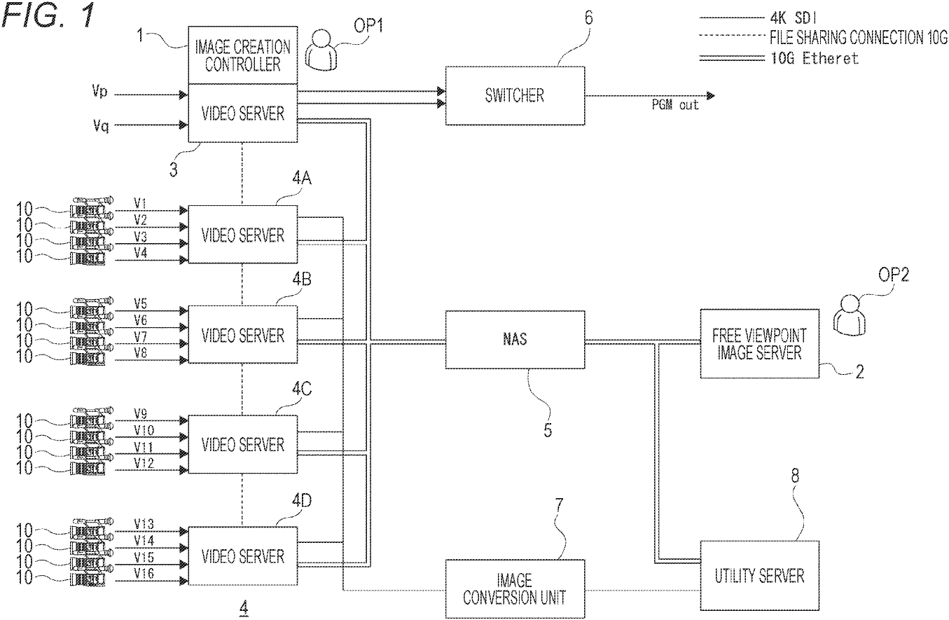

FIG. 1 illustrates a configuration example of an image processing system according to an embodiment of the present technology.

The image processing system includes an image creation controller 1, a free viewpoint image server 2, a video server 3, a plurality of (for example, four) video servers 4A, 4B, 4C, and 4D, a network attached storage (NAS) 5, a switcher 6, an image conversion unit 7, a utility server 8, and a plurality of (for example, sixteen) imaging devices 10.

Hereinafter, the term “camera” refers to the imaging device 10. For example, “camera arrangement” means arrangement of a plurality of imaging devices 10.

In addition, when the video servers 4A, 4B, 4C, and 4D are collectively referred to without being particularly distinguished, they are referred to as “video servers 4”.

In this image processing system, a free viewpoint image corresponding to an observation image from an arbitrary viewpoint in a three-dimensional space can be generated on the basis of captured images (for example, image data V1 to V16) acquired from a plurality of imaging devices 10, and an output clip including the free viewpoint image can be created.

In FIG. 1, the connection state of each part is indicated by a solid line, a broken line, and a double line.

A solid line indicates connection of a serial digital interface (SDI) which is an interface standard for connecting broadcast devices such as a camera and a switcher, and supports 4K, for example. The image data is mainly transmitted and received between the devices by the SDI wiring.

The double line indicates connection of a communication standard for constructing a computer network, for example, 10 Gigabit Ethernet. The image creation controller 1, the free viewpoint image server 2, the video servers 3, 4A, 4B, 4C, and 4D, the NAS 5, and the utility server 8 are connected by a computer network, so that image data and various control signals can be transmitted and received to and from each other.

A broken line between the video servers 3 and 4 indicates a state in which the video servers 3 and 4 equipped with the inter-server file sharing function are connected via, for example, a 10G network. As a result, between the video server 3 and the video servers 4A, 4B, 4C, and 4D, each video server can preview and send materials in other video servers. That is, a system using a plurality of video servers is constructed, and efficient highlight editing and sending can be realized.

Each imaging device 10 is configured as a digital camera device including an imaging element such as a charge coupled device (CCD) sensor or a complementary metal-oxide-semiconductor (CMOS) sensor, for example, and obtains captured images (image data V1 to V16) as digital data. In this example, each imaging device 10 obtains a captured image as a moving image.

In this example, each imaging device 10 captures an image of a situation in which a competition such as basketball or soccer is being held, and each imaging device is arranged in a predetermined orientation at a predetermined position in a competition site where the competition is held. In this example, the number of imaging devices 10 is sixteen, but the number of imaging devices 10 may be at least two or more to enable generation of a free viewpoint image. By increasing the number of imaging devices 10 and imaging a target subject from a larger number of angles, the accuracy of three-dimensional restoration of the subject can be improved, and the image quality of the virtual viewpoint image can be improved.

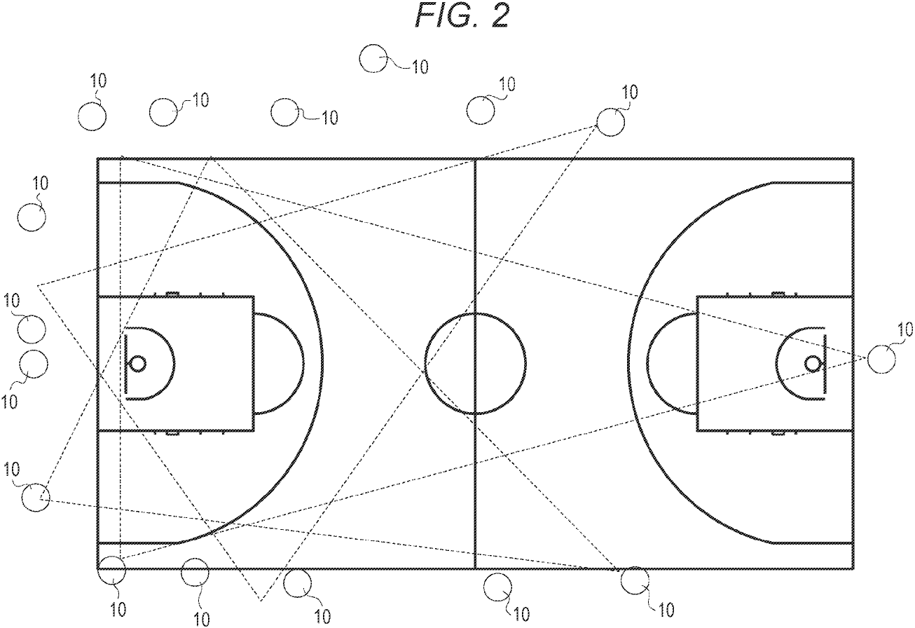

FIG. 2 illustrates an arrangement example of the imaging device 10 around a basketball court. It is assumed that circles (o) are the imaging devices 10. For example, this is a camera arrangement example in a case where it is desired to mainly shoot the vicinity of the goal on the left side in the drawing. Naturally, the arrangement and number of cameras are examples, and should be set according to the content and purpose of photographing and broadcasting.

The image creation controller 1 includes an information processing device. The image creation controller 1 can be realized using, for example, a dedicated workstation, a general-purpose personal computer, a mobile terminal device, or the like.

The image creation controller 1 performs control/operation management of the video servers 3 and 4 and processing for creating clips.

As an example, the image creation controller 1 is a device operable by the operator OP1. For example, the operator OP1 selects a clip content and gives an instruction to create the clip.

The free viewpoint image server 2 is configured as an information processing device that actually performs a process of creating a free viewpoint image (free view (FV) clip to be described later) according to an instruction from the image creation controller 1 or the like. The free viewpoint image server 2 can also be realized using, for example, a dedicated workstation, a general-purpose personal computer, a mobile terminal device, or the like.

As an example, the free viewpoint image server 2 is a device that can be operated by the operator OP2. The operator OP2 performs, for example, work related to creation of an FV clip as a free viewpoint image. Specifically, the operator OP2 performs a designation operation (selection operation) of the camerawork for generating the free viewpoint image. In this example, the operator OP2 also performs work of creating a camerawork.

Configurations and processes of the image creation controller 1 and the free viewpoint image server 2 will be described later in detail. In addition, the operators OP1 and OP2 perform operations, but for example, the image creation controller 1 and the free viewpoint image server 2 may be arranged side by side and operated by one operator.

Each of the video servers 3 and 4 is an image recording device, and includes, for example, a data recording unit such as a solid state drive (SSD) or a hard disk drive (HDD), and a control unit that controls data recording and reproduction of the data recording unit.

Each of the video servers 4A, 4B, 4C, and 4D can receive inputs from four systems, for example, and each video server simultaneously records images captured by the four imaging devices 10.

For example, the video server 4A records the image data V1, V2, V3, and V4. The video server 4B records the image data V5, V6, V7, and V8. The video server 4C records the image data V9, V10, V11, and V12. The video server 4D records the image data V13, V14, V15, and V16.

As a result, all the images captured by the sixteen imaging devices 10 are simultaneously recorded.

The video servers 4A, 4B, 4C, and 4D perform constant recording, for example, during a sports game to be broadcast.

The video server 3 is directly connected to the image creation controller 1, for example, and can receive inputs from two systems and output data to two systems, for example. Pieces of image data Vp and Vq are illustrated as inputs of two systems. As the image data Vp and Vq, images captured by any two imaging devices 10 (any two of the pieces of image data V1 to V16) can be selected. Naturally, the captured image may be an image captured by another imaging device.

The image creation controller 1 can display the image data Vp and Vq on the display as monitor images. The operator OP1 can check the situation of the scene captured and recorded for broadcasting, for example, by the image data Vp and Vq input to the video server 3.

In addition, since the video servers 3 and 4 are connected to the file sharing state, the image creation controller 1 can monitor and display the images captured by the imaging devices 10 recorded in the video servers 4A, 4B, 4C, and 4D, and the operator OP1 can sequentially check the captured images.

Note that, in this example, a time code is attached to an image captured by each imaging device 10, and frame synchronization can be achieved in processing in the video servers 3, 4A, 4B, 4C, and 4D.

The NAS 5 is a storage device arranged on a network, and includes, for example, an SSD, an HDD, or the like. In the case of this example, the NAS 5 is a device that stores for processing in the free viewpoint image server 2 or stores the created free viewpoint image when some frames of the image data V1, V2, ..., V16 recorded in the video servers 4A, 4B, 4C, and 4D are transferred for generating the free viewpoint image.

The switcher 6 is a device that inputs an image output via the video server 3 and selects the main line image PGMout to be finally selected and broadcast. For example, a broadcast director or the like performs necessary operations.

The image conversion unit 7 performs, for example, resolution conversion and synthesis of image data by the imaging device 10, generates a monitoring image of the camera arrangement, and supplies the monitoring image to the utility server 8. For example, sixteen systems of image data (V1 to V16) to be 8K images are converted into four systems of images arranged in a tile shape after resolution conversion into 4K images, and the four systems of images are supplied to the utility server 8.

The utility server 8 is a computer device capable of performing various related processes. In this example, the utility server 8 is a device that performs a process of detecting a camera movement for calibration. For example, the utility server 8 monitors image data from the image conversion unit 7 to detect camera movement. The camera movement is, for example, movement of any one of arrangement positions of the imaging devices 10 arranged as illustrated in FIG. 2. The information of the arrangement position of the imaging device 10 is an important factor for generating the free viewpoint image, and it is necessary to redo the parameter setting when the arrangement position changes. Therefore, camera movement is monitored.

### 2. Configuration of Image Creation Controller and Free Viewpoint Image Server

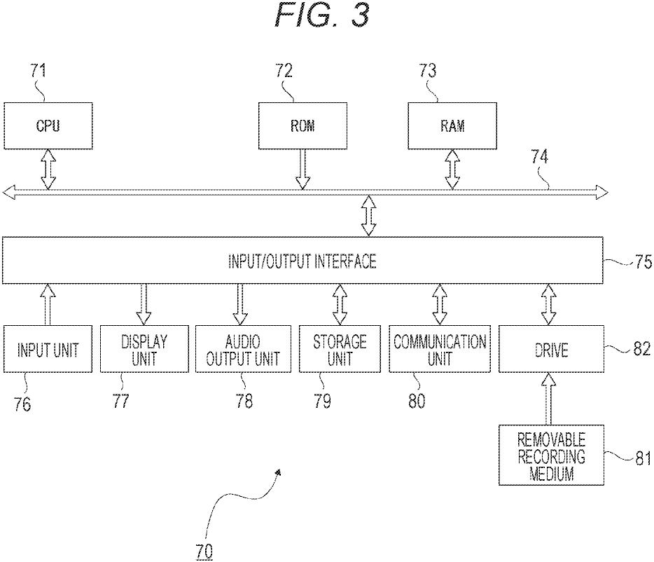

The image creation controller 1, the free viewpoint image server 2, the video servers 3 and 4, and the utility server 8 having the above configuration can be realized as the information processing device 70 having the configuration illustrated in FIG. 3, for example.

In FIG. 3, a CPU 71 of the information processing device 70 executes various processes according to a program stored in the ROM 72 or a program loaded from the storage unit 79 to the RAM 73. The RAM 73 also appropriately stores data and the like necessary for the CPU 71 to execute various processes.

The CPU 71, the ROM 72, and the RAM 73 are connected to one another via a bus 74. An input/output interface 75 is also connected to the bus 74.

An input unit 76 including an operator and an operation device is connected to the input/output interface 75.

For example, as the input unit 76, various operators and operation devices such as a keyboard, a mouse, a key, a dial, a touch panel, a touch pad, and a remote controller are assumed.

An operation of the user is detected by the input unit 76, and a signal corresponding to the input operation is interpreted by the CPU 71.

Furthermore, a display unit 77 configured of a liquid crystal display (LCD), an organic electro-luminescence (EL) panel, or the like, and a sound output unit 78 configured of a speaker or the like are integrally or separately connected to the input/output interface 75.

The display unit 77 is a display unit that performs various displays, and includes, for example, a display device provided in a housing of the information processing device 70, a separate display device connected to the information processing device 70, or the like.

The display unit 77 executes display of an image for various types of image processing, a moving image to be processed, and the like on a display screen on the basis of an instruction from the CPU 71. In addition, the display unit 77 displays various operation menus, icons, messages, and the like, that is, displays as a graphical user interface (GUI) on the basis of an instruction from the CPU 71.

In some cases, a storage unit 79 including a hard disk, a solid-state memory, or the like, and a communication unit 80 configured of a modem or the like are connected to the input/output interface 75.

The communication unit 80 performs communication processing via a transmission path such as the Internet, wired/wireless communication with various devices, bus communication, and the like.

A drive 82 is also connected to the input/output interface 75 as necessary, and a removable recording medium 81 such as a magnetic disk, an optical disk, a magneto-optical disk, or a semiconductor memory is appropriately mounted.

A data file such as an image file MF, various computer programs, and the like can be read from the removable recording medium 81 by the drive 82. The read data file is stored in the storage unit 79, and images and sounds included in the data file are output by the display unit 77 and the sound output unit 78. Furthermore, the computer program and the like read from the removable recording medium 81 are installed in the storage unit 79 as necessary.

In the information processing device 70, software can be installed via network communication by the communication unit 80 or the removable recording medium 81. Alternatively, the software may be stored in advance in the ROM 72, the storage unit 79, or the like.

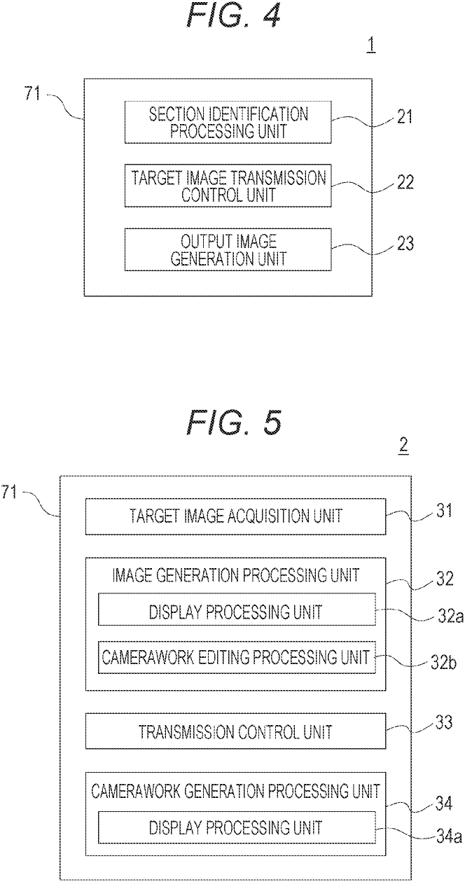

In a case where the image creation controller 1 and the free viewpoint image server 2 are realized using such an information processing device 70, the processing functions as illustrated in FIGS. 4 and 5 are realized in the CPU 71 by software, for example.

FIG. 4 illustrates a section identification processing unit 21, a target image transmission control unit 22, and an output image generation unit 23 as functions formed in the CPU 71 of the information processing device 70 serving as the image creation controller 1.

The section identification processing unit 21 performs processing of identifying a generation target image section as a generation target of a free viewpoint image for a plurality of captured images (image data V1 to V16) simultaneously captured by the plurality of imaging devices 10. For example, in response to the operator OP1 performing an operation of selecting a scene to be replayed in the image, processing of specifying a time code for the scene, in particular, a section (generation target image section) of the scene to be a free viewpoint image, and notifying the free viewpoint image server 2 of the time code is performed.

Here, the generation target image section refers to a frame section actually used as a free viewpoint image. In a case where a free viewpoint image is generated for one frame in a moving image, the one frame is the generation target image section. In this case, the in-point and the out-point for the free viewpoint image have the same time code.

Furthermore, in a case where a free viewpoint image is generated for a section of a plurality of frames in a moving image, the plurality of frames is the generation target image section. In this case, the in-point and the out-point for the free viewpoint image are different time codes.

Note that, although the structure of the clip will be described later, it is assumed that the in-point/out-point of the generation target image section is different from the in-point/out-point as the output clip to be finally generated. This is because a front clip and a rear clip, which will be described later, are coupled.

The target image transmission control unit 22 performs control to transfer image data of the generation target image section in each of the plurality of captured images 10, that is, one or a plurality of frames of the image data V1 to V16, as image data to be used for generating a free viewpoint image in the free viewpoint image server 2. Specifically, control is performed to transfer the image data as the generation target image section from the video servers 4A, 4B, 4C, and 4D to the NAS 5.

The output image generation unit 23 performs a process of generating an output image (output clip) including the free viewpoint image (FV clip) generated and received by the free viewpoint image server 2.

For example, by the processing of the output image generation unit 23, the image creation controller 1 combines, on the time axis, a front clip that is an actual moving image at a previous time point and a rear clip that is an actual moving image at a subsequent time point with an FV clip that is a virtual image generated by the free viewpoint image server 2 to obtain an output clip. That is, the front clip + the FV clip + the rear clip are set as one output clip.

Naturally, the front clip + FV clip may be one output clip.

Alternatively, the FV clip + the rear clip may be one output clip.

Further, an output clip of only the FV clip may be generated without coupling the front clip and the rear clip.

In any case, the image creation controller 1 generates an output clip including the FV clip, outputs the output clip to the switcher 6, and can use the output clip for broadcasting.

FIG. 5 illustrates a target image acquisition unit 31, an image generation processing unit 32, a transmission control unit 33, and a camerawork generation processing unit 34 as functions formed in the CPU 71 of the information processing device 70 serving as the free viewpoint image server 2.

The target image acquisition unit 31 performs processing of acquiring image data of a generation target image section as a generation target of a free viewpoint image in each of a plurality of captured images (image data V1 to V16) simultaneously captured by the plurality of imaging devices 10. That is, image data of one or a plurality of frames designated by the in-point/out-point of the generation target image section specified by the function of the section identification processing unit 21 by the image creation controller 1 can be acquired from the video servers 4A, 4B, 4C, and 4D via the NAS 5 and used for generating a free viewpoint image.

For example, the target image acquisition unit 31 acquires image data of one or a plurality of frames of the generation target image section for all of the pieces of image data V1 to V16. The image data of the generation target image section is acquired for all of the pieces of image data V1 to V16 in order to generate a high-quality free viewpoint image. As described above, it is possible to generate a free viewpoint image using images captured by at least two or more imaging devices 10. However, by increasing the number of imaging devices 10 (that is, the number of viewpoints), it is possible to generate a finer 3D model and generate a high-quality free viewpoint image. Therefore, for example, in a case where sixteen imaging devices 10 are arranged, the image data of the generation target image section is acquired for all the pieces of image data (V1 to V16) of the sixteen imaging devices 10.

The image generation processing unit 32 is a function of generating a free viewpoint image, that is, an FV clip in this example, using the image data acquired by the target image acquisition unit 31.

For example, the image generation processing unit 32 performs modeling processing including 3D model generation and subject analysis, and processing such as rendering for generating a free viewpoint image that is a two-dimensional image from the 3D model.

The 3D model generation is processing of generating 3D model data representing the subject in a three-dimensional space (that is, the three-dimensional structure of the subject is restored from the two-dimensional image) on the basis of the image captured by each imaging device 10 and the camera parameter for each imaging device 10 input from the utility server 8 or the like, for example. Specifically, the 3D model data includes data representing the subject in a three-dimensional coordinate system of (X, Y, Z).

In the subject analysis, a position, an orientation, and a posture of a subject as a person (player) are analyzed on the basis of the 3D model data. Specifically, estimation of the position of the subject, generation of a simple model of the subject, estimation of the orientation of the subject, and the like are performed.

Then, a free viewpoint image is generated on the basis of the 3D model data and the subject analysis information. For example, a free viewpoint image is generated such that the viewpoint is moved with respect to a 3D model in which a player as a subject is stationary.

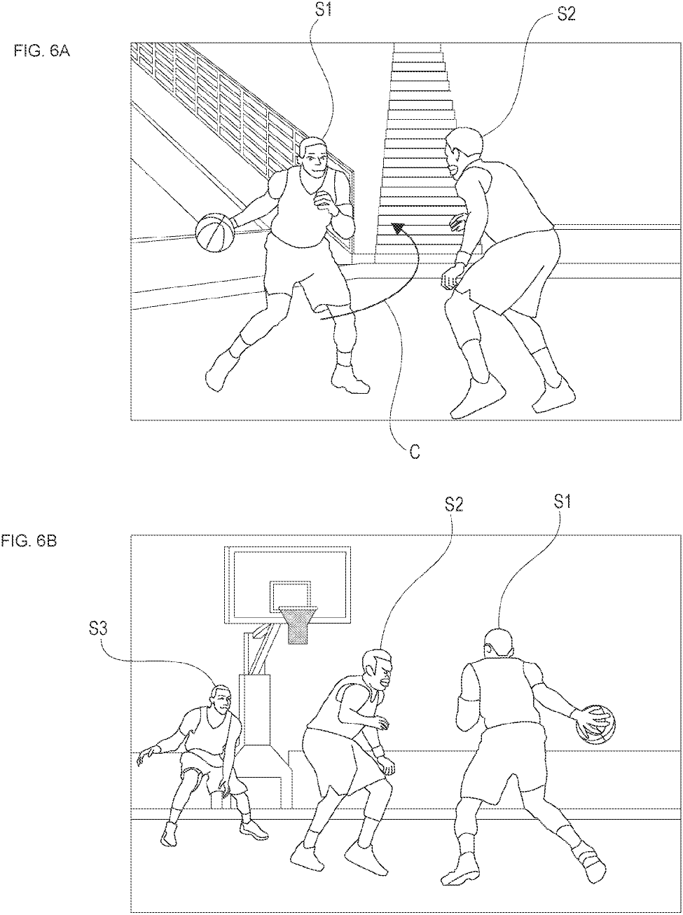

The viewpoint of the free viewpoint image will be described with reference to FIGS. 6A and 6B.

FIG. 6A illustrates an image of a free viewpoint image in which a subject is captured from a required viewpoint set in a three-dimensional space. In the free viewpoint image in this case, the subject S1 is viewed from substantially the front, and the subject S2 is viewed from substantially the back.

FIG. 6B illustrates an image of a virtual viewpoint image in a case where the position of the viewpoint is changed in the direction of the arrow C in FIG. 6A and the viewpoint for viewing the subject S1 substantially from the back is set. In the free viewpoint image of FIG. 6B, the subject S2 is viewed from substantially the front, and the subject S3 and the basket goal, which are not illustrated in FIG. 6A, are illustrated.

For example, the viewpoint is gradually moved in the direction of the arrow C from the state of FIG. 6A, and an image of about 1 second to 2 seconds leading to the state of FIG. 6B is generated as a free viewpoint image (FV clip). Naturally, the time length of the FV clip as the free viewpoint image and the trajectory of the viewpoint movement can be variously considered.

Here, the free viewpoint image server 2 (CPU 71) of this example has a function as the display processing unit 32a as a part of the function of the image generation processing unit 32.

The display processing unit 32a performs processing of displaying the camerawork designation screen Gs that receives the designation operation of the camerawork information used for generating the free viewpoint image. Note that details of the camerawork related to the free viewpoint image and the camerawork designation screen Gs will be described later again.

Furthermore, the free viewpoint image server 2 in this example also has a function as the camerawork editing processing unit 32b as a part of the function of the image generation processing unit 32, but the function as the camerawork editing processing unit 32b will also be described later.

The transmission control unit 33 performs control to transmit the free viewpoint image (FV clip) generated by the image generation processing unit 32 to the image creation controller 1 via the NAS 5. In this case, the transmission control unit 33 also controls to transmit accompanying information for generating an output image to the image creation controller 1. The accompanying information is assumed to be information designating images of the front clip and the rear clip. That is, it is information designating which image of the image data V1 to V16 is used to create (cut out) the front clip and the rear clip. In addition, information designating the time length of the front clip or the rear clip is also assumed as the accompanying information.

The camerawork generation processing unit 34 performs processing related to generation of camerawork information used for generation of a free viewpoint image. In creating the free viewpoint image, a plurality of candidate cameraworks is created in advance to cope with various scenes. In order to enable such pre-creation of the camerawork, a software program for creating the camerawork is installed in the free viewpoint image server 2 of this example. The camerawork generation processing unit 34 is a function realized by this software program, and performs a camerawork generation process on the basis of an operation input of the user.

The camerawork generation processing unit 34 has a function as a display processing unit 34a. The display processing unit 34a performs processing of displaying the creation operation screen Gg so as to enable reception of various operation inputs for creating the camerawork by the user (the operator OP2 in this example).

### 3. Outline of GUI

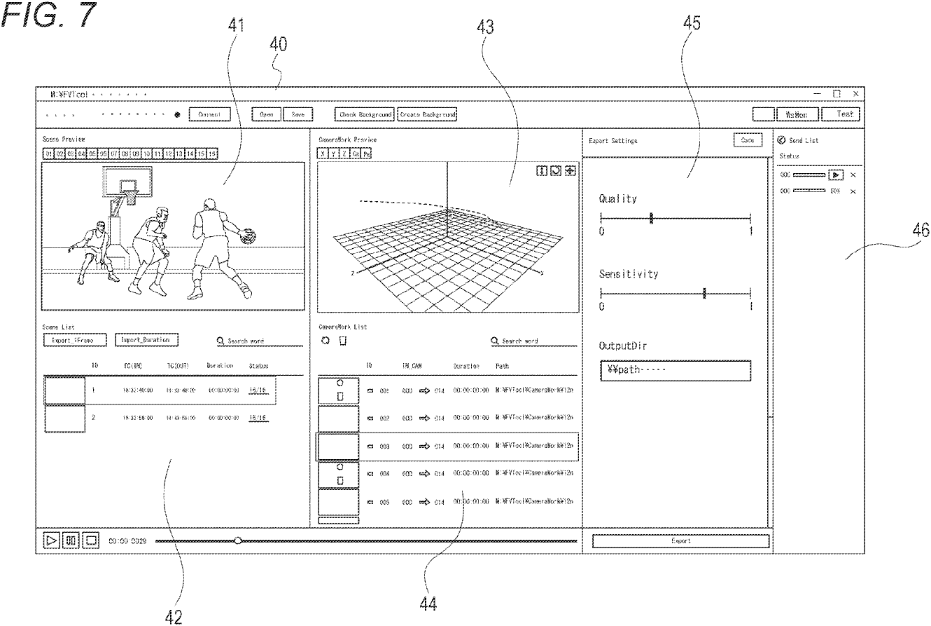

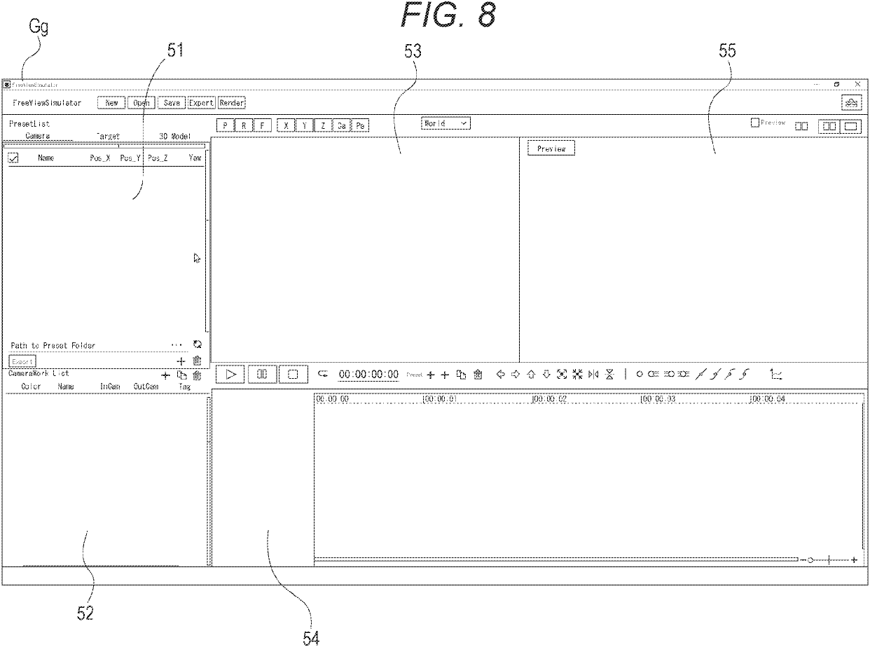

With reference to FIGS. 7 and 8, an outline of the camerawork designation screen Gs used for creating the free viewpoint image and the creation operation screen Gg used for creating the camerawork will be described. In this example, the camerawork designation screen Gs and the creation operation screen Gg are displayed on the display unit 77 in the free viewpoint image server 2, for example, and can be checked and operated by the operator OP2.

On the camerawork designation screen Gs illustrated in FIG. 7, a scene window 41, a scene list display unit 42, a camerawork window 43, a camerawork list display unit 44, a parameter display unit 45, and a transmission window 46 are arranged.

In the scene window 41, for example, monitor display of the image of the generation target image section is performed, and the operator OP2 can check the content of the scene in which the free viewpoint image is generated.

For example, a list of scenes designated as the generation target image section is displayed on the scene list display unit 42. The operator OP2 can select a scene to be displayed in the scene window 41 on the scene list display unit 42.

In the camerawork window 43, the position of the arranged imaging device 10, the selected camerawork, a plurality of selectable cameraworks, or the like is displayed.

Here, the camerawork information is information indicating at least a movement trajectory of the viewpoint in the free viewpoint image. For example, in a case of creating an FV clip in which the position of the viewpoint, the line-of-sight direction, and the angle of view (focal length) are changed with respect to the subject for which the 3D model has been generated, the parameters necessary for defining the movement trajectory of the viewpoint, the change mode of the line-of-sight direction, and the change mode of the angle of view are the camerawork information.

In the camerawork window 43, at least information visualizing and indicating the movement trajectory of the viewpoint is displayed as the display of the camerawork.

The camerawork list display unit 44 displays a list of pieces of information of various types of cameraworks created and stored in advance. The operator OP2 can select and designate the camerawork to be used for FV clip generation from among the cameraworks displayed on the camerawork list display unit 44.

Various parameters related to the selected camerawork are displayed on the parameter display unit 45.

In the transmission window 46, information related to transmission of the created FV clip to the image creation controller 1 is displayed.

Next, the creation operation screen Gg of FIG. 8 will be described.

On the creation operation screen Gg, a preset list display unit 51, a camerawork list display unit 52, a camerawork window 53, an operation panel unit 54, and a preview window 55 are arranged.

The preset list display unit 51 can selectively display a preset list of cameras, a preset list of targets, and a preset list of 3D models.

The preset list of cameras is list information of position information (position information in a three-dimensional space) of each camera preset by the user for the camera arrangement position at the site. As will be described later, when the preset list of cameras is selected, information indicating the position of each piece of identification information (for example, cameral, camera2, ..., camera16) of the camera is displayed in a list form on the preset list display unit 51.

Furthermore, in the preset list of targets, the target means a target position that determines a line-of-sight direction from a viewpoint in the free viewpoint image. In the generation of the free viewpoint image, the line-of-sight direction from the viewpoint is determined to face the target.

When the preset list of targets is selected, the preset list display unit 51 displays a list of pieces of identification information about targets preset by the user and information indicating the positions of the targets.

Hereinafter, the target that determines the line-of-sight direction from the viewpoint in the free viewpoint image as described above is referred to as a “target Tg”.

The preset list of 3D models is a preset list of 3D models to be displayed as a background of the camerawork window 43, and when the preset list of 3D models is selected, the preset list display unit 51 displays a list of pieces of identification information of the preset 3D models.

The camerawork list display unit 52 can display a list of pieces of information of the camerawork created through the creation operation screen Gg and information (entry to be described later) of the camerawork to be newly created through the creation operation screen Gg.

In the camerawork window 53, at least information visualizing and indicating the movement trajectory of the viewpoint is displayed as the display of the camerawork.

The operation panel unit 54 is a region that receives various operation inputs in camerawork creation.

In the preview window 55, an observation image from a viewpoint is displayed. In a case where an operation of moving the viewpoint on the movement trajectory is performed, observation images from respective viewpoint positions on the movement trajectory are sequentially displayed in the preview window 55. In addition, as will be described later, in a case where an operation of designating a camera from the preset list of cameras is performed in a state where the preset list of cameras is displayed on the preset list display unit 51, an observation image from the arrangement position of the camera is displayed in the preview window 55 of this example.

Note that details of the camerawork designation screen Gs and a specific procedure of the camerawork designation illustrated in FIG. 7, and details of the creation operation screen Gg and a specific procedure of the camerawork creation illustrated in FIG. 8 will be described again later.

### 4. Clip Including Free Viewpoint Image

Next, an output clip including an FV clip as a free viewpoint image will be described.

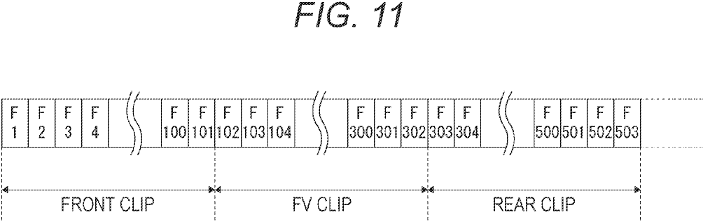

FIG. 10 illustrates a state in which a front clip, an FV clip, and a rear clip are connected as an example of the output clip.

For example, the front clip is an actual moving image in a section of time codes TC1 to TC2 in certain image data Vx among the pieces of image data V1 to V16.

Further, the rear clip is an actual moving image in a section of time codes TC5 to TC6 in certain image data Vy among the pieces of image data V1 to V16.

It is normally assumed that the image data Vx is the image data of the imaging device 10 before the start of the viewpoint movement by the FV clip, and the image data Vy is the image data of the imaging device 10 at the end of the viewpoint movement by the FV clip.

In this example, the front clip is a moving image having a time length t1, the FV clip is a free viewpoint image having a time length t2, and the rear clip is a moving image having a time length t3. The reproduction time length of the entire output clip is t1 + t2 + t3. For example, as the output clip for 5 seconds, a 1.5-second moving image, a 2-second free viewpoint image, a 1.5-second moving image, and the like can be considered.

Here, the FV clip is illustrated as a section of time codes TC3 to TC4, but this may or may not correspond to the number of frames of the actual moving image.

That is, as the FV clip, there are a case where the viewpoint is moved in a state where the time of the moving image is stopped (TC3 = TC4) and a case where the viewpoint is moved without stopping the time of the moving image (TC3 ≠ TC4).

For description, an FV clip in a case where the viewpoint is moved in a state where the time of the moving image is stopped is referred to as a “still image FV clip”, and an FV clip in a case where the viewpoint is moved without stopping the time of the moving image is referred to as a “moving image FV clip”.

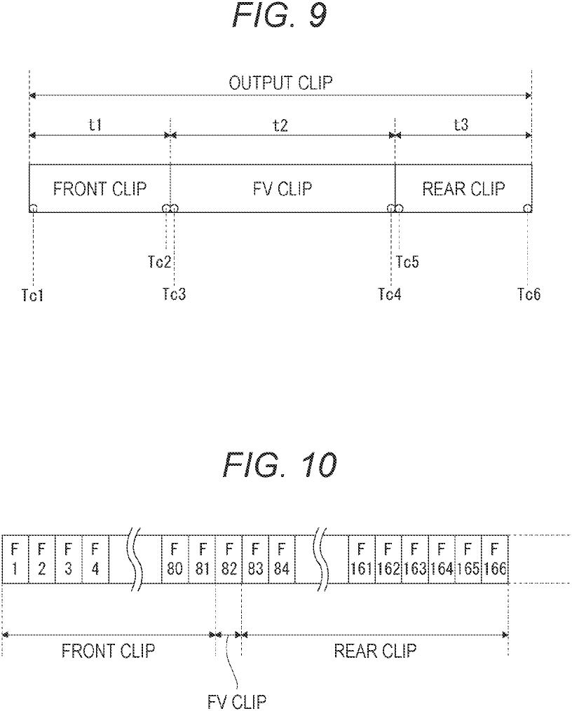

FIG. 10 illustrates the still image FV clip with reference to the frame of the moving image. In this example, the time codes TC1 and TC2 of the front clip are the time codes of the frames F1 and F81, and the time code of the following frame F82 is the time code TC3 = TC4 in FIG. 9. The time codes TC5 and TC6 of the rear clip are the time codes of the frames F83 and F166.

That is, this is the case of generating a free viewpoint image in which the viewpoint moves with respect to the still image of one frame of the frame F82.

Meanwhile, the moving image FV clip is as illustrated in FIG. 11. In this example, the time codes TC1 and TC2 of the front clip are the time codes of the frames F1 and F101, and the time codes of the frames F102 and F302 are the time codes TC3 and TC4 in FIG. 9. The time codes TC5 and TC6 of the rear clip are the time codes of the frames F303 and F503.

That is, this is a case where a free viewpoint image in which the viewpoint moves is generated for a moving image in a section of a plurality of frames from frame F102 to frame 302.

Therefore, the generation target image section determined by the image creation controller 1 is a section of one frame of the frame F82 in the case of creating the still image FV clip of FIG. 10, and is a section of a plurality of frames from the frame F102 to the frame 302 in the case of creating the moving image FV clip of FIG. 11.

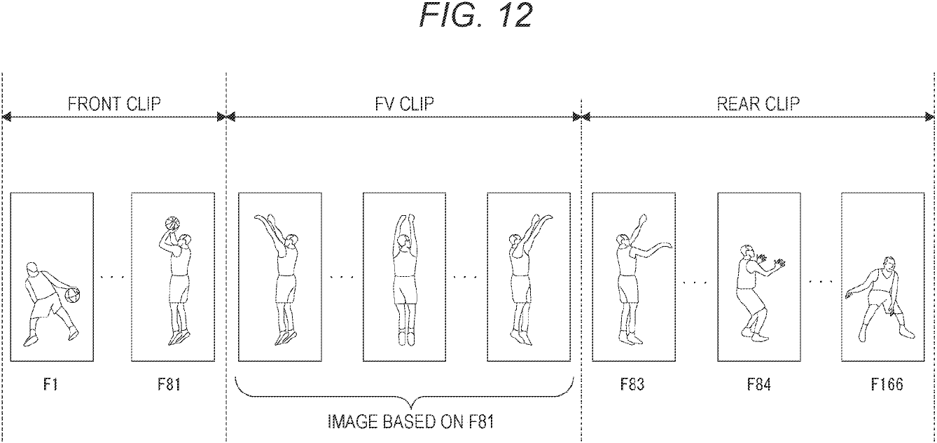

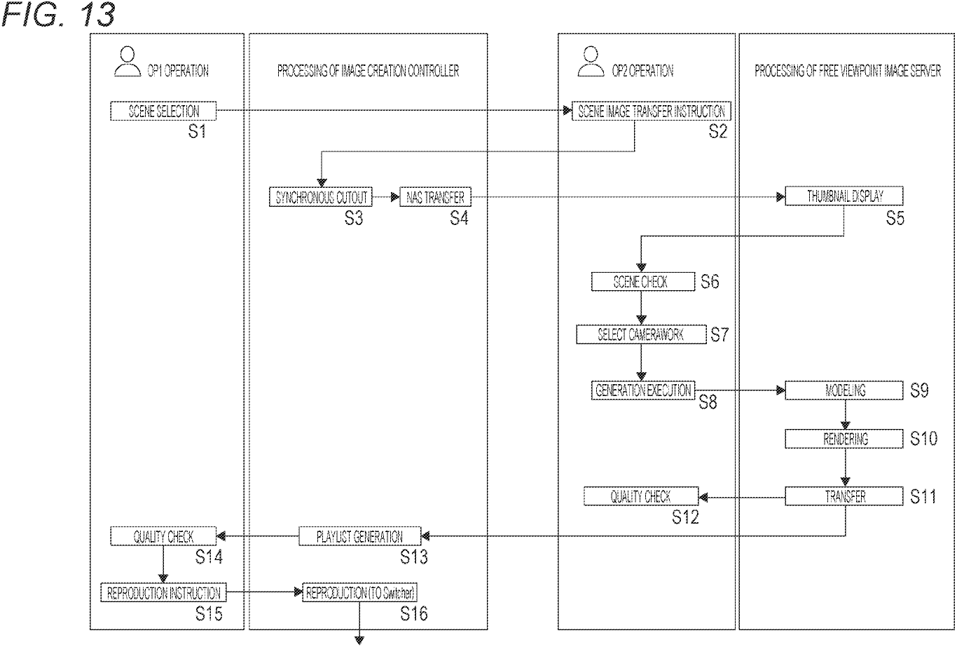

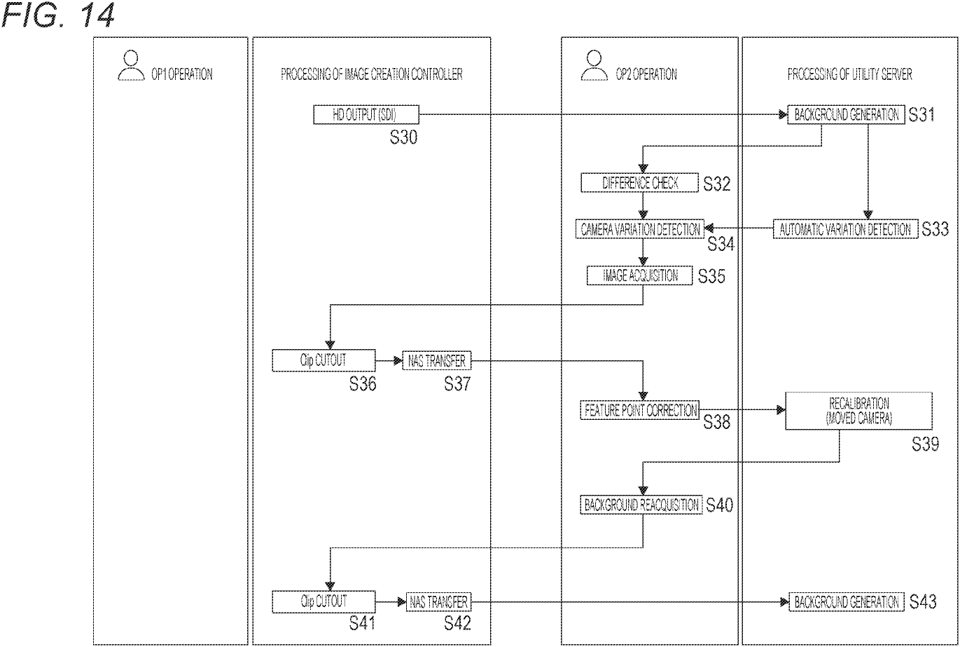

FIG. 12 illustrates an example of the image content of the output clip in the example of the still image FV clip of FIG. 10.

In FIG. 12, the front clip is an actual moving image from frame F1 to frame F81. The FV clip is a virtual image in which the viewpoint is moved in the scene of the frame F81. The rear clip is an actual moving image from frame F83 to frame F166.

For example, the output clip including the FV clip is generated in this manner and used as an image to be broadcast.

### 5. Clip Creation Process

Hereinafter, a processing example of output clip creation performed in the image processing system of FIG. 1 will be described. Processing of the image creation controller 1 and the free viewpoint image server 2 will be mainly described.

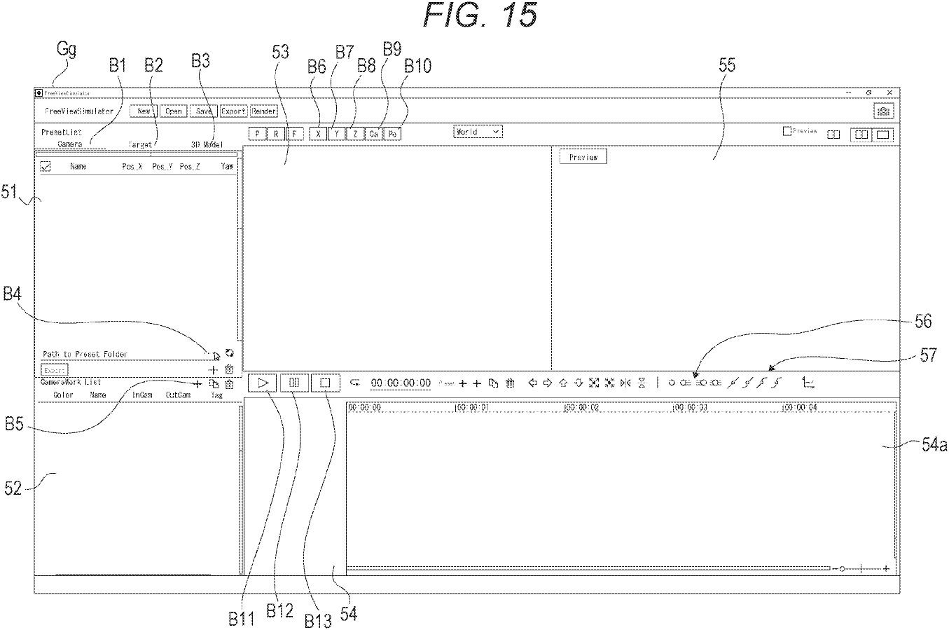

First, a flow of processing including operations of the operators OP1 and OP2 will be described with reference to FIG. 13. Note that the processing of the operator OP1 in FIG. 13 collectively illustrates GUI processing and operator operation of the image creation controller 1. In addition, the processing of the operator OP2 collectively illustrates GUI processing and operator operation of the free viewpoint image server 2.

### Step S1: Scene Selection

When an output clip is created, first, the operator OP1 selects a scene to be an FV clip. For example, the operator OP1 searches for a scene desired to be an FV clip while monitoring the captured image displayed on the display unit 77 on the image creation controller 1 side. Then, a generation target image section of one or a plurality of frames is selected.

The information of the generation target image section is transmitted to the free viewpoint image server 2, and the operator OP2 can recognize the generation target image section by the GUI on the display unit 77 on the free viewpoint image server 2 side.

Specifically, the information on the generation target image section is information on the time codes TC3 and TC4 in FIG. 9. As described above, in the case of the still image FV clip, the time codes are TC3 = TC4.

### Step S2: Scene Image Transfer Instruction

In response to the designation of the generation target image section, the operator OP2 performs an operation of giving an instruction to transfer the image of the corresponding scene. In response to this operation, the free viewpoint image server 2 transmits a transfer request for image data in the section of the time codes TC3 and TC4 to the image creation controller 1.

### Step S3: Synchronous Cutout

In response to the image data transfer request, the image creation controller 1 controls the video servers 4A, 4B, 4C, and 4D, and causes the video servers to cut out the section of the time codes TC3 and TC4 for each of the sixteen systems of image data from the image data V1 to the image data V16.

### Step S4: NAS Transfer

Then, the image creation controller 1 transfers the data in the section of all the time codes TC3 and TC4 of the image data V1 to V16 to the NAS 5.

### Step S5: Thumbnail Display

The free viewpoint image server 2 displays the thumbnails of the pieces of image data V1 to V16 in the section of the time codes TC3 and TC4 transferred to the NAS 5.

### Step S6: Scene Check

The operator OP2 checks the scene content of the section indicated by the time codes TC3 and TC4 on the camerawork designation screen Gs by the free viewpoint image server 2.

### Step S7: Select Camerawork

The operator OP2 selects (designates) the camerawork considered to be appropriate on the camerawork designation screen Gs according to the scene content.

### Step S8: Generation Execution

After selecting the camerawork, the operator OP2 performs an operation to execute generation of the FV clip.

### Step S9: Modeling

The free viewpoint image server 2 generates a 3D model of the subject, analyzes the subject, and the like using data of frames in the section of the time codes TC3 and TC4 in the image data V1 to V16, respectively, and parameters such as the arrangement position of each imaging device 10 input in advance.

### Step S10: Rendering

The free viewpoint image server 2 generates a free viewpoint image on the basis of the 3D model data and the subject analysis information. At this time, a free viewpoint image is generated so that the viewpoint movement based on the camerawork selected in step S7 is performed.

### Step S11: Transfer

The free viewpoint image server 2 transfers the generated FV clip to the image creation controller 1. At this time, not only the FV clip but also the designation information of the front clip and the rear clip and the designation information of the time lengths of the front clip and the rear clip can be transmitted as accompanying information.

### Step S12: Quality Check

Note that, on the free viewpoint image server 2 side, the quality check by the operator OP2 can be performed before or after the transfer in step S11. That is, the free viewpoint image server 2 reproduces and displays the generated FV clip on the camerawork designation screen Gs so that the operator OP2 can check the FV clip. In some cases, it is also possible that the operator OP2 performs the generation of the FV clip again without executing the transfer.

### Step S13: Playlist Generation

The image creation controller 1 generates an output clip using the transmitted FV clip. In this case, one or both of the front clip and the rear clip are coupled to the FV clip on the time axis to generate the output clip.

The output clip may be generated as stream data in which each frame as the front clip, each frame virtually generated as the FV clip, and each frame as the rear clip are actually connected in time series. However, in this processing example, the frames are virtually connected as the playlist.

That is, the playlist is generated such that the FV clip is reproduced following the reproduction of the frame section as the front clip, and the frame section as the subsequent clip is reproduced thereafter, so that the output clip can be reproduced without generating the stream data actually connected as the output clip.

### Step S14: Quality Check

The GUI on the image creation controller 1 side performs reproduction based on the playlist, and the operator OP1 checks the content of the output clip.

### Step S15: Reproduction Instruction

The operator OP1 gives a reproduction instruction by a predetermined operation according to the quality confirmation. The image creation controller 1 recognizes the input of the reproduction instruction.

### Step S16: Reproduction

In response to the reproduction instruction, the image creation controller 1 supplies the output clip to the switcher 6. As a result, the broadcast of the output clip can be executed.

### 6. Camera Variation Detection

In order to generate a free viewpoint image, since a 3D model is generated using the image data V1, V2, ..., V16, parameters including position information of each imaging device 10 are important.

For example, in a case where the position of a certain imaging device 10 is moved or the imaging direction is changed in the panning direction, the tilt direction, or the like in the middle of broadcasting, it is necessary to calibrate the parameter corresponding thereto. Therefore, in the image processing system of FIG. 1, the utility server 8 detects the variation of the camera. Here, the variation of the camera means that at least one of the position and the imaging direction of the camera changes.

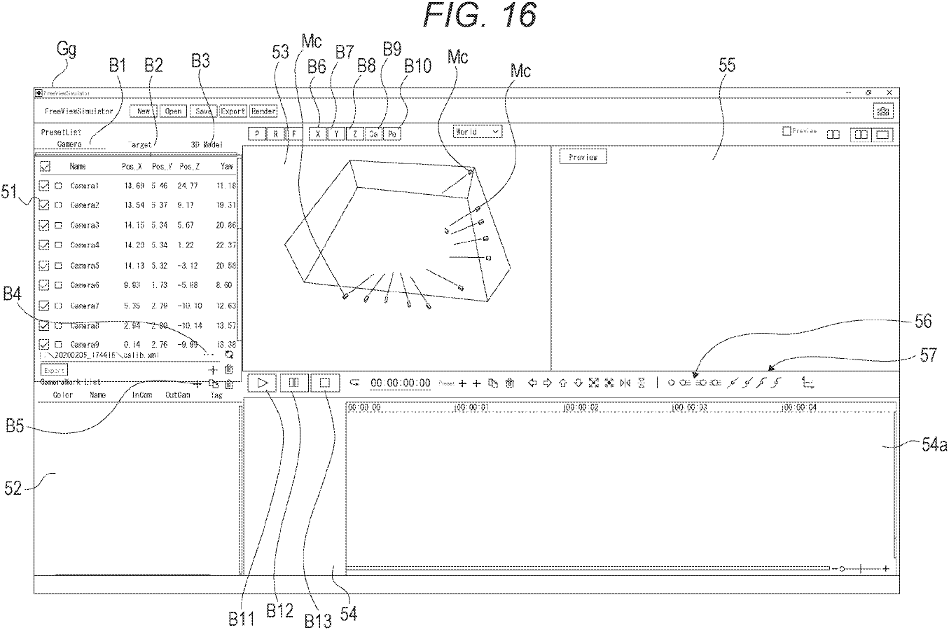

A processing procedure of the image creation controller 1 and the utility server 8 at the time of detecting the variation of the camera will be described with reference to FIG. 14. FIG. 14 illustrates a processing procedure in a format similar to that of FIG. 13, but the operator OP2 also performs an operation on the utility server 8.

### Step S30: HD Output

The image creation controller 1 controls the image conversion unit 7 to output image data from the video servers 4A, 4B, 4C, and 4D for camera movement detection. The images from the video servers 4A, 4B, 4C, and 4D, that is, the images of the sixteen imaging devices 10 are subjected to resolution conversion by the image conversion unit 7 and supplied to the utility server 8.

### Step S31: Background Generation

The utility server 8 generates a background image on the basis of the supplied image. Since the background image is an image that does not change unless there is a change in the camera, for example, a background image excluding a subject such as a player is generated for image data of sixteen systems (V1 to V16).

### Step S32: Difference Check

The background image is displayed as a GUI so that the operator OP2 can check a change in the image.

### Step S33: Automatic Variation Detection

It is also possible to automatically detect a variation of the camera by performing comparison processing on the background image at each time point.

### Step S34: Camera Variation Detection

As a result of step S33 or step S32, a variation of a certain imaging device 10 is detected.

### Step S35: Image Acquisition

Calibration is required in response to detection of a variation in the imaging device 10. Therefore, the utility server 8 requests the image creation controller 1 for the image data in the changed state.

### Step S36: Clip Cutout

The image creation controller 1 controls the video servers 4A, 4B, 4C, and 4D in response to a request for image acquisition from the utility server 8, and causes the video servers to execute clip cutout for the image data V1 to V16.

### Step S37: NAS Transfer

The image creation controller 1 controls the video servers 4A, 4B, 4C, and 4D to transfer the image data cut out as a clip to the NAS 5.

### Step S38: Feature Point Correction

By the transfer to the NAS 5, the utility server 8 can refer to and display the image in the state after the camera is changed. The operator OP2 performs an operation necessary for calibration such as feature point correction.

### Step S39: Recalibration

The utility server 8 re-executes the calibration for creating the 3D model using the image data (V1 to V16) in the state after the camera variation.

### Step S40: Background Reacquisition

After the calibration, in response to the operation of the operator OP2, the utility server 8 requests reacquisition of image data for the background image.

### Step S41: Clip Cutout

The image creation controller 1 controls the video servers 4A, 4B, 4C, and 4D in response to a request for image acquisition from the utility server 8, and causes the video servers to execute clip cutout for the image data V1 to V16.

### Step S42: NAS Transfer

The image creation controller 1 controls the video servers 4A, 4B, 4C, and 4D to transfer the image data cut out as a clip to the NAS 5.

### Step S43: Background Generation

The utility server 8 generates a background image using the image data transferred to the NAS 5. This is, for example, a background image serving as a reference for subsequent camera variation detection.

For example, by performing camera variation detection and calibration as in the above procedure, for example, even in a case where the position or the imaging direction of the imaging device 10 is changed during broadcasting, the parameter is corrected accordingly, so that an accurate FV clip can be continuously generated.

### 7. GUI for Creating Camerawork

Hereinafter, details of the creation operation screen Gg illustrated in FIG. 8, an example of a camerawork creation procedure, and various functions related to camerawork creation will be described with reference to FIGS. 15 to 51.

FIG. 15 is a diagram illustrating an initial screen of the creation operation screen Gg.

As described above, the preset list display unit 51, the camerawork list display unit 52, the camerawork window 53, the operation panel unit 54, and the preview window 55 are arranged on the creation operation screen Gg.

As illustrated, the preset list display unit 51 is provided with a camera button B1, a target button B2, and a 3D model button B3. The camera button B1 is a button for giving an instruction to display the preset list of cameras described above on the preset list display unit 51, and the target button B2 and the 3D model button B3 are buttons for giving an instruction to display the preset list of targets described above and the preset list of 3D models as the background on the preset list display unit 51.

In the drawing, an underline mark is illustrated in the camera button B1, which means that the preset list display of the camera is selected.

The preset list display unit 51 is provided with a folder reference button B4. By operating the folder reference button B4, the user can refer to a folder storing data desired to be displayed as a list on the preset list display unit 51.

A new creation button B5 is provided in the camerawork list display unit 52. The user can issue an instruction to add a new entry of camerawork by operating the new creation button B5. The added entry of the camerawork is displayed on the camerawork list display unit 52.

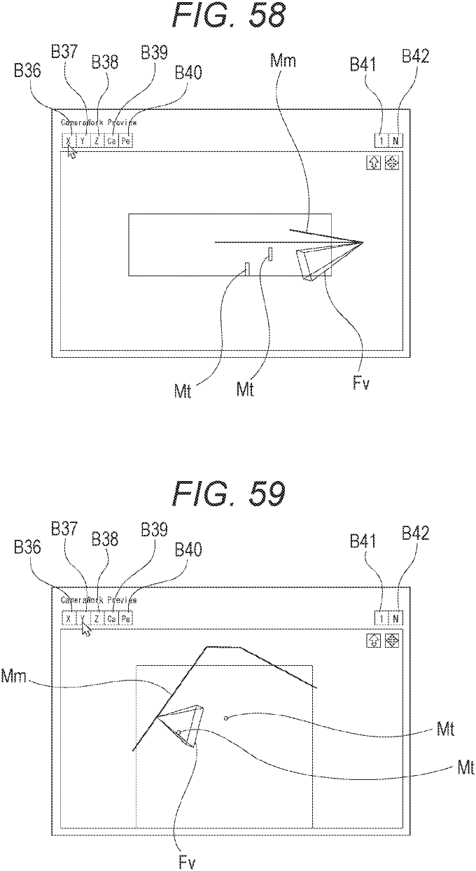

The camerawork window 53 is provided with an X viewpoint button B6, a Y viewpoint button B7, a Z viewpoint button B8, a Ca viewpoint button B9, and a Pe viewpoint button B10. Each of these viewpoint buttons is a button for instructing an observation viewpoint for an object to be displayed in the camerawork window 53. Specifically, the X viewpoint button B6, the Y viewpoint button B7, and the Z viewpoint button B8 are buttons for respectively instructing the viewpoint on the X axis, the viewpoint on the Y axis, and the viewpoint on the Z axis as viewpoints for observing the visualization information of the camerawork information displayed in the camerawork window 53, and the Pe viewpoint button B10 is a button for instructing the shift to a mode for changing the observation viewpoint of the visualization information of the camerawork information to an arbitrary position. The Ca viewpoint button B9 is a button for giving an instruction to display an image obtained by observing the target three-dimensional space from the viewpoint movement trajectory defined as the camerawork information. Note that, for images of the X-axis viewpoint, the Y-axis viewpoint, the Z-axis viewpoint, the Pe viewpoint, and the Ca viewpoint, refer to FIGS. 58 to 62 described later.

Here, in the creation operation screen Gg, the display image in the camerawork window 53 or the preview window 55 can be enlarged or reduced according to a predetermined operation such as a wheel operation of a mouse, for example. Furthermore, in the camerawork window 53 and the preview window 55, the display image can be scrolled according to a predetermined operation such as a drag operation, for example. Note that the enlargement, reduction, and scrolling of the display image can be performed according to an operation of a button provided on the screen.

The operation panel unit 54 is provided with a reproduction button B11, a pause button B12, a stop button B13, a timeline operation unit 54a, a speed adjustment operation unit 56, and a trajectory shape adjustment operation unit 57.

The reproduction button B11, the pause button B12, and the stop button B13 are buttons for respectively instructing reproduction, pause, and stop of the visualization image of the camerawork information displayed in the camerawork window 53 and the observation image from the viewpoint displayed in the preview window 55. The reproduction button B11, the pause button B12, and the stop button B13 are enabled at least when the information on the movement trajectory of the viewpoint is determined as the camerawork information.

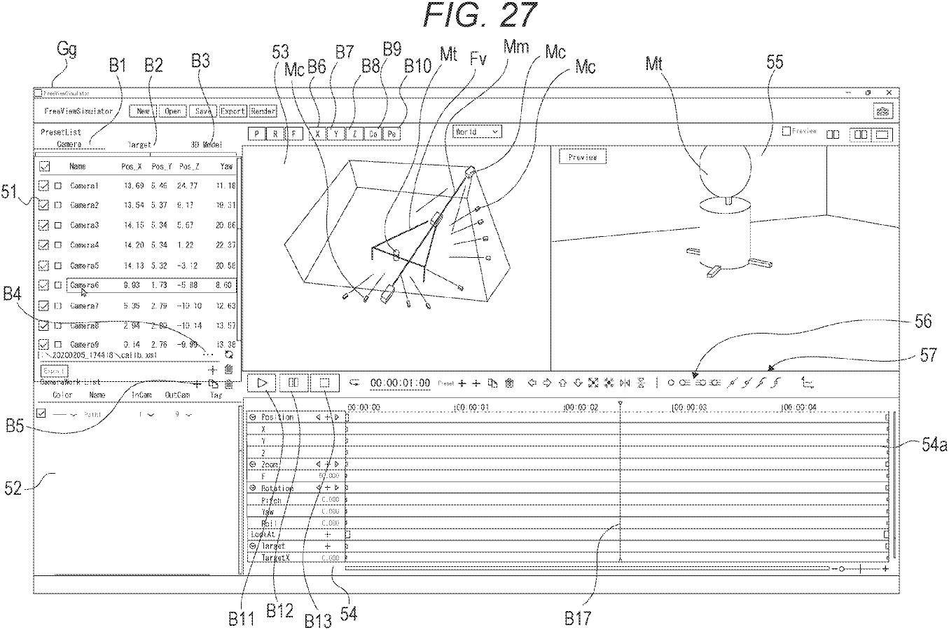

The timeline operation unit 54a is a region that receives an operation related to the creation of the camerawork on the timeline representing the movement period of the viewpoint of the free viewpoint image. Examples of the operation on the timeline operation unit 54a include an operation of dragging and dropping one of the cameras listed on the preset list display unit 51 to an arbitrary position on the timeline (that is, an arbitrary time point within the viewpoint movement period) (see FIGS. 27 to 29). As will be described later, this operation functions as a designation operation of the timing at which the viewpoint passes through the position of the dragged and dropped camera within the viewpoint movement period.

Various operation buttons for adjusting the moving speed of the viewpoint are arranged in the speed adjustment operation unit 56. In the trajectory shape adjustment operation unit 57, various operation buttons for adjusting the shape of the movement trajectory of the viewpoint are arranged.

The speed adjustment operation unit 56 and the trajectory shape adjustment operation unit 57 will be described later.

A camerawork creation procedure and various functions related to the camerawork creation will be described.

First, the user (operator OP2 in this example) performs an operation for acquiring a preset list of cameras as illustrated in FIG. 16. This operation is an operation for acquiring a preset list of cameras indicating the positions of the cameras actually installed on the site.

The preset list of cameras is acquired by operating the folder reference button B4 to designate the corresponding folder.

When a folder is designated, the display processing unit 34a performs processing of displaying a preset list of cameras according to the data content of the designated folder on the preset list display unit 51.

At the same time, the display processing unit 34a performs processing of displaying information visually indicating the arrangement of each camera on the camerawork window 53 on the basis of the acquired position information of the camera. Specifically, processing of displaying a camera position mark Mc indicating the position of each camera is performed.

Note that, regarding the display of the camera position mark Mc, display for identifying each camera by color coding may be performed. For example, each camera can be color-coded in the preset list of cameras, and each camera position mark Mc can be displayed by the same color coding in the camerawork window 43.

Furthermore, in the camerawork window 53, it is also conceivable to display the identification information (for example, cameral, camera2, ..., cameraX, and the like) of the camera for the mouse-over camera position mark Mc.

In this example, the 3D model displayed as the background can be changed in the camerawork window 53.

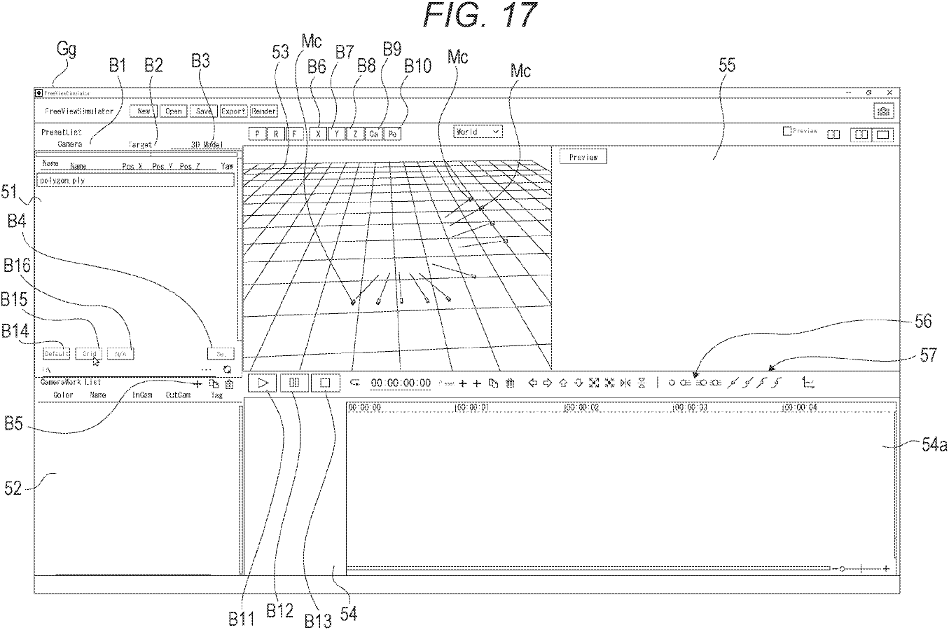

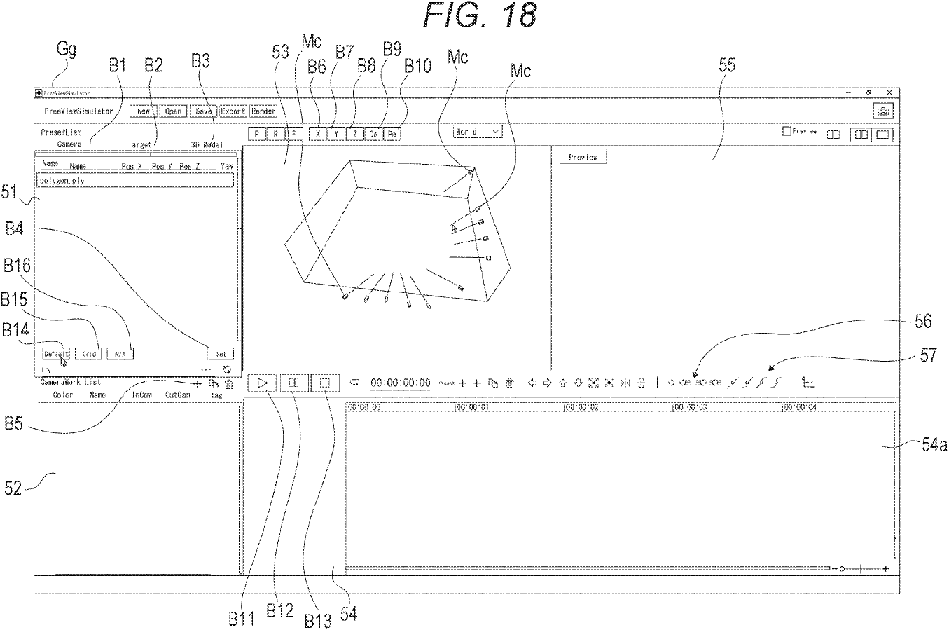

Describing the change of the background 3D model with reference to FIGS. 17 and 18, in a case where the user desires to change the background 3D model, the user operates the 3D model button B3 to set the display state of the preset list display unit 51 to the display state of the preset list of 3D models. In this display state, a default designation button B14, a Grid designation button B15, and an N/A designation button B16 as illustrated in the drawing are displayed in the preset list display unit 51, and the user can switch the background 3D model by operating these buttons. Here, the default designation button B14 is a button for instructing switching to a background 3D model (for example, a 3D model indicating a stage, a ground, or the like) prepared in advance as an initial setting, and the Grid designation button B15 is a button for instructing switching to a background 3D model (for example, a grid line, a square, or the like) whose distance and angle can be visually recognized. Furthermore, the N/A designation button B16 is a button for instructing to turn off the display of the background 3D model.

FIG. 17 illustrates an example of the background 3D model of the camerawork window 53 in a case where the Grid designation button B15 is operated. Furthermore, FIG. 18 illustrates an example of the background 3D model of the camerawork window 53 in a case where the default designation button B14 is operated.

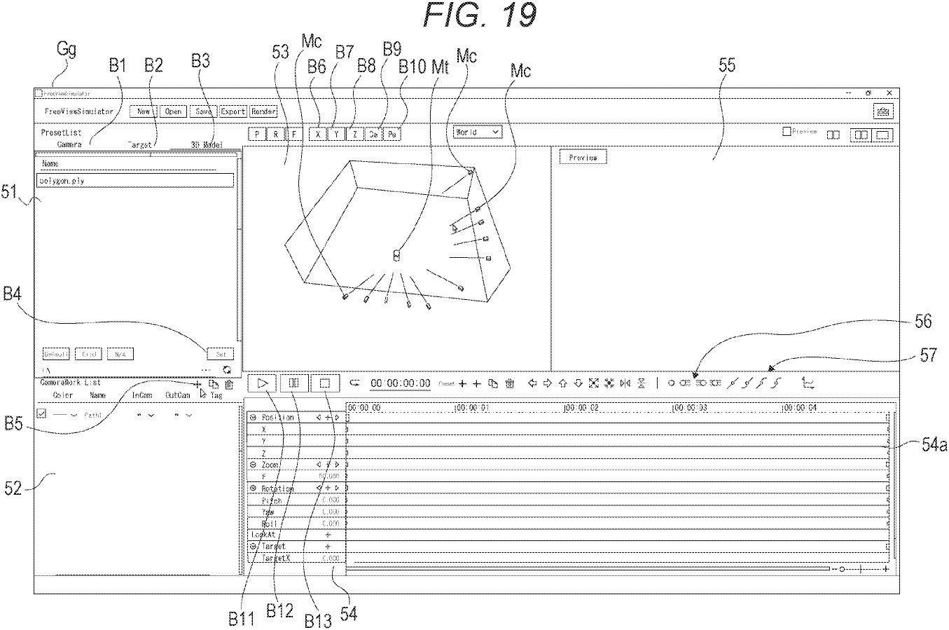

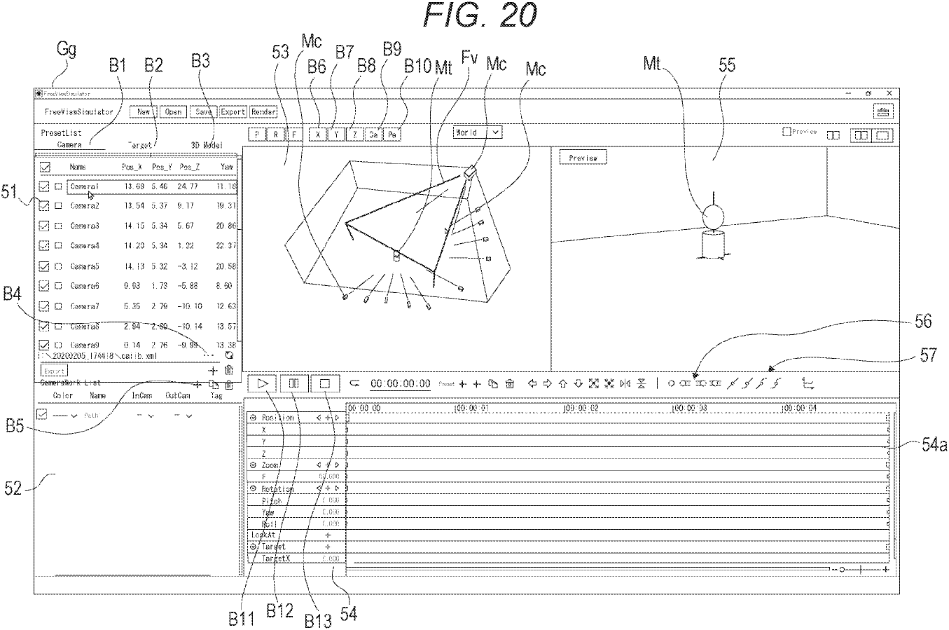

In starting the creation of the camerawork, the user operates a new creation button B5 as illustrated in FIG. 19.

In response to the operation of the new creation button B5, the display processing unit 34a displays a new entry of camerawork on the camerawork list display unit 52. In this entry, an operation unit for designating the In-camera as a start point of the viewpoint movement and the Out-camera as an end point of the viewpoint movement is displayed.

In this example, in the generation of the free viewpoint image, since the texture based on the image captured by the camera is pasted to the 3D model of the subject, it is desirable to create a movement trajectory that passes through the camera position as much as possible as the movement trajectory of the viewpoint. In particular, since the start point and the end point of the viewpoint movement in the free viewpoint image are switching points of the image with the front and back clip, the start point and the end point of the viewpoint movement should coincide with the camera position. Therefore, the start point and the end point of the viewpoint movement are designated as the camera positions of the In-camera and the Out-camera, respectively.

Note that the movement start point and the movement end point of the viewpoint are not necessarily limited to the camera position, and may be any position other than the camera position.

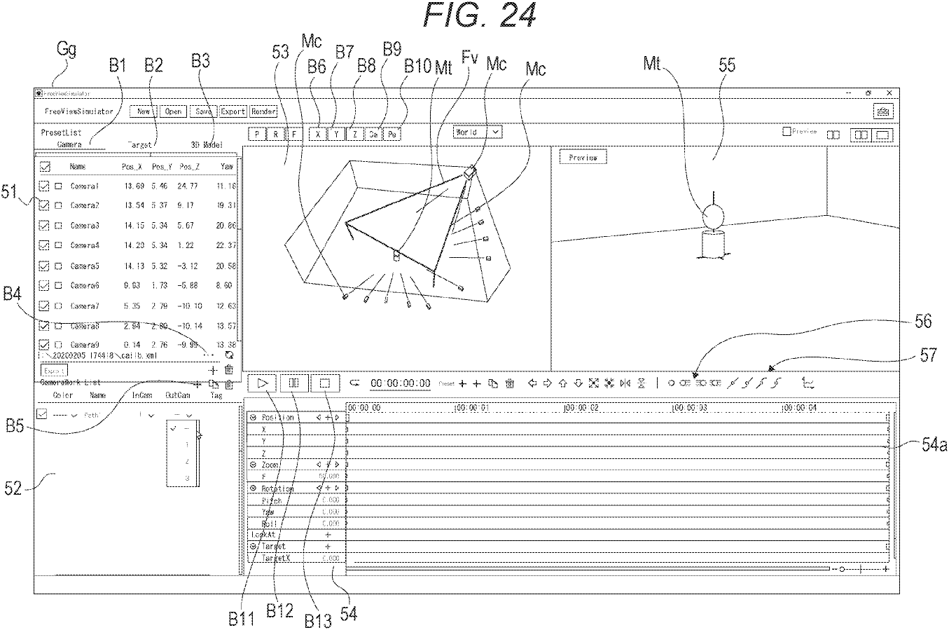

As illustrated in the drawing, the operation unit for designating the In-camera and the Out-camera is, for example, an operation unit for designating the camera in a pull-down format. When pull-down is instructed by a user operation, information (in this example, the camera number information) indicating each camera listed in a preset list of specifiable cameras, that is, cameras designated by the user is displayed (see FIGS. 22 and 24 to be described later).

Furthermore, according to the operation of the new creation button B5, the new entry of the camerawork is displayed in the camerawork list display unit 52 as described above, and a mark (hereinafter referred to as a “target mark Mt”) indicating the position of the target Tg set by the user is displayed in the camerawork window 53.

Here, in the camerawork creation work, the position of the target Tg is set to an appropriate position assumed for the target scene, for example, in a case where it is desired to generate an image of a shooting scene as a free viewpoint image, the position is set to a position near a goal in a target three-dimensional space (for example, a soccer ground in the case of soccer). Here, it is assumed that the position of the target Tg can be set in the free viewpoint image server 2 in advance by the user.

As described above, the free viewpoint image can be generated such that the line-of-sight direction from the viewpoint faces the target Tg. Specifically, the free viewpoint image of this example can be generated such that the target Tg continues to be located at a predetermined position (for example, the center position) in the image frame within at least a partial period during the movement period of the viewpoint.

Note that, in the generation of the free viewpoint image, continuing to position the target Tg at a predetermined position in the image frame as described above is expressed as “following the target Tg”. This “following the target Tg” is synonymous with the fact that the line-of-sight direction from the viewpoint continues to face the target Tg while the viewpoint is moving.

Here, in a state in which a preset list of cameras is displayed in the camerawork window 53, an observation image from a field of view or a viewpoint (an image obtained by observing a three-dimensional space from the viewpoint) in a case where the viewpoint is set at the position of the designated camera is displayed in the camerawork window 53 and the preview window 55, respectively, according to the designation operation of the camera from the preset list of cameras.

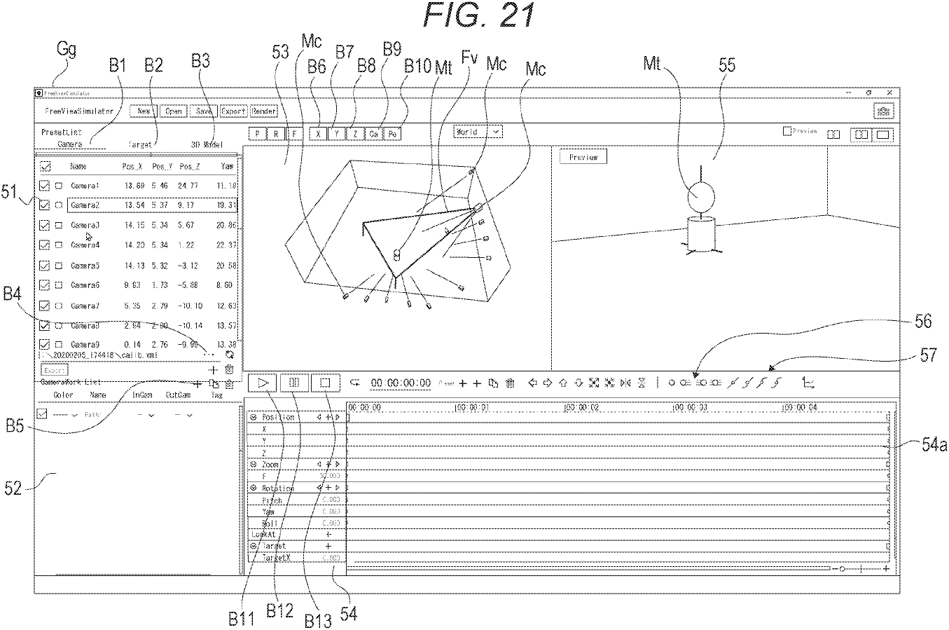

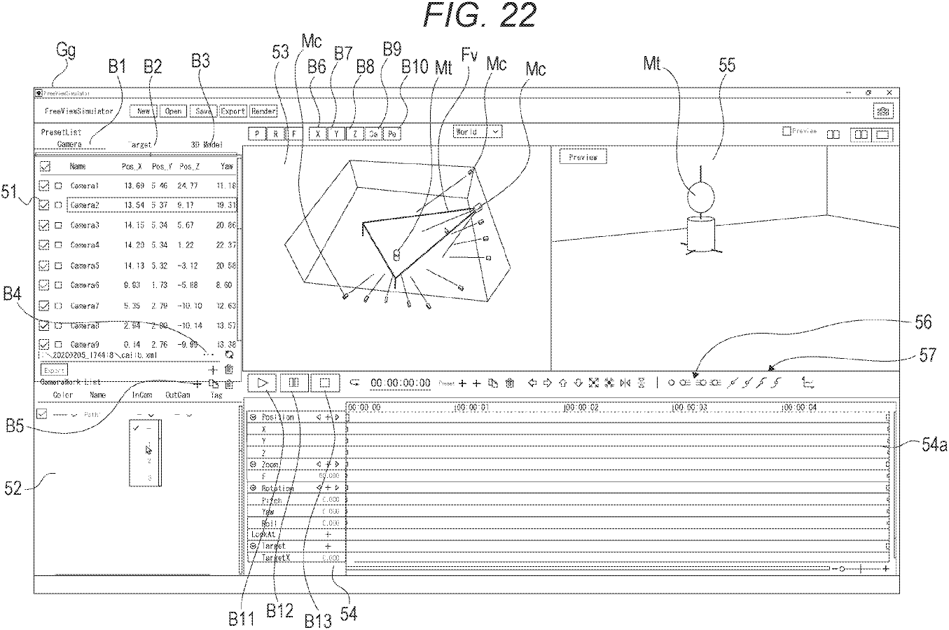

Specifically, FIGS. 20 and 21 illustrate display content examples of the creation operation screen Gg in a case where the camera as cameral and the camera as camera2 are designated from the camera preset list.

In this case, the camerawork window 53 displays field-of-view information Fv that visualizes and indicates the field of view from the camera for the camera designated from the preset list of cameras. As illustrated in the drawing, in this example, information representing the field of view as a figure is displayed as the field-of-view information Fv.

Furthermore, in the camerawork window 53 in this case, the camera position mark Mc for the designated camera is highlighted more than the camera position marks Mc for other cameras (in the figure, an example of increasing the size is illustrated), so that the user can easily grasp at which position the designated camera is located.

In the preview window 55, an image obtained by observing a three-dimensional space from a designated camera is displayed.

Here, in this example, it is assumed that the camerawork creation work is performed prior to the generation of the free viewpoint image. That is, it is assumed that the captured image used to generate the free viewpoint image is performed in an unacquired state. Therefore, the image obtained by observing the three-dimensional space from the viewpoint mentioned here is not an image obtained by rendering, as a two-dimensional image, a 3D model (hereinafter, it is described as a “real three-dimensional model” for the sake of description) generated by performing object detection or the like from the image captured by each camera that captures the target real space, but is an image obtained by rendering, as a two-dimensional image, a virtual 3D model (referred to as “virtual three-dimensional model”) that simulates the target real space. In the process of generating the observation image from the viewpoint in this case, since the captured image has not been acquired, the process of pasting the texture generated from the captured image to the 3D model is not performed.

FIGS. 22 to 25 are explanatory diagrams of a method of designating the In-camera and the Out-camera.

As illustrated in FIG. 22, for the designation of the In-camera, a camera designation operation is performed from the pull-down list of In-cameras in the entry added to the camerawork list display unit 52.

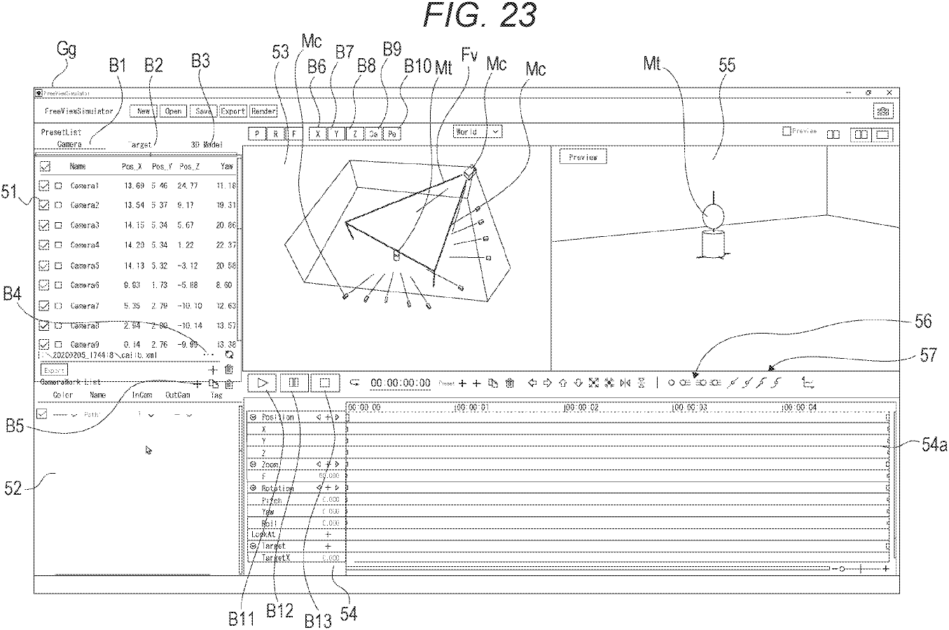

FIG. 23 illustrates a state of the creation operation screen Gg in a case where the cameral is designated as the In-camera. In a case where cameral is designated as the In-camera, “1” is displayed in the item of the In-camera in the entry added to the camerawork list display unit 52 as illustrated in the drawing.

Furthermore, in the camerawork window 53, the camera position mark Mc for the cameral is highlighted, and the field-of-view information Fv for the cameral is displayed.

Note that, in comparison with FIG. 20 described above, the display mode of the camera position mark Mc and the field-of-view information Fv in the camerawork window 53 may be different between the case of being designated from the preset list of cameras and the case of being designated as the In-camera.

In the preview window 55, an image obtained by observing a three-dimensional space from the cameral is displayed.

In a case where the Out-camera is designated, as illustrated in FIG. 24, the camera designation operation is performed from the pull-down list of Out-cameras in the entry added to the camerawork list display unit 52.

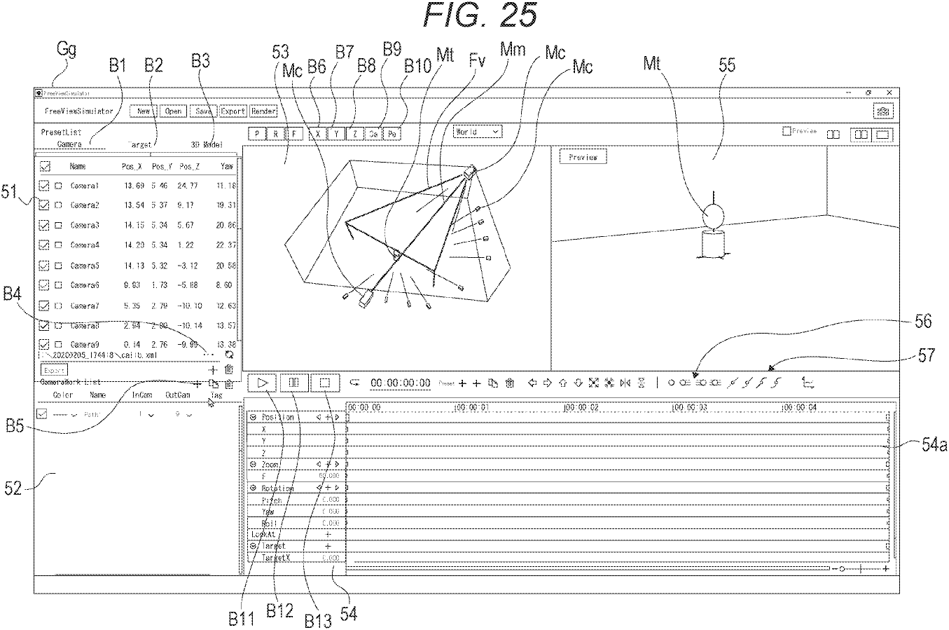

FIG. 25 illustrates a state of the creation operation screen Gg in a case where the camera9 is designated as the Out-camera. In this case, “9” is displayed in the item of the Out-camera in the entry added to the camerawork list display unit 52.

Here, the movement trajectory of the viewpoint is determined by designating the In-camera and the Out-camera. Therefore, in the camerawork window 53 in this case, information indicating the movement trajectory of the viewpoint connecting the positions of the In-camera and the Out-camera, which is indicated as the movement trajectory information Mm in the figure, is displayed. Here, the movement trajectory information Mm is information obtained by visualizing the movement trajectory of the viewpoint.

Specifically, in the camerawork window 53 in this case, the camera position mark Mc for the camera9 designated as the Out-camera is highlighted, and linear movement trajectory information Mm connecting the positions of the In-camera and the Out-camera is additionally displayed from the case of FIG. 23.

Although illustration is omitted, in the creation operation screen Gg, the preview of the camerawork can be displayed after at least the In-camera and the Out-camera are designated as described above and the movement trajectory of the viewpoint is formed.

Specifically, this preview display can be instructed to start by operating the reproduction button B11 on the operation panel unit 54. In the camerawork window 53, as the preview display of the camerawork, an image in which the field-of-view information Fv changes from moment to moment with movement of the viewpoint is displayed. In addition, in conjunction with such preview display of the camerawork, in the preview window 55, an observation image in a three-dimensional space (observation image from the viewpoint) that changes from moment to moment with movement of the viewpoint is displayed.

Furthermore, in this example, such preview display of the camerawork and preview display of the observation image in the three-dimensional space can be performed not only by the operation of the reproduction button B11 but also by the drag operation of the seek bar B17 in the timeline operation unit 54a.

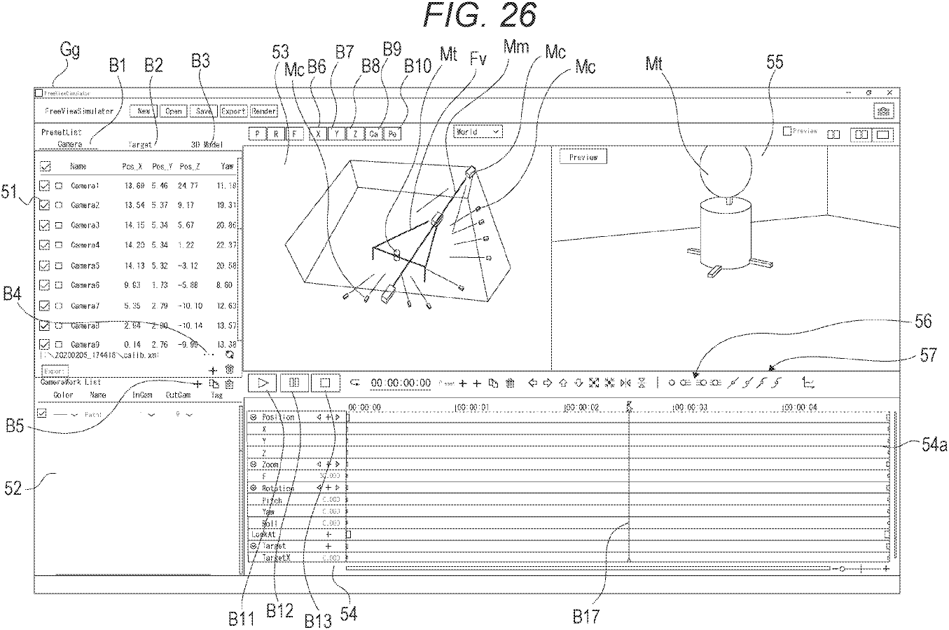

FIG. 26 illustrates a state in which the seek bar B17 is positioned at a desired position on the timeline by drag operation of the seek bar B17 in the timeline operation unit 54a.

While the drag operation of the seek bar B17 is being performed, the position of the seek bar B17 on the timeline, that is, on the time axis from the start timing to the end timing of the free viewpoint image changes from moment to moment. Therefore, while the drag operation is being performed, the field-of-view information Fv corresponding to the viewpoint position at the timing indicated by the seek bar B17 is sequentially displayed in the camerawork window 53, and is visually recognized by the user as an image in which the field-of-view information Fv changes from moment to moment with movement of the viewpoint. Similarly, in the preview window 55, an observation image of the three-dimensional space from a viewpoint changing from moment to moment is displayed according to the movement of the seek bar B17.

Next, the via-point of the viewpoint will be described.

On the creation operation screen Gg, it is possible to designate a via-point of the viewpoint and a timing at which the viewpoint passes through the via-point.

FIGS. 27 to 30 are explanatory diagrams of designation of a via-point of a viewpoint and a via-timing.

In this example, the via-point and the timing at which the viewpoint passes through the via-point can be designated by an operation of dragging and dropping a camera desired to be designated as the via-point on the timeline in the timeline operation unit 54a.

FIGS. 27 to 29 are explanatory diagrams of operation examples in a case where a camera6 is designated as a via-point.

First, as illustrated in FIG. 27, a camera desired to be designated as a via-point is selected from a camera preset list in the preset list display unit 51. In this example, the operation for selection is a pressing operation of the left button of the mouse.

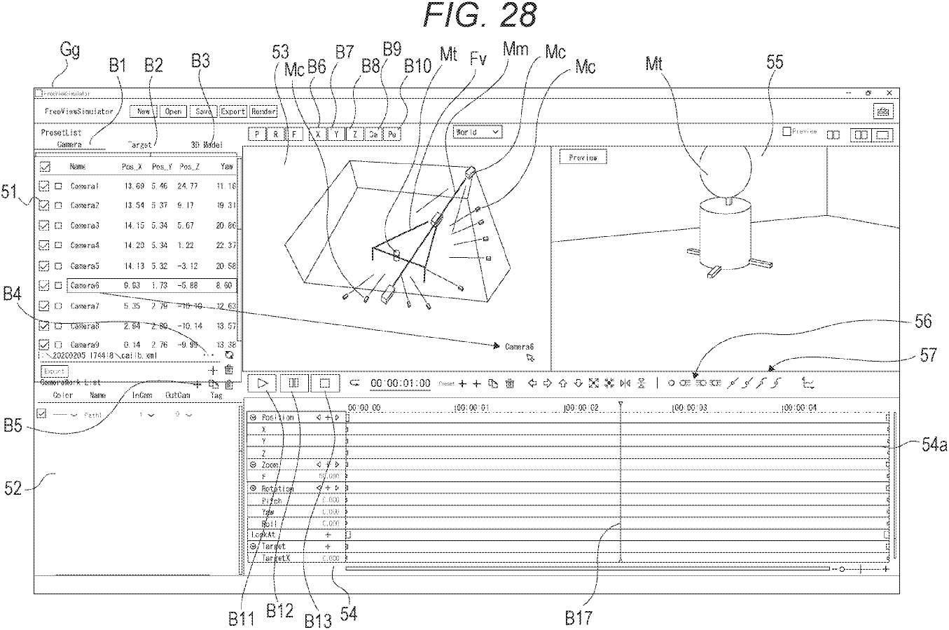

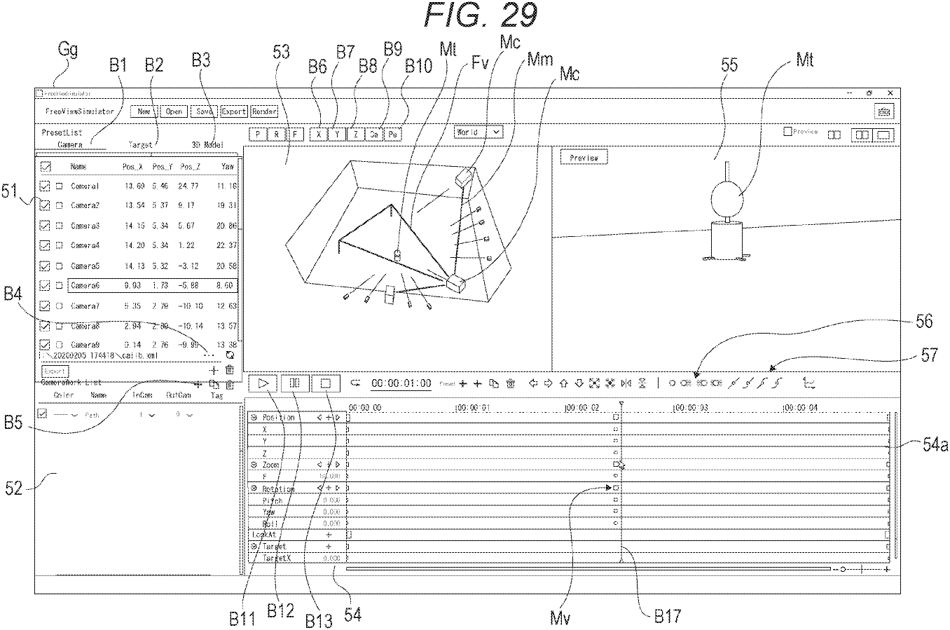

The camera selected in this manner is dragged on the screen as illustrated in FIG. 28 and dropped at a desired position on the timeline of the timeline operation unit 54a as illustrated in FIG. 29 (in this example, the pressing state of the left click is released). As a result, the designation of the camera as the via-point and the timing at which the viewpoint passes through the via-point is completed.

In response to the completion of the designation, as illustrated in FIG. 29, the via-point mark Mv is displayed on the timeline of the timeline operation unit 54a. The via-point mark Mv is displayed at a position designated on the timeline by the drop operation described above. That is, the free viewpoint image is displayed at the position indicating the designated timing within the period from the start timing to the end timing of the free viewpoint image (within the movement period of the viewpoint).

In this example, the via-point mark Mv is displayed as a square mark in the initial state as illustrated in the drawing.

In addition, in a state in which the designation of the via-point and the via-timing is completed, the camerawork window 53 highlights the camera position mark Mc for the camera (camera6 in this case) designated as the via-point, and displays the field-of-view information Fv indicating the field of view from the camera. Furthermore, the preview window 55 displays an image obtained by observing the three-dimensional space from the viewpoint of the camera position designated as the via-point.

By selecting a camera from the preset list and dragging and dropping the selected camera, as described above, it is possible to designate a via-point of the viewpoint and a timing at which the viewpoint passes through the via-point.

FIG. 30 illustrates a state of the creation operation screen Gg in a case where a via-point and a via-timing are further designated for two cameras in the same manner as described above.

Note that, although the example in which the camera position is designated as the via-point of the viewpoint has been described here, an arbitrary position other than the camera position can be designated as the via-point.

Furthermore, on the creation operation screen Gg, it is possible to designate the type of the shape of the movement trajectory of the viewpoint.

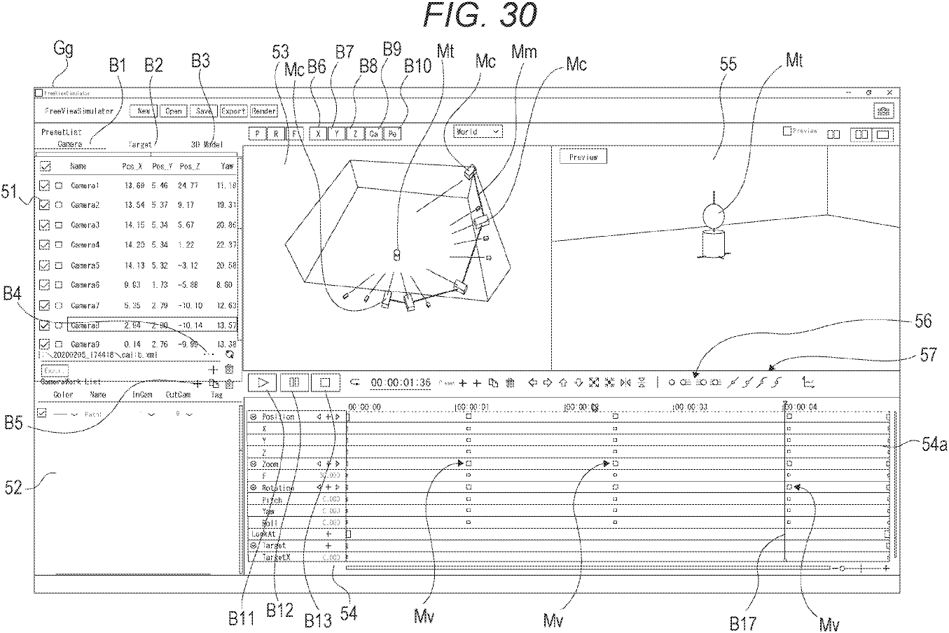

With reference to FIGS. 31 to 33, a specific operation procedure and screen transition according to the operation will be described.

First, as illustrated in FIG. 31, a target range in which the type of the movement trajectory is desired to be designated is designated on the timeline in the timeline operation unit 54a. The figure illustrates an example in which a range from a first via-point to a third via-point is designated in a case where three via-points of viewpoints are set as illustrated in FIG. 30.

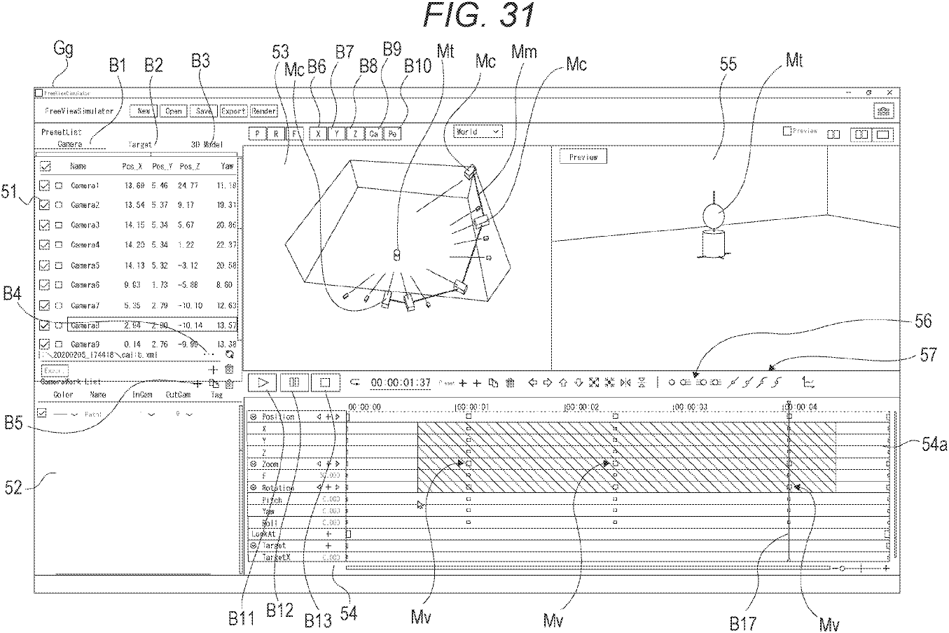

An operation button provided in the trajectory shape adjustment operation unit 57 is operated to designate the type of the shape of the movement trajectory. For example, as illustrated in FIG. 32, the curve interpolation button B18 provided in the trajectory shape adjustment operation unit 57 is operated.

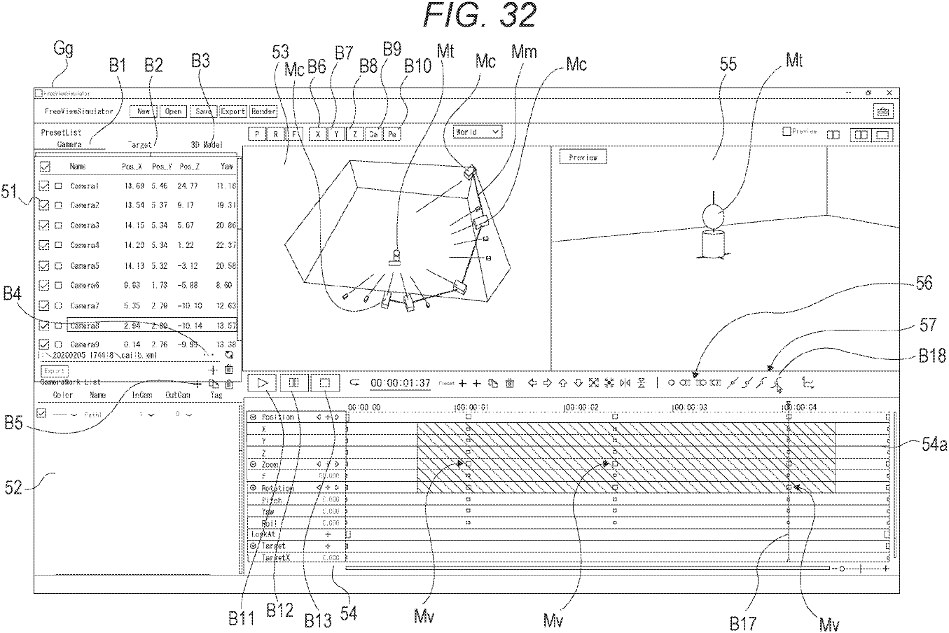

In response to the operation of the curve interpolation button B18, the camerawork generation processing unit 34 performs curve interpolation of the movement trajectory for the partial designated range of the viewpoint movement trajectory designated in FIG. 31. Then, as illustrated in FIG. 33, the display processing unit 34a performs processing of displaying the movement trajectory information Mm generated by the curve interpolation in the camerawork window 53.

By forming the movement trajectory of the viewpoint into the curved shape in this manner, it is possible to prevent the distance from the target subject to the viewpoint from greatly changing even if the viewpoint moves. In other words, the size of the target subject in the free viewpoint image can be prevented from greatly changing.

In this example, in a case where the curve interpolation as described above is performed, processing of changing the shape of the via-point mark Mv displayed on the timeline in the timeline operation unit 54a to a shape corresponding to the curve interpolation is performed. Specifically, in this example, as illustrated in the figure, the shape of the via-point mark Mv is changed from a square mark to a round mark. As a result, it is possible to notify the user that curve interpolation is being performed for the movement trajectory of the viewpoint connecting the via-points also on the timeline.

Note that, in this example, an operation button for instructing to make the movement trajectory shape linear is arranged in the trajectory shape adjustment operation unit 57, and when the operation button is operated, the shape of the corresponding via-point mark Mv is changed to a square mark.

Here, as the movement trajectory shape, shapes other than a curve and a straight line can be set. For example, as illustrated in the movement trajectory information Mm of FIG. 33, a shape in which a curve and a straight line are mixed can be used. In addition, the movement trajectory by the curve is not limited to the constant curvature, and it is also possible to set the curvature to be different in some sections.

In addition, in a case where there is a variation in the movement trajectory shape as described above, the via-point mark Mv may be displayed not only in the two types of display forms of the straight line and the curved line as illustrated above but also in different display forms corresponding to each variation.

Furthermore, in the creation operation screen Gg of this example, it is possible to designate the moving speed of the viewpoint.

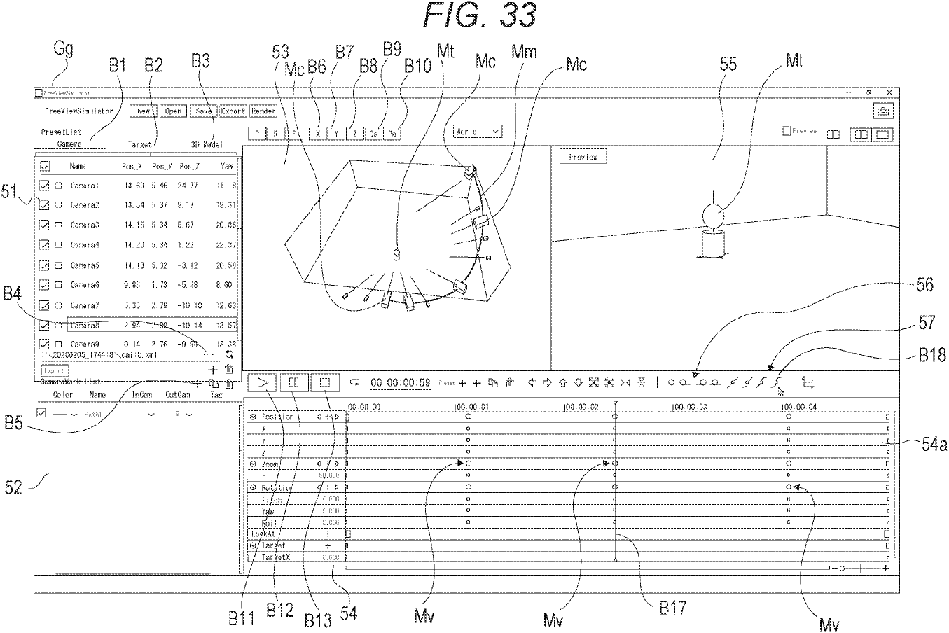

In the designation of the moving speed, first, as illustrated in FIG. 31, the target range is designated on the timeline in the timeline operation unit 54a. Here, as illustrated in FIG. 34, it is assumed that a range across only the second via-point is designated. Then, an operation button provided in the speed adjustment operation unit 56 is operated. For example, as illustrated in FIG. 34, a speed adjustment button B19 provided in the speed adjustment operation unit 56 is operated.

In response to the operation of the speed adjustment button B19, the camerawork generation processing unit 34 adjusts the speed of the viewpoint corresponding to the operated button for a partial range of the designated viewpoint movement trajectory.

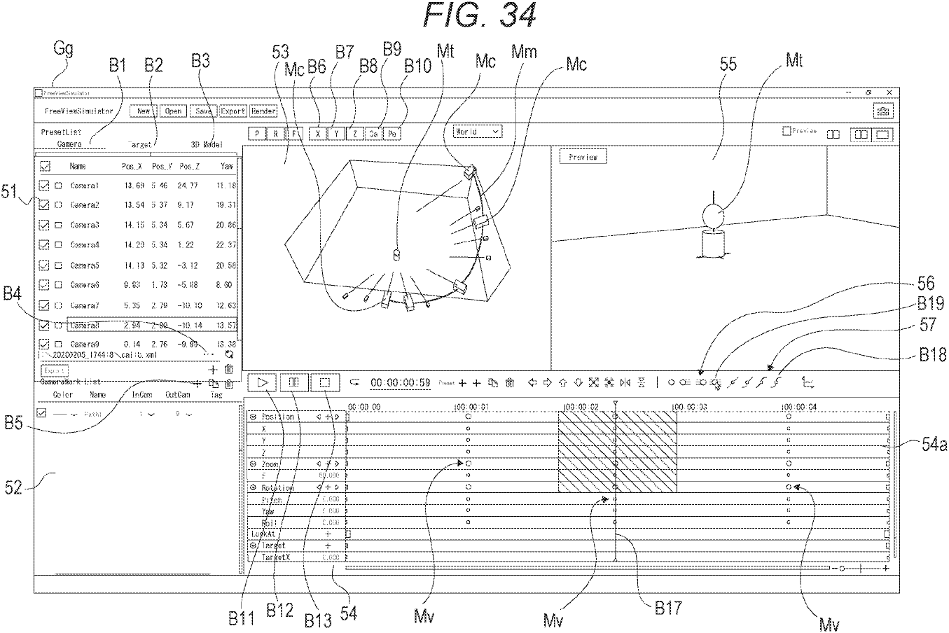

In this example, in response to such speed adjustment, the display processing unit 34a performs processing of changing the shape of the corresponding via-point mark Mv on the timeline to a shape according to the mode of the executed speed adjustment, as illustrated in FIG. 35. Note that the illustrated display mode is merely an example. By performing such a shape change, it is possible to notify the user on the timeline that the speed adjustment has been performed in the corresponding range in the viewpoint movement trajectory.

Next, adjustment of the target position will be described.

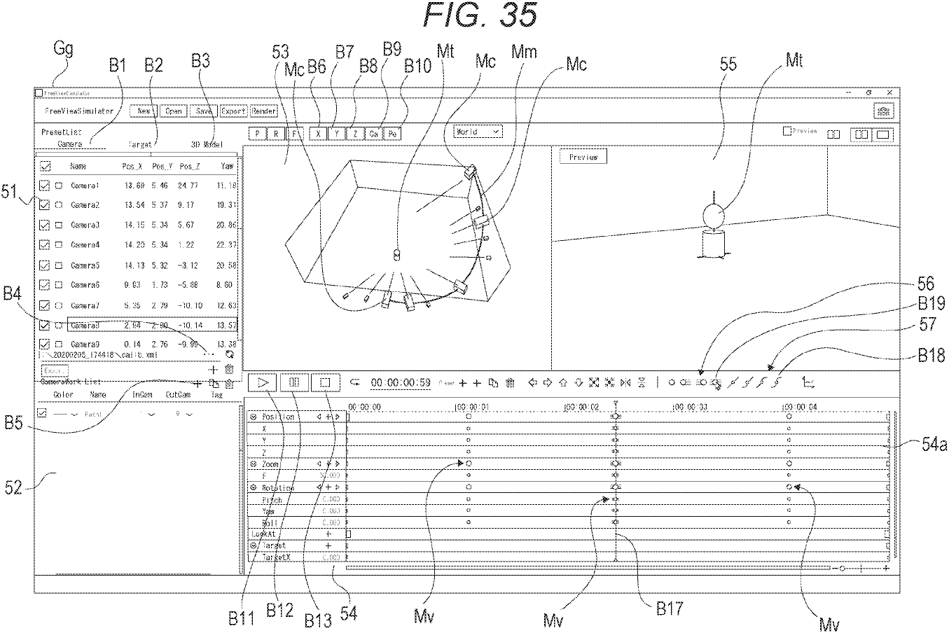

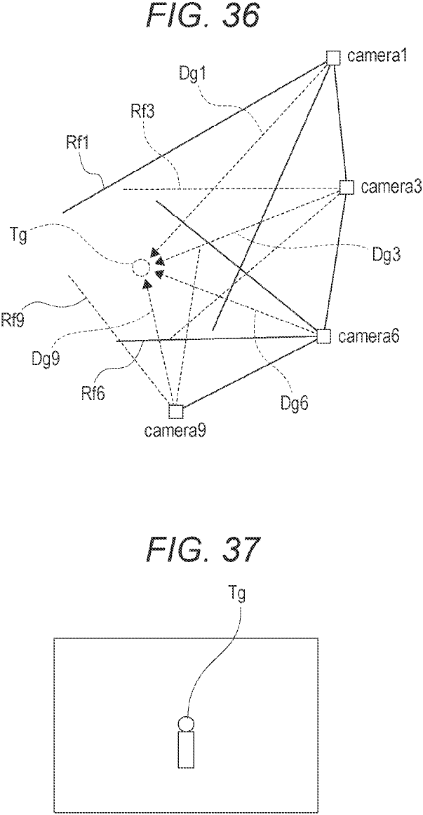

First, the significance of the target Tg will be described with reference to FIGS. 36 and 37.

As described above, the target Tg is used to determine the line-of-sight direction from the viewpoint in the free viewpoint image. FIG. 36 illustrates the field of view Rf (Rf1, Rf3, Rf6, Rf9 for each camera position) and the line-of-sight direction Dg (Dg1, Dg3, Dg6, Dg9 for each camera position) from each camera position (here, cameral, camera3, camera6, and camera9) in the movement trajectory of the viewpoint.

As described above, in the generation of the free viewpoint image in this example, it is possible to designate the period of facing the target Tg in the movement period of the viewpoint. In other words, it is possible to designate a period during which the target Tg continues to be positioned at a predetermined position in the image frame as a period for following the target Tg. In this example, the following of the target Tg is performed such that the target Tg continues to be positioned at the center position in the image frame as illustrated in FIG. 37, for example.

FIG. 36 illustrates the line-of-sight direction Dg and the field of view Rf in the case of following the target Tg within the movement period of the viewpoint from the cameral to the camera9. However, in this example, as illustrated in the drawing, the line-of-sight direction Dg and the field of view Rf are set so as to capture the target Tg at the center position in the image frame.

In this example, the position of the target Tg can be adjusted on the creation operation screen Gg. As the adjustment operation of the target Tg, for example, it is conceivable to perform an operation of adjusting the position of the target mark Mt displayed in the camerawork window 53.

When the position of the target Tg is changed by adjustment, the camerawork generation processing unit 34 sets the line-of-sight direction Dg and the field of view Rf at each viewpoint position so as to keep the changed target Tg at a predetermined position in the image frame.

Here, in the creation operation screen Gg of this example, it is possible to perform designation of moving the position of the target Tg with the lapse of time during the viewpoint movement period.

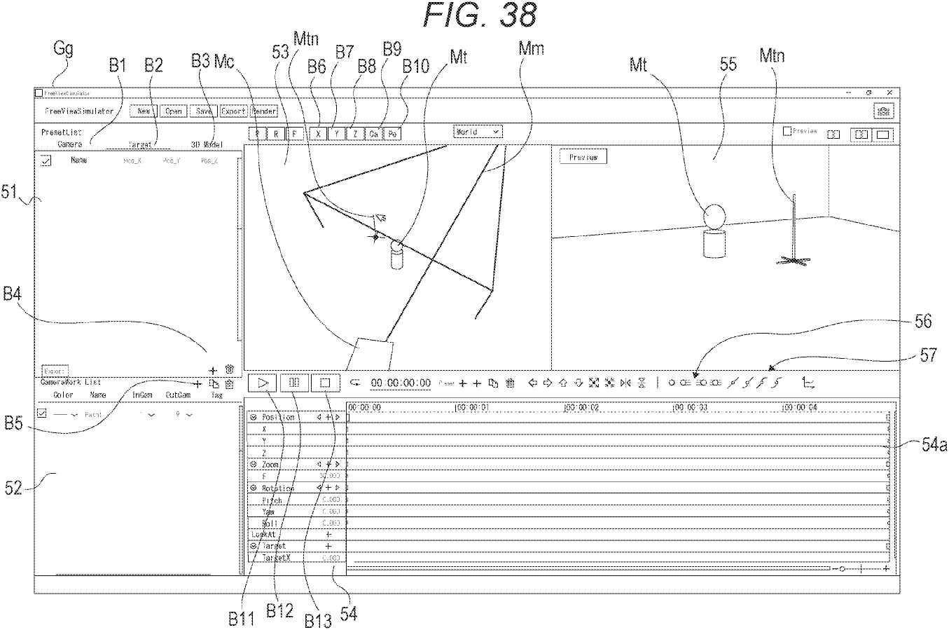

A specific operation procedure of the movement designation of the target Tg will be described with reference to FIGS. 38 to 45.

First, as illustrated in FIG. 38, an operation of designating the new point Ptn of the target Tg is performed. Specifically, in the camerawork window 53, an operation of setting the target position designation mark Mtn for designating the new point Ptn at a desired position is performed. Although not illustrated, the target position designation mark Mtn is superimposed and displayed on the target mark Mt in the initial state, and the user drags and drops the target position designation mark Mtn from the position of the target mark Mt to a desired position.

By such an operation, the new point Ptn of the target Tg is designated.

Next, the user operates the target button B2 provided on the preset list display unit 51 to bring the preset list display unit 51 into a display state of the list of target Tg. In the display state, as illustrated in FIG. 39, an addition button B20 of the target Tg is displayed on the preset list display unit 51, and the user can give an instruction to add the new target Tg to the position designated by the target position designation mark Mtn by operating the addition button B20.

In response to the operation of the addition button B20, identification information (“Target0” in the drawing) and position information (position information indicating the new point Ptn) about the added target Tg are displayed on the preset list display unit 51 as illustrated in the drawing. Furthermore, in the camerawork window 53, an additional target mark Mtt as a mark representing the added target Tg is displayed at the position of the target position designation mark Mtn.

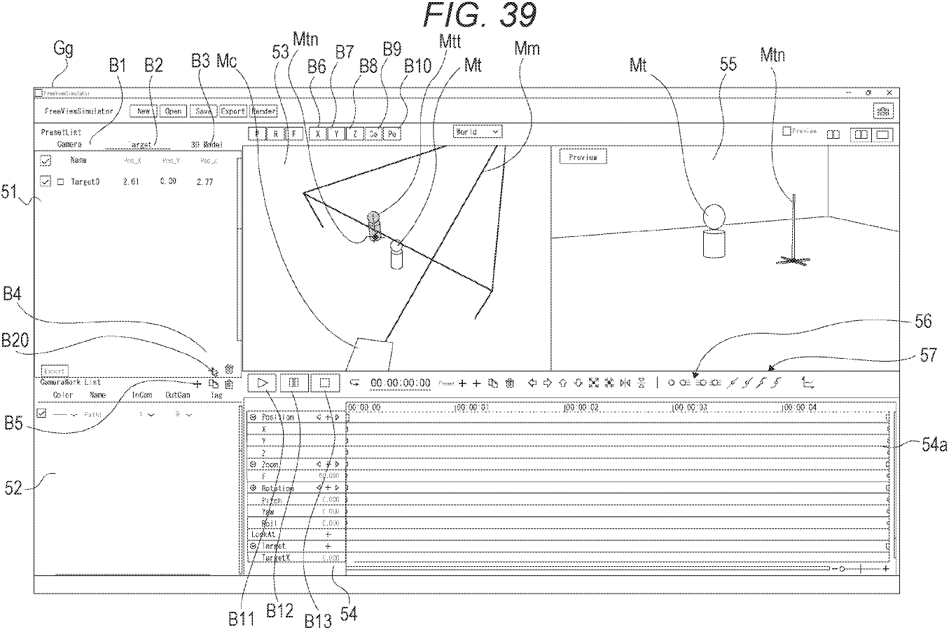

Next, the user performs an operation of adding a new target to the timeline as illustrated as transitions from FIG. 40 to FIG. 42. Specifically, an operation of dragging and dropping a target (here, “Target0”) newly displayed on the preset list display unit 51 to a desired position on the timeline of the timeline operation unit 54a is performed.

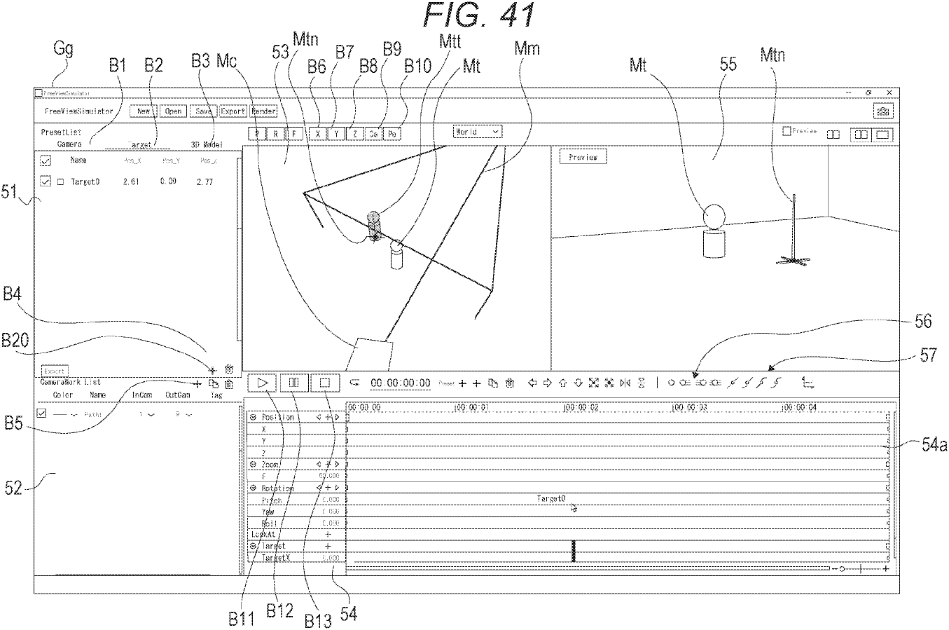

The arrival target timing mark Mem as illustrated in FIG. 42 is displayed at the position on the timeline designated by the drop operation. The arrival target timing mark Mem is a mark indicating the arrival target timing to the new point Ptn of the target Tg when the position of the target Tg of the viewpoint is moved from the position indicated by the target mark Mt (that is, the initial position of the target Tg) to the position indicated by the additional target mark Mtt (that is, the new point Ptn). In other words, the operation of adding a new target to the timeline as described above is an operation of designating a target timing at which the position of the target Tg reaches the new point Ptn with respect to the movement of the target Tg.

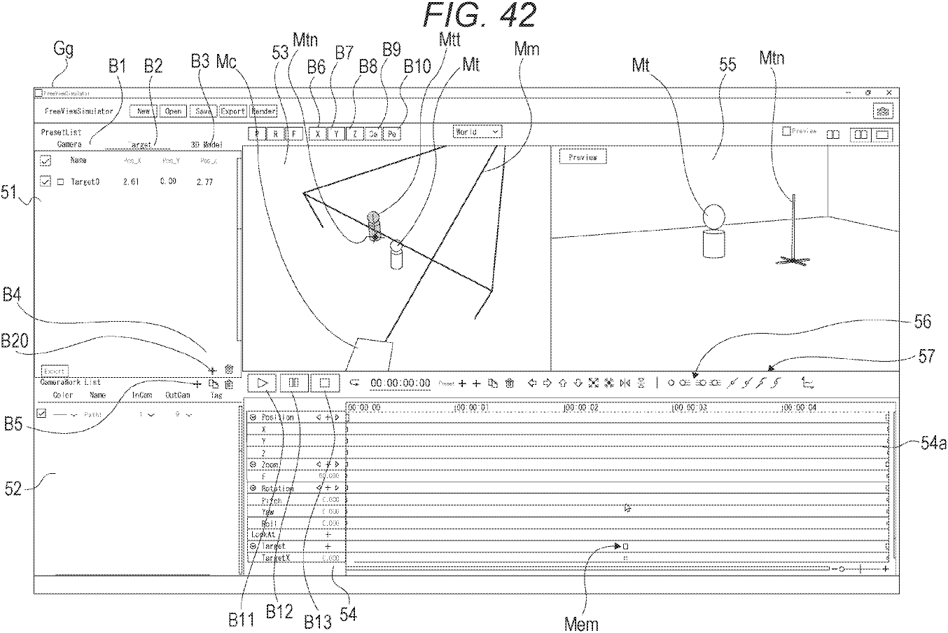

After performing the operation of adding a new target to the timeline as described above, the user performs an operation of designating a period of time to face the target Tg as illustrated in FIGS. 43 to 45.

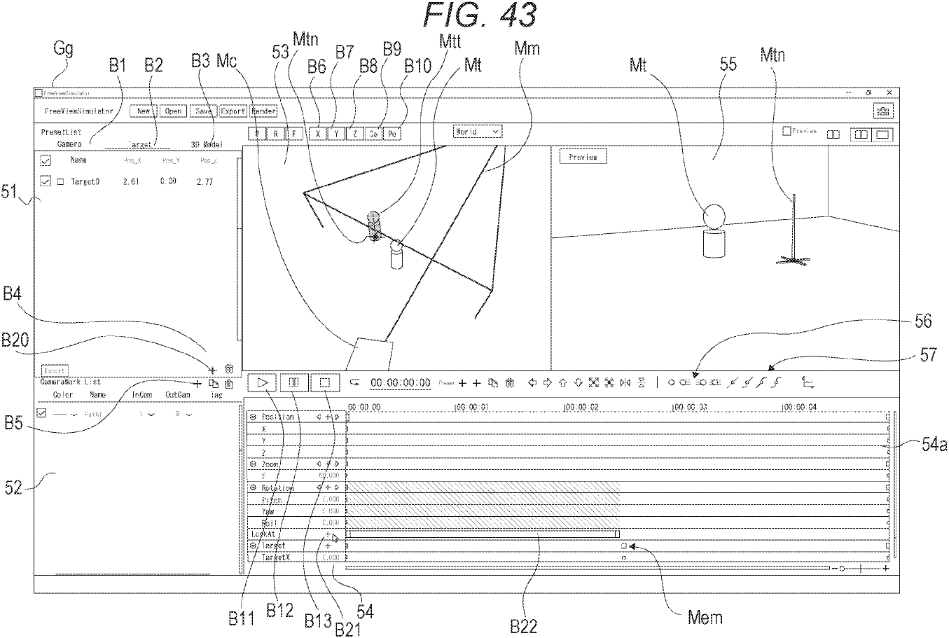

In designating the period of facing the target Tg, first, as illustrated in FIG. 43, the LookAt button B21 provided in the timeline operation unit 54a is operated. Then, as illustrated, a period designation bar B22 for designating a period is displayed on the timeline. The period designation bar B22 is displayed in a mode of designating a period from the movement start time point of the viewpoint to the time point indicated by the arrival target timing mark Mem as illustrated in the drawing at the stage where the Look At button B21 is operated. In a case where the user desires to change the period of facing the target Tg, the user performs an operation of extending or reducing the period designation bar B22. Here, as illustrated in FIGS. 44 and 45, it is assumed that the period designation bar B22 is extended and the period of facing the target Tg is designated as the period until the movement end point of the viewpoint (period from the start to the end of the movement of the viewpoint).

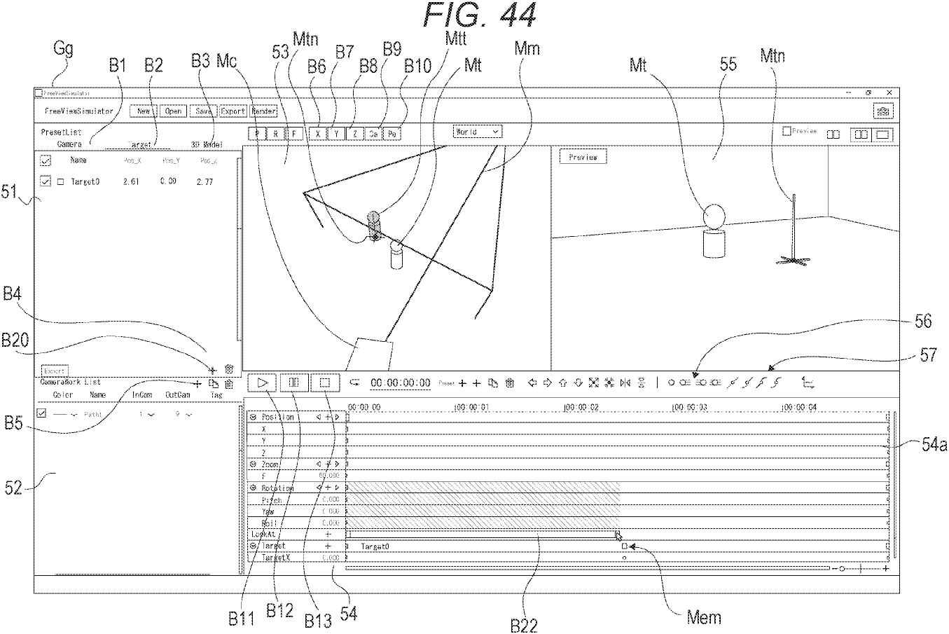

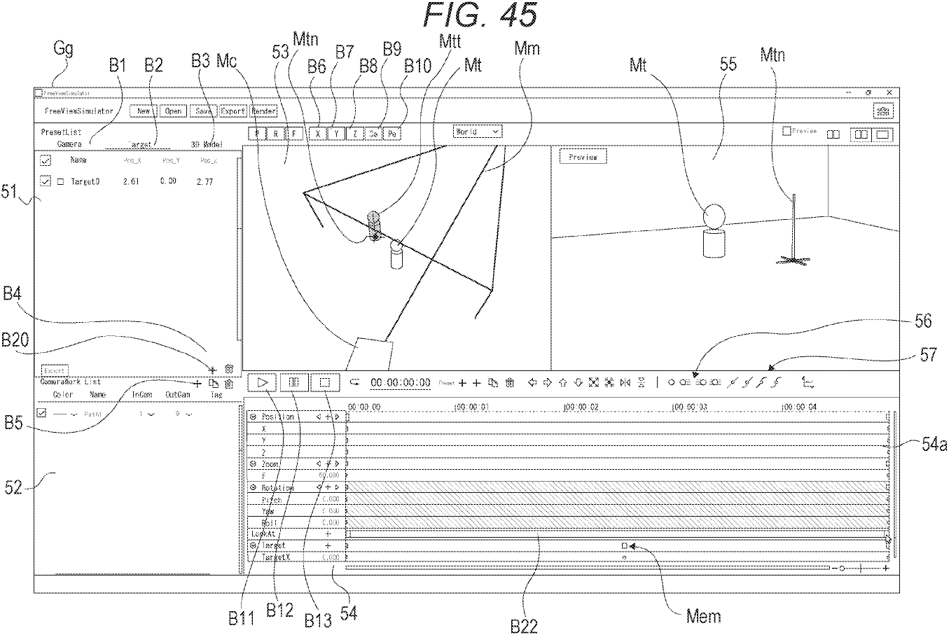

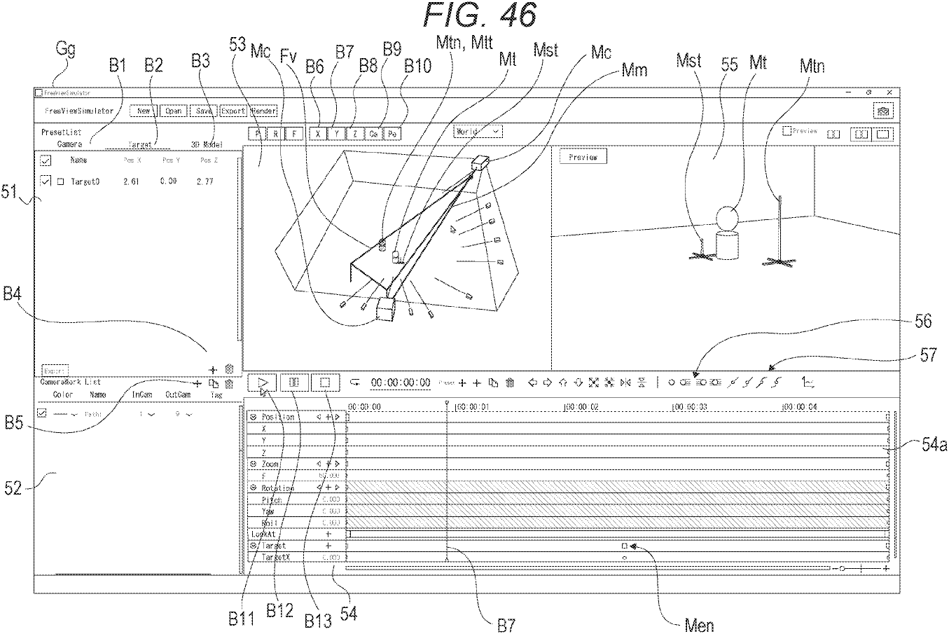

FIGS. 46 to 49 are diagrams for describing a preview reproduction image of camerawork and a preview reproduction image of an observation image from a viewpoint in a case where various designation operations for the movement of the target Tg described with reference to FIGS. 38 to 45 are performed. Specifically, the transition of the images displayed in the camerawork window 53 and the preview window 55 in response to the operation of the reproduction button B11 after various designation operations regarding the movement of the target Tg described with reference to FIGS. 38 to 45 are performed is illustrated.

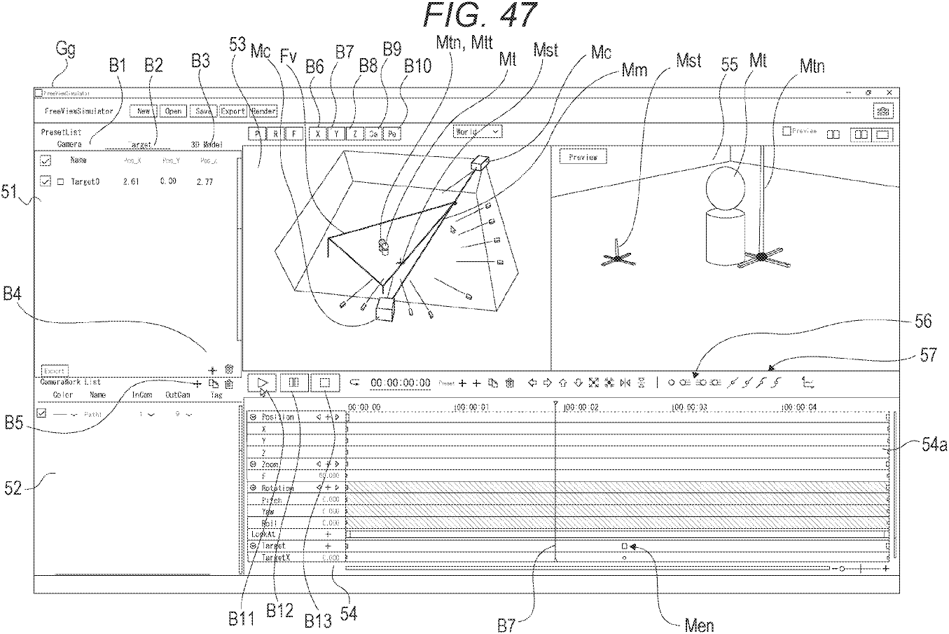

In this case, the movement of the target Tg is performed so as to reach the new point Ptn at the timing indicated by the arrival target timing mark Mem on the timeline within the period from the start to the end of the movement of the viewpoint. Therefore, the target mark Mt gradually approaches the target position designation mark Mtn (the additional target mark Mtt in the camerawork window 53) as illustrated in FIGS. 46 and 47 from the viewpoint movement start time point to the timing indicated by the arrival target timing mark Mem. Here, in FIGS. 46 and 47, the target initial position mark Mst is illustrated in each of the camerawork window 53 and the preview window 55, but the target initial position mark Mst is a mark indicating the position of the target Tg at the start of movement of the viewpoint.

In this example, the period of facing the target Tg is designated as the entire period from the start to the end of movement of the viewpoint. That is, a period exceeding the period until the timing indicated by the arrival target timing mark Mem is designated as the period of facing the target Tg.

In this way, in a case where the period of facing the target Tg is designated as a period exceeding the period up to the arrival target timing mark Mem, in this example, the position of the target Tg is gradually returned from the new point Ptn to the movement start position as the movement of the target Tg in the period exceeding the period up to the arrival target timing mark Mem.

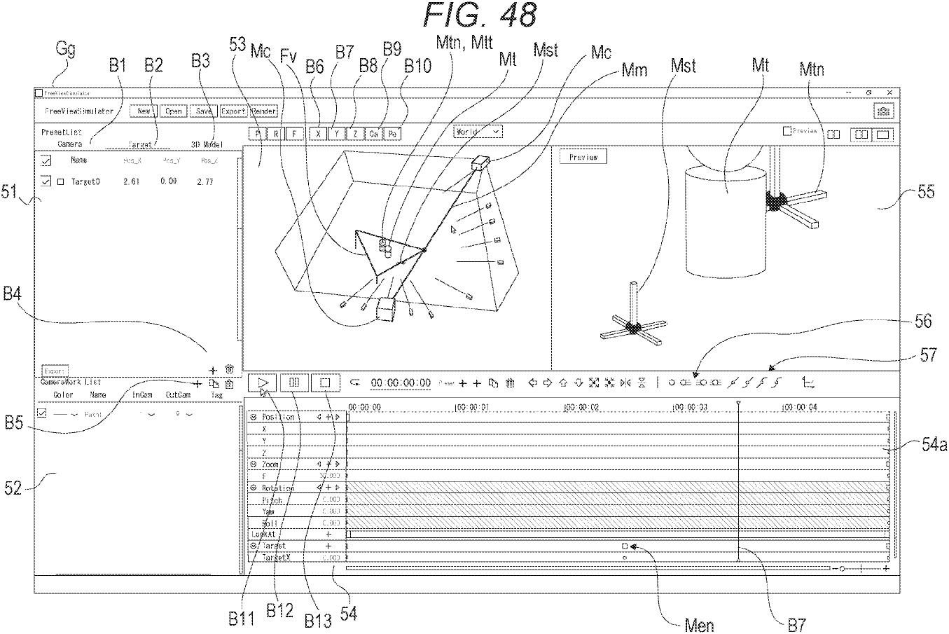

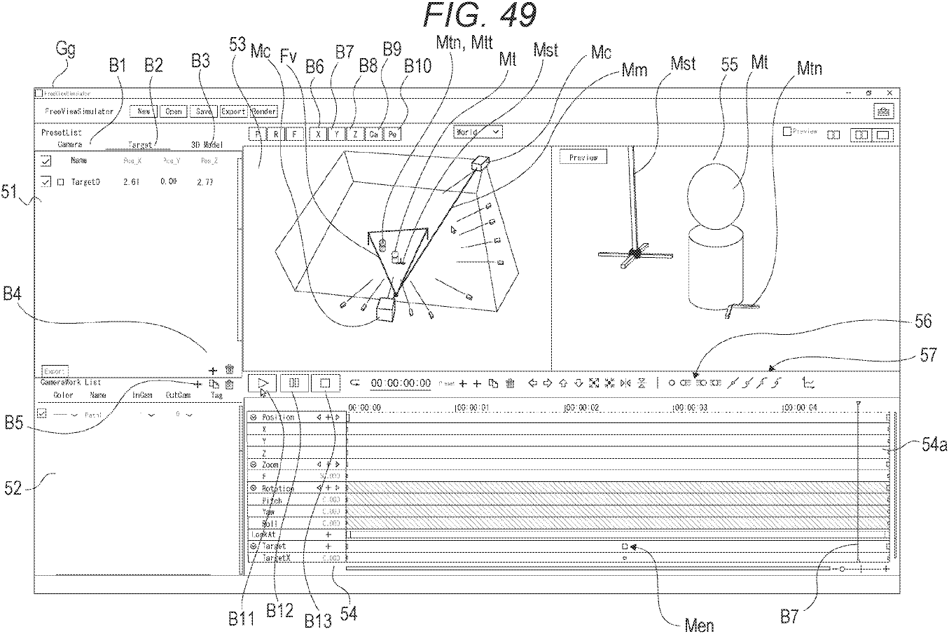

Therefore, in a period exceeding the period up to the arrival target timing mark Mem in the period of facing the target Tg, the target mark Mt gradually approaches the target initial position mark Mst indicating the movement start position with the lapse of time as illustrated in FIGS. 48 and 49.

By enabling the movement of the target Tg as described above, the degree of freedom in creating a free viewpoint image can be improved as compared with a case where the position of the target Tg is fixed.

In the above description, in a case where designation to move the position of the target Tg is performed, a case where the period exceeding the period up to the arrival target timing mark Mem is designated as the period of facing the target Tg has been illustrated. However, as illustrated in FIG. 50, the period from the viewpoint movement start time point up to the arrival target timing mark Mem can also be designated as the period of facing the target Tg. In this case, in the viewpoint movement period after the period up to the arrival target timing mark Mem, a free viewpoint image that does not follow the designated target Tg is generated.

Furthermore, in the above description, an example has been described in which one target Tg is added as the addition of the new target Tg using the target position designation mark Mtn, but a plurality of targets Tg can also be added.

Then, in that case, as illustrated in FIG. 51, for example, the period of facing the target Tg can be individually designated for each added target Tg. FIG. 51 illustrates a state in which, in a case where two targets Tg (hereinafter, referred to as a target Tg-1 and a target Tg-2) are added as new targets Tg by the operation using the target position designation mark Mtn (see FIGS. 38 and 39), by adding the targets Tg-1 and Tg-2 to different positions on the timeline, the arrival target timing marks Mem-1 and Mem-2 are individually displayed on the timeline. In this case, with respect to the target Tg-1, as indicated by a period designation bar B22-1 in the figure, it is assumed that a period from the movement start time point of the viewpoint to the arrival target timing mark Mem-1 is designated as a period of facing the target Tg. In addition, for the target Tg-2, as indicated by a period designation bar B22-2 in the figure, it is assumed that a period from a time point after a lapse of a predetermined time from a time point indicated by the arrival target timing mark Mem-1 to a timing indicated by the arrival target timing mark Mem-2 is designated as a period of facing the target Tg.

In this case, in the period indicated by the period designation bar B22-1 within the movement period of the viewpoint, a free viewpoint image in which the position of the target Tg gradually moves from the initial position (position of the target Tg at the viewpoint movement start time point) to the position of the target Tg-1 is generated, and in the period indicated by the period designation bar B22-2, for example, a free viewpoint image in which the position of the target Tg gradually moves from the initial position to the position of the target Tg-2 is generated.

Here, as understood from the description of FIG. 51, the creation operation screen Gg can accept an operation of designating the positions of a plurality of targets Tg.

As a result, it is possible to generate a free viewpoint image that follows the target A in a certain period and follows the target B in another period in the viewpoint movement period, and freely improve the setting of the target to be followed.

Therefore, the degree of freedom in creating a free viewpoint image can be improved.

Note that, in the above description, as the designation of the position of the target Tg, an example of designating the position of the target Tg as the movement destination point in a case where the position of the target Tg is moved during the viewpoint movement period has been described. However, the designation of the position of the target Tg can also be performed as designation of the position of the target Tg that is not moved during the viewpoint movement period.

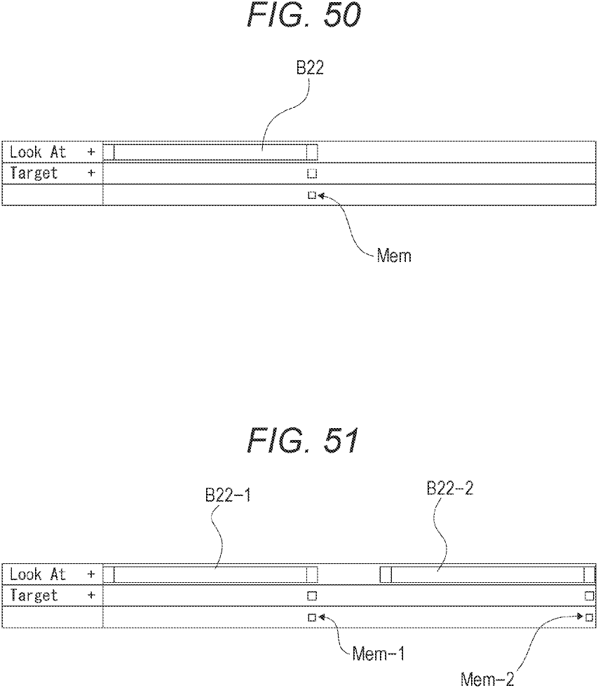

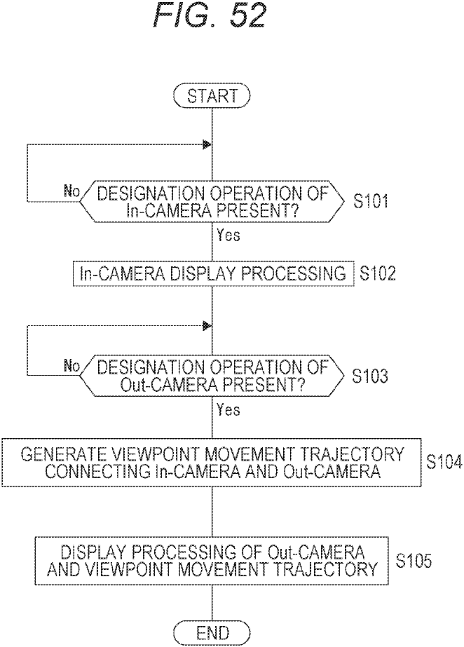

Processing related to generation and display of a movement trajectory according to an operation input on the creation operation screen Gg will be described with reference to the flowcharts of FIGS. 52 and 53.

Note that the processing illustrated in FIGS. 52 and 53 is executed by the CPU 71 of the free viewpoint image server 2. This processing is processing for realizing some functions of the camerawork generation processing unit 34 described above.

FIG. 52 illustrates processing related to generation and display of the viewpoint movement trajectory according to the designation of the In-camera and the Out-camera.

First, in step S101, the CPU 71 waits for the designation operation of the In-camera. In this example, this designation operation is performed as an operation of designating the camera number described in the pull-down list of In-cameras in the entry of the camerawork displayed on the camerawork list display unit 52 as illustrated in FIG. 22.

In a case where the designation operation of the In-camera is performed, the CPU 71 performs various types of display processing related to the In-camera as described with reference to FIG. 23 as the In-camera display processing in step S102. For example, processing for highlighting the camera position mark Mc and displaying the field-of-view information Fv for the camera designated as the In-camera in the camerawork window 53 is performed.

In step S103 subsequent to step S102, the CPU 71 waits for the designation operation of the Out-camera (see the description of FIG. 24), and advances the processing to step S104 in a case where the designation operation of the Out-camera is performed.

In step S104, the CPU 71 performs processing of generating a viewpoint movement trajectory connecting the In-camera and the Out-camera.

Then, in subsequent step S105, the CPU 71 executes processing of displaying the Out-camera and the viewpoint movement trajectory. That is, various display processes related to the Out-camera and the display process of the movement trajectory information Mm of the viewpoint as described with reference to FIG. 25 are performed.

The CPU 71 terminates the series of processing illustrated in FIG. 52 in response to the execution of the display processing in step S105.

FIG. 53 illustrates processing related to generation and display of a viewpoint movement trajectory according to designation of a via-point.

In step S110, the CPU 71 waits for the designation operation of the via-point. In this example, the designation operation is a series of operations including the operation on the timeline as described with reference to FIGS. 26 to 28.

When the via-point is designated, the CPU 71 generates a viewpoint movement trajectory through the designated point in step S111. That is, a movement trajectory of the viewpoint connecting the In-camera, the designated point, and the Out-camera is generated.

Then, in subsequent step S112, the CPU 71 performs processing of displaying the via-point and the viewpoint movement trajectory. That is, for the designated via-point, processing for highlighting the camera position mark in the camerawork window 53, displaying the field-of-view information Fv, and displaying the via-point mark Mv in the timeline as described in FIG. 29 is performed.

The CPU 71 terminates the series of processing illustrated in FIG. 53 in response to the execution of the display processing in step S112.

### 8. GUI for Creating Free Viewpoint Image

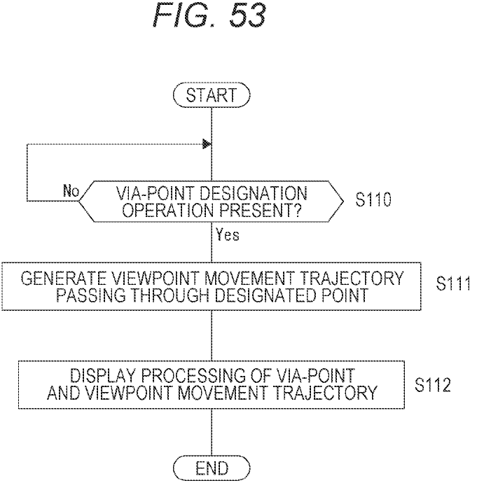

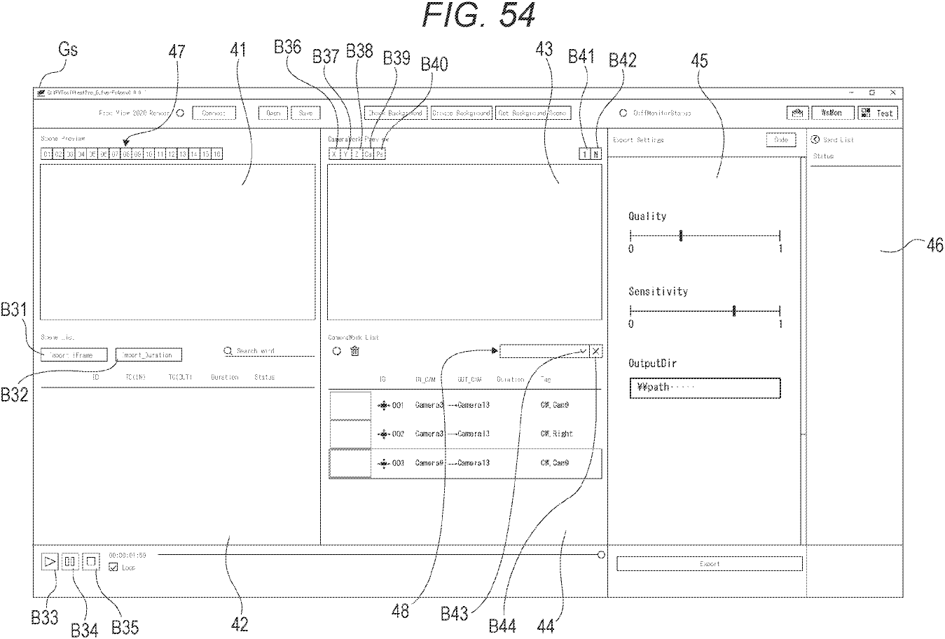

Next, details of the camerawork designation screen Gs illustrated in FIG. 7, an example of a camerawork designation procedure used for generating a free viewpoint image, and various functions related to camerawork designation will be described with reference to FIGS. 54 to 72.

FIG. 54 is a diagram illustrating an initial screen of the camerawork designation screen Gs. Here, the processing related to the display of various types of information on the screen of the camerawork designation screen Gs to be described below is performed by the above-described display processing unit 32a (see FIG. 5).

As described above, the camerawork designation screen Gs is provided with the scene window 41, the scene list display unit 42, the camerawork window 43, the camerawork list display unit 44, the parameter display unit 45, and the transmission window 46.

Furthermore, on the camerawork designation screen Gs, a camera designation operation unit 47, a still image import button B31, and a moving image import button B32 are provided with respect to the scene window 41, and a reproduction button B33, a pause button B34, and a stop button B35 are provided at the lower part of the screen.

Furthermore, on the camerawork designation screen Gs, an X-axis viewpoint button B36, a Y-axis viewpoint button B37, a Z-axis viewpoint button B38, a Ca viewpoint button B39, a Pe viewpoint button B40, a display path restriction button B41, and a restriction release button B42 are provided for the camerawork window 43, and a filtering operation unit 48 is provided for the camerawork list display unit 44. The filtering operation unit 48 is provided with a pull-down button B43 and a reset button B44.

In generating the free viewpoint image on the camerawork designation screen Gs, first, the user performs an operation for importing an image of a generation target section of the free viewpoint image, in other words, an image of a scene as a generation target of the free viewpoint image, as the image data V1 to V16 described above. In performing this import, the user operates either the still image import button B31 or the moving image import button B32 in the drawing. The still image import button B31 is a button for giving an instruction to import the image data V1 to V16 by a still image for generating the still image FV clip described above as a free viewpoint image, and the moving image import button B32 is a button for giving an instruction to import the image data V1 to V16 by a moving image for generating the moving image FV clip described above as a free viewpoint image.

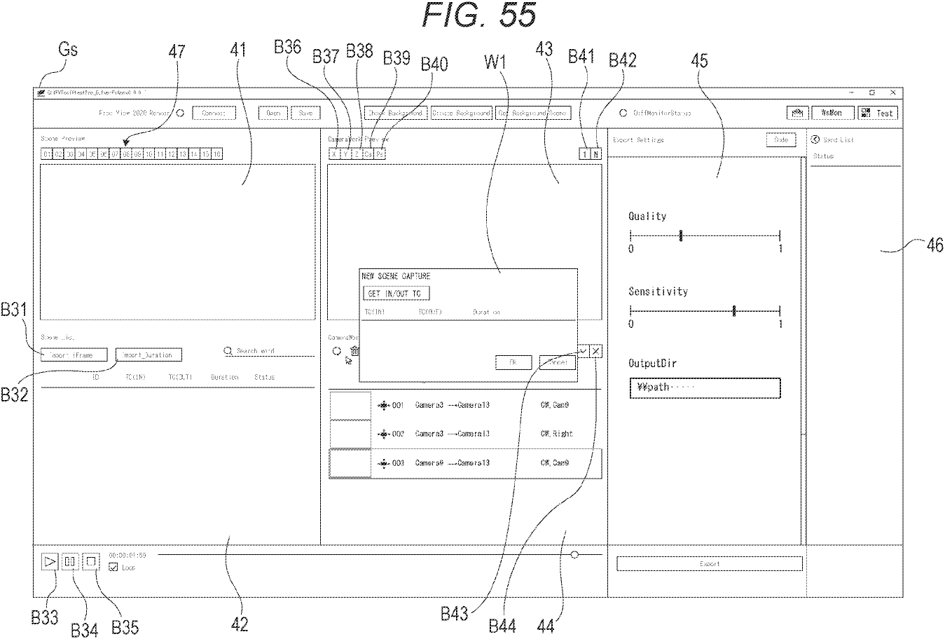

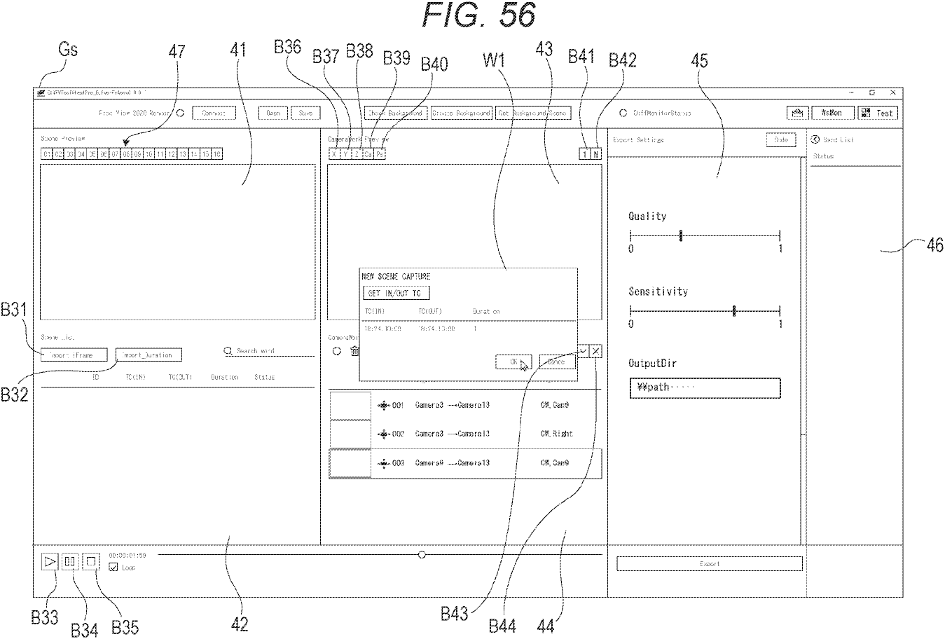

In response to the operation of any one of the still image import button B31 and the moving image import button B32, a pop-up window W1 as illustrated in FIG. 55 is displayed on the camerawork designation screen Gs, and the user can display information indicating the image data V1 to V16 to be imported in the pop-up window W1 as illustrated in FIG. 56 by operating the “GET IN/OUT TC” button provided in the pop-up window W1. When importing the displayed data, the user operates an OK button provided in the pop-up window W1.

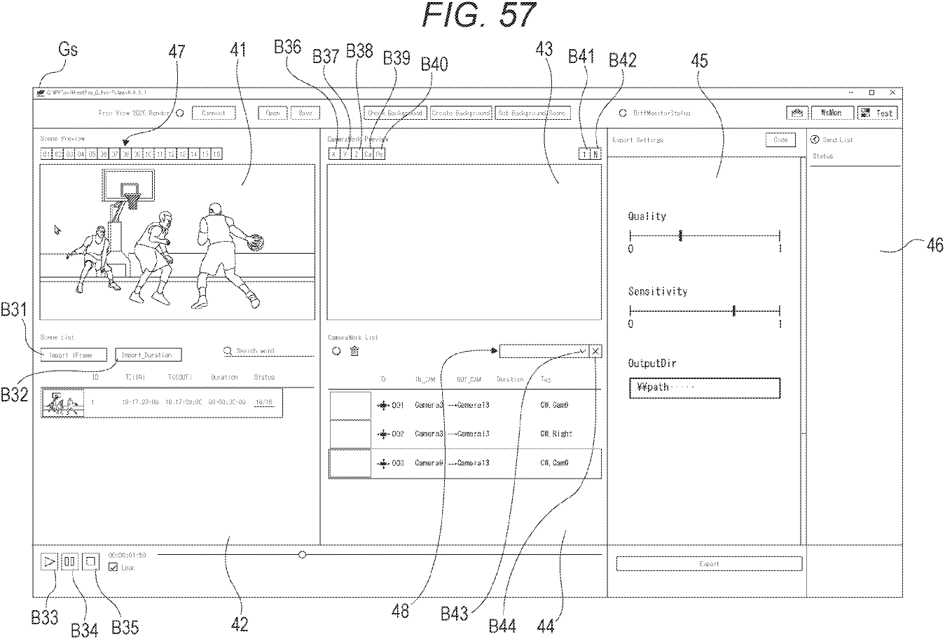

When the OK button is operated, information on the imported scene is added in the scene list display unit 42 on the camerawork designation screen Gs as illustrated in FIG. 57, and an image of the imported scene is displayed in the scene window 41. As the information of the scene added to the list by the import, a thumbnail image of the scene, time information (in this example, both the start time and the end time of the scene are displayed) indicated by the time code, information indicating a period of the scene, and the like are displayed. Note that the illustrated example is a case where image data V1 to V16 as still images are imported, and the value indicating the period of the scene is “0”.

The camera designation operation unit 47 is provided with a camera selection button for selecting which camera displays an image for each camera for the imported scene, that is, image data V1 to V16.

On the camerawork designation screen Gs, the camerawork can be previewed in the camerawork window 43.

In the camerawork window 43, the observation viewpoint of the camerawork in the three-dimensional space can be switched by the X-axis viewpoint button B36, the Y-axis viewpoint button B37, the Z-axis viewpoint button B38, the Ca viewpoint button B39, and the Pe viewpoint button B40.

The X-axis viewpoint button B36, the Y-axis viewpoint button B37, and the Z-axis viewpoint button B38 are buttons for switching the observation viewpoint in the three-dimensional space to the viewpoint on the X-axis, the viewpoint on the Y-axis, and the viewpoint on the Z-axis, respectively. Here, the X axis, the Y axis, and the Z axis are three axes that define a three-dimensional space. In this example, the X axis is an axis that defines a horizontal direction, the Y axis is an axis that defines a vertical direction, and the Z axis is an axis that defines a direction orthogonal to both the X axis and the Y axis.

The Pe viewpoint button B40 is a button for switching the observation viewpoint of the three-dimensional space to an arbitrary viewpoint designated by the user.

The Ca viewpoint button B39 is a button for switching the observation viewpoint in the three-dimensional space to the viewpoint (point on the viewpoint movement trajectory) in the camerawork.

FIGS. 58, 59, 60, 61, and 62 illustrate display images in the camerawork window 43 when the X-axis viewpoint button B36, the Y-axis viewpoint button B37, the Z-axis viewpoint button B38, the Pe viewpoint button B40, and the Ca viewpoint button B39 are operated, respectively.

Here, the camerawork window 43 displays information indicating the camerawork displayed on the camerawork list display unit 44. The camerawork displayed on the camerawork list display unit 44 is the camerawork created through the creation operation screen Gg described above, and is a candidate for the camerawork used for generating the free viewpoint image. In other words, it is a camerawork that can be designated as a camerawork used for generating a free viewpoint image.

In the camerawork window 43, as the information indicating the camerawork, the movement trajectory information Mm, the camera position mark Mc, and the field-of-view information Fv described above (also in this case, the field of view is a piece of information indicated by a figure) are displayed. Furthermore, as particularly illustrated in FIG. 61, the camera position mark Mc indicating the positions of the In-camera and the Out-camera is displayed to be larger than the other camera position marks Mc, and the positions of the In-camera and the Out-camera are indicated. Here, the camera position marks Mc of the In-camera and the Out-camera, that is, the information (start point arrangement position information, end point arrangement position information) indicating the positions of the camera serving as the movement start point and the camera serving as the movement end point of the viewpoint may be indicated in a manner different from the camera position marks Mc of other cameras other than the In-camera and the Out-camera, and the manner is not limited to the display size being different.

Furthermore, in the camerawork window 43, the target mark Mt indicating the position of the target Tg described above is displayed as the information indicating the camerawork.

Note that, in the case of FIG. 62, that is, in a case where the Ca viewpoint button B39 is operated, since the observation image is from the viewpoint movement trajectory, the movement trajectory information Mm, the camera position mark Mc, and the field-of-view information Fv are not displayed, and the target mark Mt is displayed.

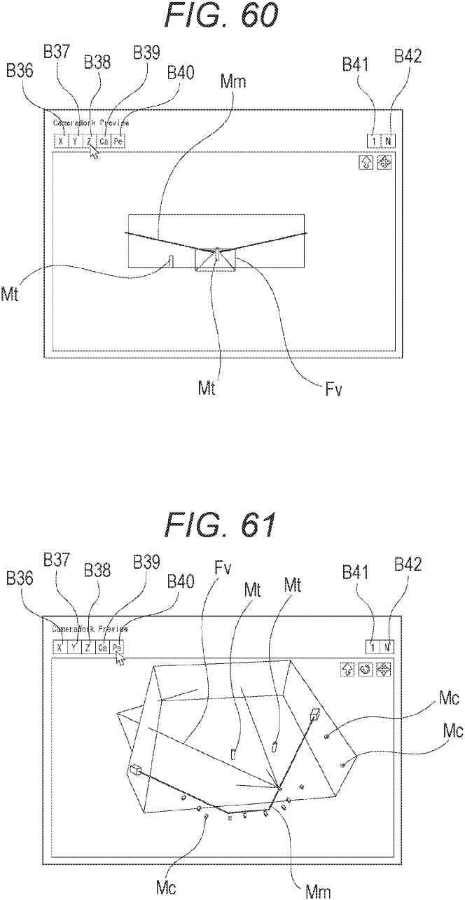

In the drawing, two target marks Mt are displayed as the target marks Mt (particularly, refer to FIGS. 60 and 61), but this means that cameraworks in which different targets Tg are set are mixed as a plurality of cameraworks as candidates displayed on the camerawork list display unit 44. That is, the camerawork as a candidate in this case includes, for example, a camerawork in which the target Tg whose position is indicated by the target mark Mt on the left side in FIG. 61 is set and a camerawork in which the target Tg whose position is indicated by the target mark Mt on the right side in FIG. 61 is set.

In the camerawork window 43, dynamic preview reproduction of the camerawork can be performed. Such dynamic preview reproduction can be instructed by the operation of the reproduction button B33.

When the reproduction button B33 is operated, in each case of the viewpoint on the X-axis, the viewpoint on the Y-axis, the viewpoint on the Z-axis, and any viewpoint illustrated in FIGS. 58 to 61, an image in which the position and shape of the field-of-view information Fv change from moment to moment with the movement of the viewpoint on the movement trajectory is displayed. Furthermore, in the case of FIG. 62, images obtained by observing the three-dimensional space of the object from each point from the viewpoint movement start point to the end point on the viewpoint movement trajectory are sequentially switched and displayed. That is, an observation image of a three-dimensional space that changes from moment to moment with movement of the viewpoint is displayed.

Note that the pause button B12 and the stop button B13 are buttons for instructing pause and stop of the dynamic preview reproduction as described above, respectively.

Here, in a case of preview reproduction of an observation image from a viewpoint as in the case of FIG. 62, a free viewpoint image as an FV clip generated using the selected camerawork can be displayed as the display image. That is, the above-described real three-dimensional model is generated on the basis of the imported image data V1 to V16, and a two-dimensional image rendered by pasting a texture or the like on the real three-dimensional model is displayed as a preview image.

However, since the generation of the free viewpoint image as the FV clip requires a corresponding processing load and processing time, the time for making the user wait until the start of the preview reproduction becomes long, and there is a possibility that the rapid generation of the free viewpoint image is hindered.

Therefore, in this example, in the case of preview reproduction of the observation image from the viewpoint as in the case of FIG. 62, not the real three-dimensional model generated on the basis of the image data V1 to V16 (that is, the captured image of the real space) but an image obtained by rendering the above-described virtual three-dimensional model (virtual 3D model of the real space) is displayed as the display image.

As a result, the processing time required to display the preview of the observation image from the viewpoint can be shortened, and the work of creating the free viewpoint image can be quickly executed.

Here, as described above, in the camerawork window 43, it is possible to display the selected camerawork or a plurality of selectable cameraworks.

Although the case where the camerawork information for only the selected camerawork is displayed is illustrated in FIGS. 58 to 62, the camerawork window 43 can also display the camerawork information of all the plurality of cameraworks displayed on the camerawork list display unit 44.

In this manner, switching of the number of cameraworks to be displayed in the camerawork window 43 can be instructed by the display path restriction button B41 and the restriction release button B42. The display path restriction button B41 is a button for instructing display of only the selected camerawork, and the restriction release button B42 is a button for releasing the state of being limited to the display of only the selected camerawork, and functions as an instruction button for displaying the camerawork information of all the plurality of cameraworks displayed on the camerawork list display unit 44.

Next, the camerawork list display unit 44 will be described.

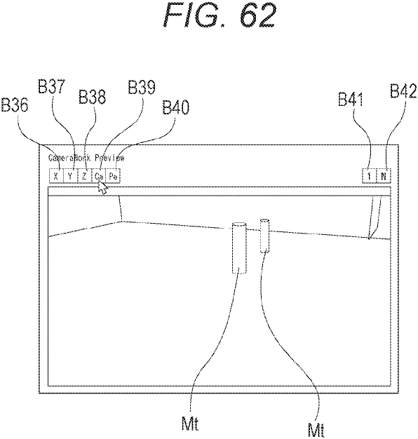

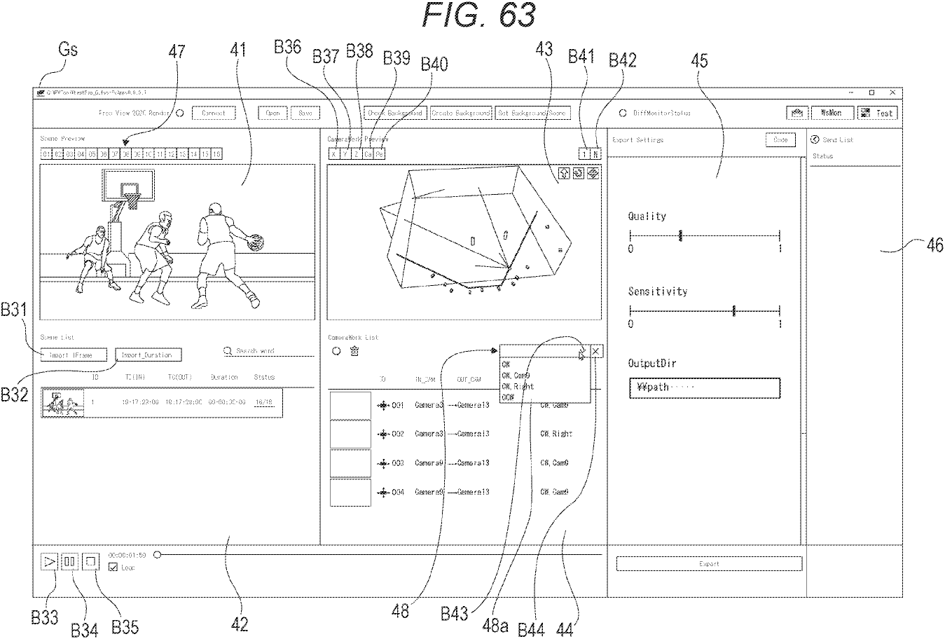

The camerawork as a candidate that can be used to generate the free viewpoint image is displayed on the camerawork list display unit 44 (see, for example, FIG. 63). Examples of the camerawork information displayed on the camerawork list display unit 44 include camerawork ID, identification information of the In-camera and the Out-camera, tag information, and the like.

Furthermore, in this example, the thumbnail image of the movement trajectory information Mm is displayed for each camerawork in the camerawork list display unit 44. By displaying such thumbnail images, it is possible to cause the user to confirm what viewpoint movement trajectory each camerawork has even on the camerawork list.

Here, the tag information is information that can be added to each created camerawork when the camerawork is created through the creation operation screen Gg described above, and is text information in this example. The tag information for the camerawork can be set by, for example, inputting information to a field of “Tag” (See, for example, FIG. 19) provided in the entry of the camerawork on the camerawork list display unit 52 of the creation operation screen Gg.

Hereinafter, this tag information is referred to as “tag information 11”.

The camerawork list display unit 44 is provided with the filtering operation unit 48 for filtering the camerawork to be displayed in the list display, that is, the camerawork to be displayed on the camerawork list display unit 44.

A function related to filtering of the camerawork using the filtering operation unit 48 will be described with reference to FIGS. 63 to 65.

First, when filtering is performed, the user operates a pull-down button B43 on the filtering operation unit 48 as illustrated in FIG. 63. Then, as illustrated in the drawing, a pull-down list 48a is displayed. A list of pieces of tag information I1 is displayed in the pull-down list 48a. The tag information I1 displayed in the pull-down list 48a is the tag information I1 set for each camerawork as a candidate. That is, as illustrated in the drawing, in a case where there is a camerawork in which tag information I1 such as “CW, Cam9” and “CW, Right” is set as a candidate, the tag information I1 such as “CW, Cam9” and “CW, Right” is displayed in the pull-down list 48a.

The user can give an instruction to display only the camerawork in which the tag information I1 is set on the camerawork list display unit 44 by performing an operation (for example, a click operation or the like) to designate the tag information I1 displayed in the pull-down list 48a.

Note that, as can be understood from this point, the display portion of each piece of tag information I1 in the pull-down list 48a corresponds to filtering condition information indicating a filtering condition for filtering and displaying the camerawork information.

FIG. 64 illustrates a state of the camerawork designation screen Gs in a case where “CW, Right” is designated as the tag information I1. In this case, only the camerawork in which “CW, Right” is set as the tag information I1 is displayed on the camerawork list display unit 44.

In this case, since there is only one camerawork to which the “CW, Right” is set, information of the camerawork to which the “CW, Right” is set is displayed in the camerawork window 43. Note that the camerawork in which “CW, Right” is set is the camerawork in which the target Tg whose position is indicated by the right target mark Mt among the targets Tg whose positions are indicated by the two target marks Mt illustrated in the camerawork window 43 of FIG. 61 described above is set. Therefore, in the camerawork window 43 in this case, only one target mark Mt is displayed as camerawork information.

Note that, in a case where there is a plurality of cameraworks to which the designated tag information I1 is set, for example, it is conceivable to display information of the camerawork displayed at a predetermined position such as a head position on the list in the camerawork window 43.

By filtering the camerawork based on the tag information I1 as described above, filtering based on an arbitrary standard can be realized depending on information content set as the tag information I1. For example, if team information (for example, team A, team B, or the like) is set as the tag information I1, filtering based on a criterion such as whether the camerawork is for a shooting scene of team A or a shooting scene of team B can be realized. Alternatively, by setting information (for example, clockwise rotation, counterclockwise rotation, and the like) indicating the movement direction of the viewpoint as the tag information I1, filtering based on the movement direction of the viewpoint can be realized.

Furthermore, by setting the camera closest to the visual field of interest, such as the visual field closest to the subject to be the target Tg, as the tag information I1, it is possible to realize filtering of the camerawork with the visual field of interest as a reference.

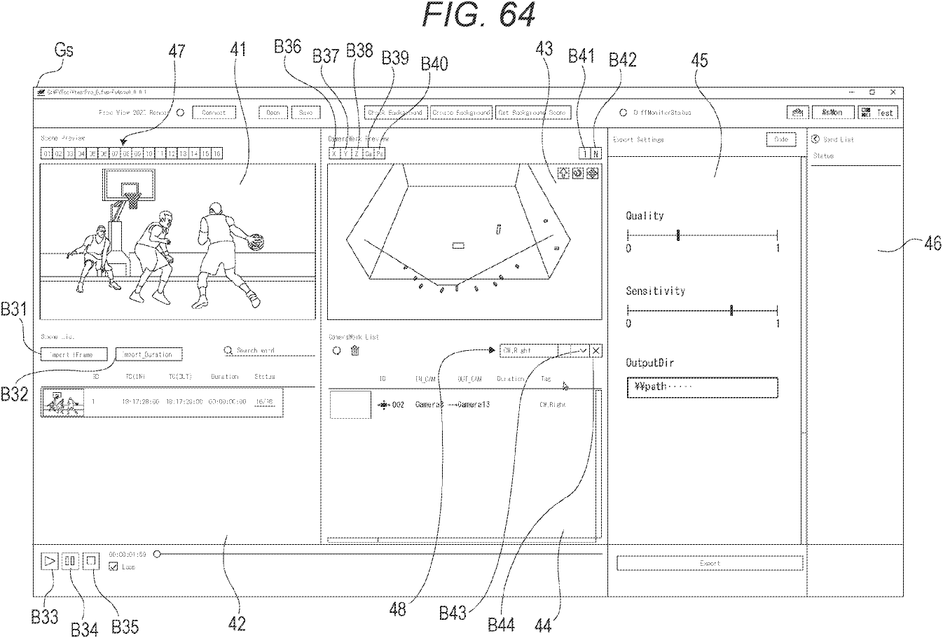

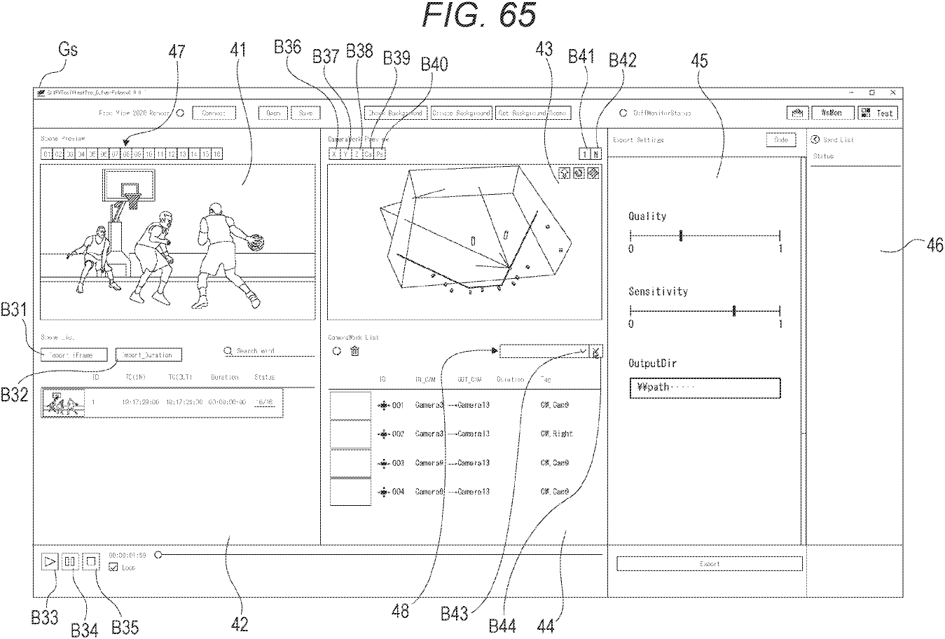

In the filtering operation unit 48, the reset button B44 is a button for instructing resetting of filtering. In a case where the reset button B44 is operated, as illustrated as the screen transition from FIG. 64 to FIG. 65, the filtering and displaying state of the camerawork in the camerawork list display unit 44 is released, and the camerawork as the candidates to be used for generation of the free viewpoint image is displayed in a list.

Here, although the filtering based on the tag information I1 has been illustrated above with respect to the filtering of the camerawork, the filtering of the camerawork can be performed on the basis of the information of the In-camera or the Out-camera included in the information of the camerawork.

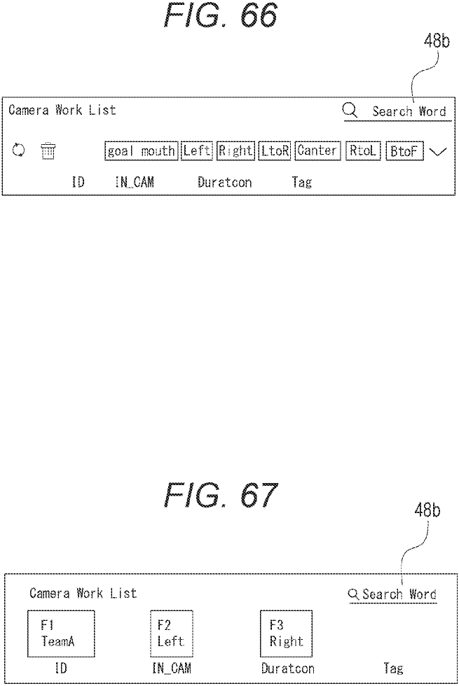

Although the example in which the information indicating the filtering condition such as the tag information I1 is displayed in the pull-down list 48a has been described above, the information indicating the filtering condition (filtering condition information) can also be displayed as a button as illustrated in FIG. 66.

At this time, the information displayed as the button can be determined on the basis of history information of the camerawork used for generation of the free viewpoint image in the past. For example, the tag information I1 of predetermined high-rank cameraworks that have been used frequently in the past can be displayed as a button.

In FIG. 66, the button arrangement corresponding to a case where predetermined high-rank cameraworks that have been used frequently are the cameraworks to which the tag information I1 such as “goal mouth”, “Left”, “Right”, or the like is attached is illustrated.

The button displaying the filtering condition information may be customized by the user.

FIG. 67 illustrates a button display example in that case. In this case, the user can set arbitrary information for the display information of each button. In a case where the display information of the button is set by the user, the image generation processing unit 32 manages the set information as information indicating the filtering condition of the camerawork. For example, information of “TeamA”, “Left”, and “Right” illustrated in the drawing is managed as information indicating a filtering condition of the camerawork. In a case where the button is operated, the image generation processing unit 32 (specifically, the display processing unit 32a) performs processing of displaying, on the camerawork list display unit 44, the camerawork in which the tag information I1 that matches the information managed corresponding to the button is set.

Furthermore, the information indicating the filtering condition can be received as input keyword information by the user.

In this case, for example, the keyword input unit 48b illustrated in FIGS. 66 and 67 is provided in the filtering operation unit 48. In this case, the display processing unit 32a performs processing of displaying the camerawork in which the tag information I1 matching the input keyword information is set on the camerawork list display unit 44 in response to the keyword input to the keyword input unit 48b.

Note that, in the above description, the designation of the camerawork used for generating the free viewpoint image is performed as the designation of the camerawork displayed on the camerawork list display unit 44. However, the designation of the camerawork may be performed as the designation of the camerawork displayed on the camerawork window 43.

Here, in the present embodiment, information obtained by visualizing the moving speed of the viewpoint is displayed for the camerawork information displayed in the camerawork window 43.

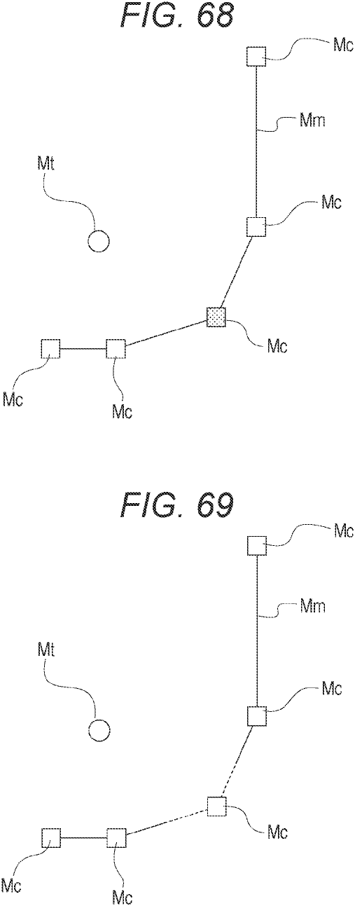

FIGS. 68 and 69 illustrate display examples of visualization information of the moving speed of the viewpoint. Note that FIGS. 68 and 69 illustrate an example in which the observation image of the camerawork information at the viewpoint on the Y axis described above is displayed in the camerawork window 43.

In this example, information indicating a period during which the moving speed of the viewpoint decreases is displayed as the information visualizing the moving speed of the viewpoint. FIG. 68 illustrates an example in which the camera position mark Mc indicating the camera positioned in the section in which the moving speed of the viewpoint decreases is displayed in a display mode different from the other camera position marks Mc. For example, it is conceivable to display the corresponding camera position mark Mc in a color or size different from those of the other camera position marks Mc.

FIG. 69 illustrates an example in which the display mode of the corresponding section in the movement trajectory information Mm is different from that of the other sections for the period in which the moving speed of the viewpoint decreases. For example, as illustrated in the drawing, it is conceivable to display the movement trajectory in the corresponding section as a dotted line and the movement trajectory in the other section as a solid line. Alternatively, the color, thickness, linear shape (for example, straight line and wavy line), and the like of the movement trajectory may be displayed differently between the corresponding section and the other section.

Although not illustrated, the moving speed of the viewpoint can also be expressed by the density of points in a case where the moving trajectory is indicated by a dotted line. For example, it is conceivable to perform display in which the density of points increases as the moving speed increases.

Note that, although the observation image from the viewpoint on the Y-axis is illustrated in FIGS. 68 and 69, similar display is performed in the case of the viewpoint on the X-axis, the viewpoint on the Z-axis, and the viewpoint Pe (arbitrary viewpoint).

Furthermore, in the present embodiment, with respect to the information of the camerawork displayed in the camerawork window 43, processing of updating the information of the position of the target Tg in the camerawork information according to the operation of changing the position of the target mark Mt is performed.

This processing is processing of the camerawork editing processing unit 32b illustrated in FIG. 5.

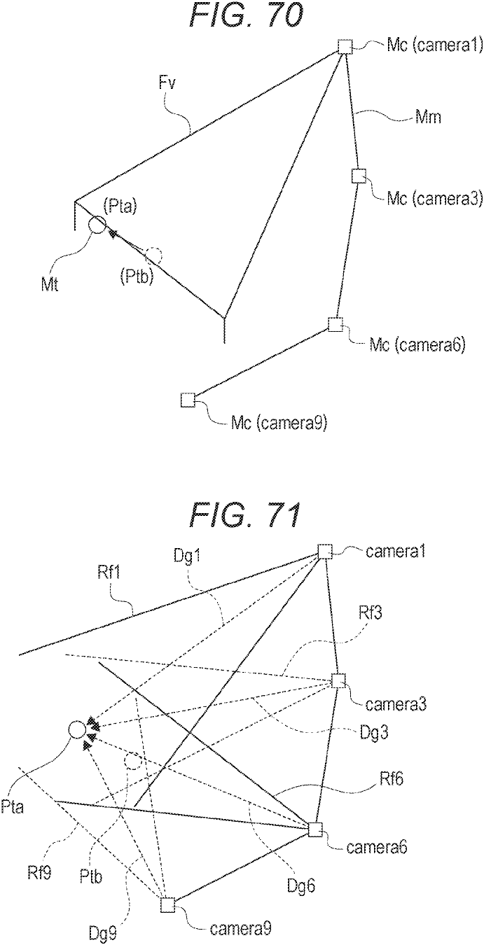

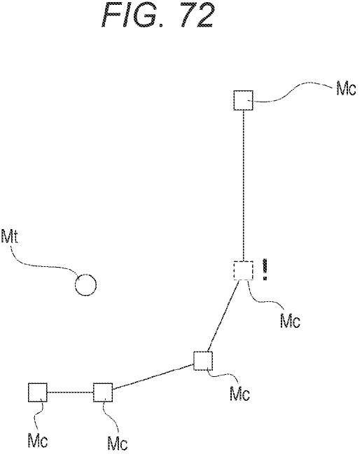

With reference to FIGS. 70 and 71, the target position editing processing by such a camerawork editing processing unit 32b will be described.

FIG. 70 illustrates camerawork information displayed in the camerawork window 43.

It is assumed that an operation of changing the position of the target mark Mt is performed in the camerawork window 43 as illustrated in the drawing. The operation of changing the position of the target mark Mt may be, for example, a drag & drop operation of the target mark Mt.

Here, the position of the target Tg after the change by such a change operation is referred to as “position Pta”, and the position of the target Tg before the change is referred to as “Ptb”.

In response to the operation of changing the position of the target mark Mt as described above, the camerawork editing processing unit 32b performs processing of updating the information on the position of the target Tg from the position Ptb to the position Pta with respect to the camerawork information displayed in the camerawork window 43.

By updating the position information of the target Tg in the camerawork information in this manner, in the free viewpoint image generation processing using the camerawork information, the free viewpoint image is generated such that the line-of-sight direction Dg from each position on the viewpoint movement trajectory faces the position of the updated target Tg. FIG. 71 illustrates an image of a change in the field of view Rf in a case where the line-of-sight direction Dg from each position on the viewpoint movement trajectory faces the position Pta, which is the position after the update.

Since the camerawork information can be edited according to the operation on the camerawork designation screen Gs as described above, it is not necessary to start software for generating the camerawork information when it is desired to edit the camerawork information at the stage of designating the camerawork to be used for generating the free viewpoint image.

Therefore, even when it is necessary to edit the camerawork information, it is possible to quickly execute the work of creating the free viewpoint image.

In addition, in the present embodiment, on the camerawork designation screen Gs, the above-described processing of displaying information notifying the camera that requires calibration is performed.

Specifically, the display processing unit 32a determines whether there is a camera whose variation has been detected among the cameras whose camera position marks Mc are displayed in the camerawork window 43, on the basis of the result of the variation detection (for example, the automatic variation detection in step S33) of each camera by the utility server 8 described above with reference to FIG. 14. In a case where there is a camera whose variation has been detected, the display processing unit 32a performs processing of displaying information notifying the corresponding camera (that is, the camera whose variation has been detected) in the camerawork window 43.

Note that the camera in which the variation is detected can be rephrased as a camera in which the change in the field of view is detected.

FIG. 72 illustrates a display example of the notification information of the camera in which the variation is detected.

As for the display of the notification information, as illustrated in the drawing, the camera position mark Mc of the corresponding camera is displayed in a display mode different from that of the other camera position marks Mc (even in this case, it is conceivable to vary the color, size, shape, and the like). Furthermore, it is also conceivable to display information for calling attention in the vicinity of the corresponding camera position mark Mc, like the exclamation mark illustrated in the figure.

In generating a free viewpoint image, in order to accurately generate three-dimensional information from images captured by a plurality of cameras, it is necessary for each camera to maintain an assumed position and orientation in advance, and in a case where a change in position and orientation occurs in any camera, it is necessary to calibrate parameters used for generating three-dimensional information. By notifying the camera in which the change in the field of view is detected as described above, it is possible to notify the user of the camera that requires calibration.

Therefore, it is possible to generate a free viewpoint image based on accurate three-dimensional information, and to improve the image quality of the free viewpoint image.

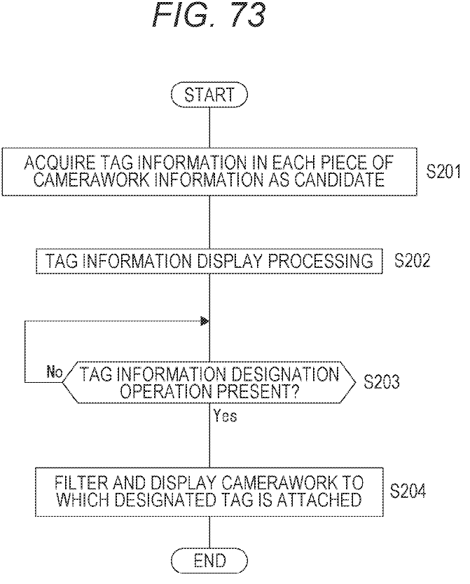

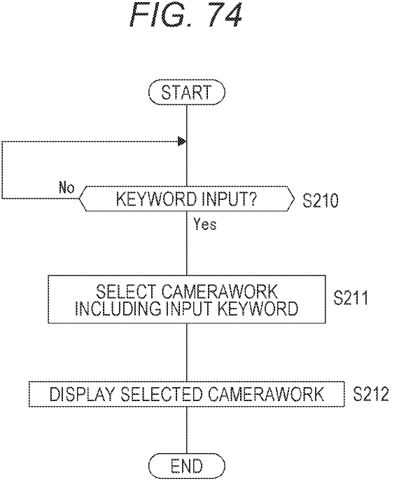

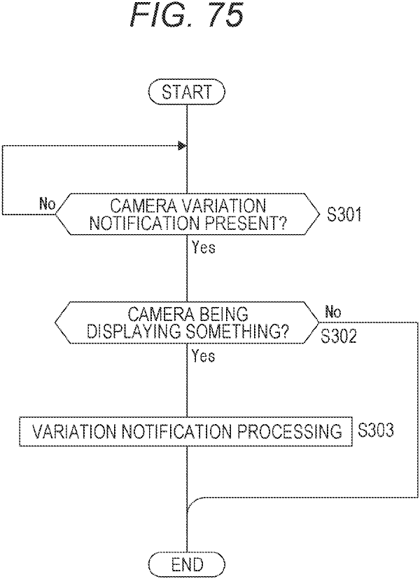

Processing related to the filtering of the camerawork described above will be described with reference to flowcharts of FIGS. 73 and 74. Note that the processing illustrated in FIGS. 73 and 74 is executed by the CPU 71 of the free viewpoint image server 2 as processing of the display processing unit 32a.

FIG. 73 illustrates processing corresponding to a case where the camerawork is filtered on the basis of the tag information I1 displayed on the camerawork designation screen Gs as illustrated in FIG. 63.

First, in step S201, the CPU 71 performs processing of acquiring tag information I1 in each piece of camerawork information as a candidate. That is, each piece of camerawork information as a candidate that can be used for generation of the free viewpoint image is acquired. Here, the camerawork information as a candidate is stored in a readable storage device inside or outside the free viewpoint image server 2. In the processing of step S201, the camerawork information as the candidate stored in this manner is acquired.

In step S202 subsequent to step S201, the CPU 71 performs a process of displaying the tag information I1. That is, in the case of displaying in the pull-down list 48a as illustrated in FIG. 63, the tag information I1 included in the camerawork information acquired in step S201 is displayed in response to the operation of the pull-down button B43.

In step S203 subsequent to step S202, the CPU 71 waits for the designation operation of the tag information I1,and in a case where the designation operation of the tag information I1 has been performed, proceeds to step S204 and performs processing of filtering and displaying the camerawork to which the designated tag information I1 is attached. That is, processing of displaying the camerawork information including the designated tag information I1 (in which the designated tag information I1 is set) among the camerawork information as candidates on the camerawork list display unit 44 is performed. As illustrated in FIG. 64, in this example, the camerawork information to be displayed is, for example, identification information of the camerawork, information of the In-camera and the Out-camera, tag information I1, and the like.

The CPU 71 ends the series of processes illustrated in FIG. 73 in response to the execution of the process of step S204.

FIG. 74 illustrates processing related to the filtering of the camerawork according to the input keyword.

In FIG. 74, the CPU 71 waits for the keyword input from the user in step S210, and selects the camerawork including the input keyword in step S211 when there is the keyword input. That is, among the pieces of camerawork information as candidates, the camerawork information including the input keyword in the tag information I1 is selected.

Then, in subsequent step S212, the CPU 71 executes processing of displaying the selected camerawork. That is, processing of displaying the selected camerawork information on the camerawork list display unit 44 is performed.

In response to the execution of the process of step S212, the CPU 71 ends the series of processes illustrated in FIG. 74.

FIG. 75 is a flowchart of processing related to notification of a camera that requires calibration illustrated in FIG. 72. Note that the processing illustrated in FIG. 75 is also executed as processing of the display processing unit 32a by the CPU 71 of the free viewpoint image server 2, similarly to the processing in FIGS. 73 and 74.

In step S301, the CPU 71 waits for the camera variation notification. That is, the CPU 71 waits for the variation notification transmitted when the utility server 8 detects variation of the camera by the automatic variation detection (step S33 in FIG. 14) described above. The variation notification includes information for specifying the camera in which the variation is detected.

When there is the camera variation notification, the CPU 71 determines in step S302 whether or not the camera is a camera being displayed. That is, it is determined whether or not the camera notified by the variation notification is the camera displaying the camera position mark Mc in the camerawork window 43. When the camera is not the camera being displayed, the CPU 71 terminates the series of processing illustrated in FIG. 75.

On the other hand, if the camera is currently displayed, the CPU 71 proceeds to step S303 and executes the variation notification process. That is, for the corresponding camera position mark Mc being displayed in the camerawork window 43, for example, processing of displaying information notifying the variation in the display mode as illustrated in FIG. 72 is performed.

In response to the execution of the process of step S303, the CPU 71 ends the series of processes illustrated in FIG. 75.

### 9. Modification

Note that the embodiment is not limited to the specific example described above, and configurations as various modifications can be adopted.

For example, in the above description, an example has been described in which a device that performs the processing of displaying the creation operation screen Gg and the acceptance of the operation input for generating the camerawork and a device that performs the processing of displaying the camerawork designation screen Gs and the acceptance of the operation input for generating the free viewpoint image are common devices as the free viewpoint image server 2. However, it is also possible to adopt a mode in which these devices are separate devices.

Furthermore, in the above description, with respect to the filtering and displaying of the camerawork on the camerawork designation screen Gs, an example has been described in which the filtering is performed according to the operated portion such as the button indicating the filtering condition. However, for example, the filtering and displaying of the camerawork can also be performed according to the designation of the target Tg, such as designation of the target mark Mt displayed in the camerawork window 43. Specifically, only the camerawork in which the designated target Tg is set among the cameraworks as the candidates is filtered and displayed.

In addition, on the creation operation screen Gg and the camerawork designation screen Gs, in a case where there is a range (for example, a range in which the resolution is equal to or less than a predetermined value) in which image quality cannot be secured due to, for example, the real camera being too far from the subject on the movement trajectory of the viewpoint, information for notifying the range can also be displayed.

### 10. Summary of Embodiments

As described above, a first information processing device according to the embodiment includes the display processing unit (34a) that performs processing of displaying a screen, as the camerawork information creation operation screen (Gg) that is information indicating at least the movement trajectory of the viewpoint in a free viewpoint image, including a designation operation reception region (camerawork list display unit 44, operation panel unit 54, and the like) that receives operation input for designating at least partial information of the camerawork information and a camerawork display region (camerawork window 53) that visualizes and displays the movement trajectory of the viewpoint based on the camerawork information reflecting the designation content by the operation input.

As a result, the user can perform the creation operation of the camerawork while visually recognizing the visualized movement trajectory of the viewpoint on the camerawork creation operation screen.

Therefore, the efficiency of the camerawork creation work can be improved.

Furthermore, in the first information processing device according to the embodiment, the designation operation reception region can receive designation operations of the start point and the end point of the movement trajectory (see FIGS. 22 to 25 and 52) .

As a result, it is possible to set an arbitrary start point and an arbitrary end point of the movement trajectory of the viewpoint rather than a fixed point.

Therefore, the degree of freedom in creating a free viewpoint image can be improved.

Furthermore, in the first information processing device according to the embodiment, the designation operation reception region can receive designation operation of a via-point of a viewpoint (see FIGS. 27 to 30 and 53).

Thus, it is possible to set, as the movement trajectory of the viewpoint, a trajectory passing through the designated point, instead of a linear trajectory connecting two points of the start point and the end point.

Therefore, the degree of freedom in creating a free viewpoint image can be improved.

Furthermore, in the first information processing device according to the embodiment, the designation operation reception region can receive designation operation of the timing at which the viewpoint passes through the via-point (see FIGS. 27 to 30).

Thus, it is possible to set not only the via-point of the viewpoint but also the timing at which the viewpoint passes through the via-point.

Therefore, it is possible to improve the degree of freedom in setting the position through which the viewpoint passes and the degree of freedom in setting the timing at which the viewpoint passes through the via-point, and improve the degree of freedom in creating the free viewpoint image.

Furthermore, in the first information processing device according to the embodiment, the designation operation reception region can receive designation operation of the type of the shape of the movement trajectory (see FIGS. 32 and 33).

As a result, the shape type of the movement trajectory of the viewpoint can be made variable instead of fixed.

Therefore, the degree of freedom in creating a free viewpoint image can be improved.

For example, if the shape type of the movement trajectory is a curved shape, it is possible to prevent the distance from the target subject to the viewpoint from greatly changing even if the viewpoint moves. In other words, the size of the target subject in the free viewpoint image can be prevented from greatly changing.

Furthermore, in the first information processing device according to the embodiment, the designation operation reception region can receive designation operation of the moving speed of the viewpoint (see FIGS. 34 and 35).

As a result, the moving speed of the viewpoint can be made variable instead of fixed.

Therefore, the degree of freedom in creating a free viewpoint image can be improved.

Furthermore, in the first information processing device according to the embodiment, the designation operation reception region can receive designation operation of a section for changing the moving speed in the movement trajectory (see FIGS. 34 and 35).

Thus, it is possible to dynamically change the moving speed of the viewpoint in the movement trajectory.

Therefore, the degree of freedom in creating a free viewpoint image can be improved.

Furthermore, in the first information processing device according to the embodiment, the designated operation-reception region can receive an operation input for a timeline indicating a period from the movement start time point to the movement end time point of the viewpoint (see the timeline operation unit 54a) .

By accepting the input operation on the timeline, for example, designation of a via-point and designation of a via-point timing thereof can be performed at the same time by dragging and dropping an icon of the camera on the timeline, or designation of a section in which a predetermined effect such as a section in which curve interpolation of a movement trajectory is to be performed by designation of a range by drag operation on the timeline can be performed. Thus, it is possible to facilitate designation operation of various types of information related to the camerawork.

Therefore, the efficiency of the camerawork creation work can be improved.

Furthermore, in the first information processing device according to the embodiment, the display processing unit performs processing of displaying information (field-of-view information Fv) obtained by visualizing the field of view from the viewpoint in the camerawork display region (see FIG. 20 and the like).

Since the field of view is visually indicated, it is possible to facilitate grasping of the camerawork by the user.

Therefore, it is possible to allow the user to easily grasp how the camerawork changes by the operation input, and improve the efficiency of the camerawork creation work.

Furthermore, in the first information processing device according to the embodiment, the display processing unit performs processing of displaying information in which the field of view from the viewpoint is represented by a figure in the camerawork display region.

Since the field of view is graphically illustrated, the user can easily grasp the camerawork.

Therefore, it is possible to allow the user to easily grasp how the camerawork changes by the operation input, and improve the efficiency of the camerawork creation work.

Furthermore, in the first information processing device according to the embodiment, the display processing unit performs processing of displaying an image obtained by observing a three-dimensional space from a viewpoint on the creation operation screen (see the preview window 55).

As a result, an image similar to the free viewpoint image generated on the basis of the camerawork information can be displayed as a preview to the user, and grasping of the camerawork can be facilitated.

Therefore, the efficiency of the camerawork creation work can be improved.

Furthermore, in the first information processing device according to the embodiment, the designation operation reception region can receive designation operation of a position of a target that defines a line-of-sight direction from a viewpoint (see FIGS. 38, 39, and the like).

As a result, an image following the target can be generated as the free viewpoint image. The image following the target means an image in which the target continues to be positioned at a predetermined position (for example, a center position) in the image frame.

Therefore, the degree of freedom in creating a free viewpoint image can be improved.

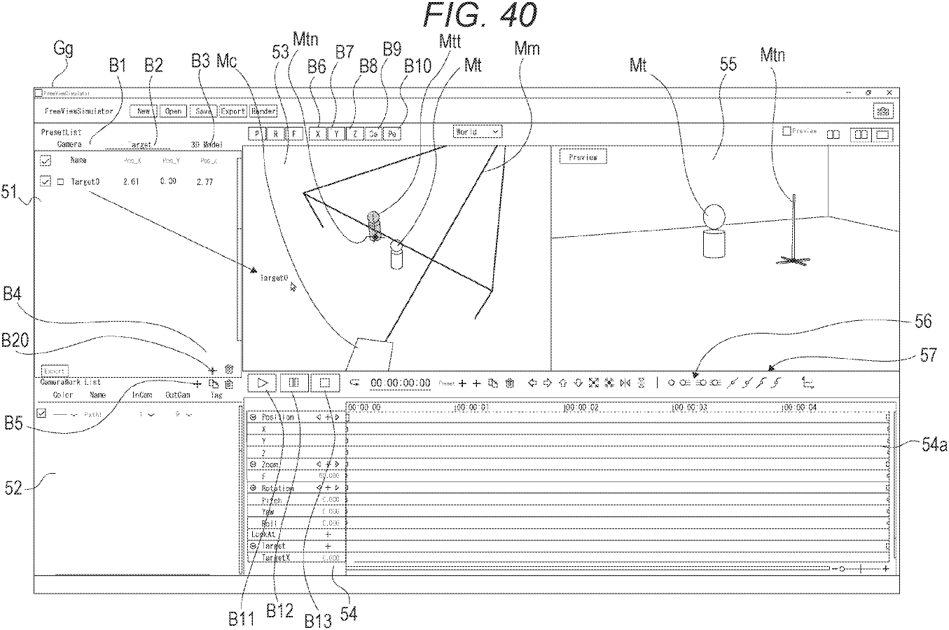

Furthermore, in the first information processing device according to the embodiment, the designation operation reception region can receive designation operation of a period of facing the target (see FIGS. 41 to 52).

The period of facing the target means a period in which the target is continuously positioned at a predetermined position in the image frame of the free viewpoint image. Since the designation operation of the period of facing the target is enabled as described above, it is possible to generate, as the free viewpoint image, an image that follows the target position in a certain period and does not follow the target position in other periods in the viewpoint movement period, and the like, and freely improve the setting for the period of following the target position.

Therefore, the degree of freedom in creating a free viewpoint image can be improved.

Furthermore, in the first information processing device according to the embodiment, the designation operation reception region can receive a designation operation of a plurality of target positions as a designation operation of target positions (see FIG. 51).

As a result, it is possible to generate a free viewpoint image that follows the target A in a certain period and follows the target B in another period in the viewpoint movement period, and freely improve the setting of the target to be followed.

Therefore, the degree of freedom in creating a free viewpoint image can be improved.

Furthermore, a first information processing method according to an embodiment is an information processing method in which an information processing device performs processing of displaying a screen, as the camerawork information creation operation screen that is information indicating at least the movement trajectory of the viewpoint in a free viewpoint image, including a designation operation reception region that receives operation input for designating at least partial information of the camerawork information and a camerawork display region that visualizes and displays the movement trajectory of the viewpoint based on the camerawork information reflecting the designation content by the operation input.

According to such a first information processing method, it is possible to obtain the same operations and effects as those of the first information processing device described above.

In addition, a second information processing device according to the embodiment includes a display processing unit (32a) that performs processing of displaying a screen indicating, by filtering, camerawork information according to user input information among a plurality of pieces of camerawork information as a camerawork designation screen (Gs) that receives designation operation of camerawork information that is information indicating at least a movement trajectory of a viewpoint in a free viewpoint image.

By filtering and displaying the camerawork information according to the input information of the user, it is possible to easily find the camerawork information desired by the user, and shorten the time required for designating the camerawork information.

Therefore, the work of creating the free viewpoint image can be executed quickly.

Furthermore, in the second information processing device according to the embodiment, the display processing unit performs processing of filtering and displaying camerawork information according to a keyword as the input information on the camerawork designation screen (see FIGS. 66, 67, 74, and the like) .

Thus, it is possible to perform appropriate filtering of the camerawork information reflecting the intention of the user.

Therefore, it is possible to make it easier for the user to find desired camerawork information, and further shorten the time required for designating the camerawork information.

Furthermore, in the second information processing device according to the embodiment, the operated portion indicating the filtering condition of the camerawork information is arranged on the camerawork designation screen, and the display processing unit performs processing of filtering and displaying the camerawork information according to the filtering condition indicated by the operated portion according to the operation of the operated portion (see FIGS. 63, 64, 66, 67, and 73).

As a result, the operation required for the filtering and displaying of the camerawork information can be reduced to only the operation of selecting the filtering condition information.

Therefore, it is possible to reduce the user’s operation burden required for filtering and displaying the camerawork information.

Furthermore, in the second information processing device according to the embodiment, the display processing unit performs processing of displaying information obtained by visualizing the movement trajectory of the viewpoint on the camerawork designation screen (see FIG. 61 and the like).

By displaying the information visualizing the movement trajectory of the viewpoint, it is easy for the user to image the camerawork.

Therefore, in designating the camerawork information to be used for creating the free viewpoint image, it is possible to make it easier for the user to find desired camerawork information, and shorten the time required for designating the camerawork information.

Furthermore, in the second information processing device according to the embodiment, the display processing unit performs processing of displaying camera arrangement position information indicating arrangement positions of a plurality of cameras that performs imaging for generating a free viewpoint image on the camerawork designation screen (see FIG. 61 and the like) .

By displaying the information indicating the arrangement position of each camera, the user can easily image what kind of image should be generated as a free viewpoint image.

Therefore, the work of creating the free viewpoint image can be executed quickly.

Furthermore, in the second information processing device according to the embodiment, the display processing unit performs processing of displaying, on the camerawork designation screen, start point arrangement position information and end point arrangement position information indicating the respective positions of the camera serving as the movement start point and the camera serving as the movement end point of the viewpoint among the plurality of cameras (see FIG. 61 and the like).

As a result, it is possible to allow the user to grasp from which camera position the movement of the viewpoint starts and ends at which camera position in the camerawork.

Therefore, when designating the camerawork information used for creating the free viewpoint image, it is possible to more easily find the camerawork information desired by the user. In particular, in the case of generating the image in which the front clip and the rear clip are connected to the free visual point image as described above, it is desirable that the camera as the movement start point of the viewpoint is matched with the imaging camera of the front clip and the camera as the movement end point of the viewpoint is matched with the imaging camera of the rear clip so that the connection between the clips becomes natural. However, by displaying the respective positions of the camera as the movement start point and the camera as the movement end point as described above, it is possible to easily designate appropriate camerawork corresponding to the imaging camera of the front clip and the imaging camera of the rear clip.

Furthermore, in the second information processing device according to the embodiment, the display processing unit performs processing of displaying the start point arrangement position information and the end point arrangement position information, and arrangement position information of a camera serving as the movement start point and a camera other than the camera serving as the movement end point among the plurality of cameras in different modes.

As a result, it is possible to allow the user to intuitively grasp from which camera position the movement of the viewpoint starts and ends at which camera position in the camerawork.

Therefore, when designating the camerawork information used for creating the free viewpoint image, it is possible to more easily find the camerawork information desired by the user.

Furthermore, in the second information processing device according to the embodiment, the display processing unit performs processing of displaying information obtained by visualizing the moving speed of the viewpoint on the camerawork designation screen (see FIGS. 68 and 69).

The period in which the moving speed of the viewpoint is changed in the period in which the viewpoint is moved is an important factor in the drawing of the free viewpoint image.

Therefore, by displaying the visualization information of the moving speed of the viewpoint as described above, the camerawork information desired by the user can be more easily found, and the time required for designating the camerawork information can be shortened.

Furthermore, in the second information processing device according to the embodiment, the display processing unit performs processing of displaying information indicating a period during which the moving speed decreases as information obtained by visualizing the moving speed of the viewpoint.

The period in which the moving speed of the viewpoint is decreased in the period in which the viewpoint is moved is an important factor in the drawing of the free viewpoint image.

Therefore, by displaying the information indicating the period in which the moving speed of the viewpoint decreases as described above, it is possible to more easily find the camerawork information desired by the user, and to shorten the time required for designating the camerawork information.

Furthermore, in the second information processing device according to the embodiment, the display processing unit performs processing of displaying information obtained by visualizing the field of view from the viewpoint on the camerawork designation screen (see FIG. 61 and the like).

Since the field of view is visually indicated, it is possible to facilitate grasping of the camerawork by the user.

Therefore, it is possible to make it easier for the user to find desired camerawork information, and shorten the time required for designating the camerawork information.

Furthermore, in the second information processing device according to the embodiment, the display processing unit performs processing of displaying a target that defines a line-of-sight direction from a viewpoint on the camerawork designation screen (see FIG. 61 and the like).

As a result, it is possible to allow the user to easily grasp which position of the subject in the three-dimensional space the camerawork is targeted for.

Therefore, it is possible to make it easier for the user to find desired camerawork information, and shorten the time required for designating the camerawork information.

Furthermore, the second information processing device according to the embodiment includes a camerawork editing processing unit (32b) that updates information on the position of the target in the camerawork information according to a change in the position of the target on the camerawork designation screen (see FIGS. 70 and 71).

As a result, when it is desired to edit the camerawork information at the stage of designating the camerawork information to be used for generation of the free viewpoint image, it is not necessary to start software for generating the camerawork information.

Therefore, even when it is necessary to edit the camerawork information, it is possible to quickly execute the work of creating the free viewpoint image.

Furthermore, in the second information processing device according to the embodiment, the display processing unit performs processing of displaying an image obtained by observing a three-dimensional space from a viewpoint on the camerawork designation screen (see FIG. 62).

As a result, an image similar to the free viewpoint image generated on the basis of the camerawork information can be displayed as a preview to the user, and grasping of the camerawork can be facilitated.

Therefore, it is possible to make it easier for the user to find desired camerawork information, and shorten the time required for designating the camerawork information.

Furthermore, in the second information processing device according to the embodiment, the display processing unit performs processing of displaying an image obtained by rendering a virtual three-dimensional model of a real space as an image obtained by observing a three-dimensional space from a viewpoint (see FIG. 62).

As a result, when the preview display of the observation image from the viewpoint is realized, it is not necessary to perform the rendering processing using the three-dimensional model generated from the captured image of the target real space.

Therefore, the processing time required to display the preview of the observation image from the viewpoint can be shortened, and the work of creating the free viewpoint image can be quickly executed.

Furthermore, in the second information processing device according to the embodiment, the display processing unit performs processing of displaying information notifying a camera in which a change in the field of view is detected among the plurality of cameras (see FIG. 72).

In generating a free viewpoint image, in order to accurately generate three-dimensional information from images captured by a plurality of cameras, it is necessary for each camera to maintain an assumed position and orientation in advance, and in a case where a change in position and orientation occurs in any camera, it is necessary to calibrate parameters used for generating three-dimensional information. By notifying the camera in which the change in the field of view is detected as described above, it is possible to notify the user of the camera that requires calibration.

Therefore, it is possible to generate a free viewpoint image based on accurate three-dimensional information, and to improve the image quality of the free viewpoint image.

Furthermore, a second information processing method according to the embodiment is an information processing method in which an information processing device performs processing of displaying a screen indicating, by filtering, camerawork information according to user input information among a plurality of pieces of camerawork information as a camerawork designation screen that receives designation operation of camerawork information that is information indicating at least a movement trajectory of a viewpoint in a free viewpoint image.

According to such a second information processing method, it is possible to obtain the same operations and effects as those of the second information processing device described above.

Here, as an embodiment, it is possible to consider a program for causing a CPU, a digital signal processor (DSP), or the like, or a device including the CPU, the DSP, or the like, to execute the processing by the display processing unit 34a described in FIG. 52, FIG. 53, or the like.

That is, a first program of the embodiment is a program that can be read by a computer device, and is a program that causes the computer device to realize a function of performing processing of displaying a screen, as the camerawork information creation operation screen that is information indicating at least the movement trajectory of the viewpoint in a free viewpoint image, including a designation operation reception region that receives operation input for designating at least partial information of the camerawork information and a camerawork display region that visualizes and displays the movement trajectory of the viewpoint based on the camerawork information reflecting the designation content by the operation input.

With such a program, the above-described display processing unit 34a can be realized in a device as the information processing device 70.

Furthermore, as an embodiment, a program for causing a CPU, a DSP, or a device including the CPU, the DSP, or the like to execute the processing by the display processing unit 32a described in FIG. 73, FIG. 74, or the like can be considered.

That is, a second program of the embodiment is a program that can be read by a computer device, and is a program that causes the computer device to execute a function of performing processing of displaying a screen indicating, by filtering, camerawork information according to user input information among a plurality of pieces of camerawork information as a camerawork designation screen that receives designation operation of camerawork information that is information indicating at least a movement trajectory of a viewpoint in a free viewpoint image.

With such a program, the above-described display processing unit 32a can be realized in a device as the information processing device 70.

These programs can be recorded in advance in an HDD as a recording medium built in a device such as a computer device, a ROM in a microcomputer having a CPU, or the like.

Alternatively, the program can be temporarily or permanently stored (recorded) in a removable recording medium such as a flexible disk, a compact disc read only memory (CD-ROM), a magneto optical (MO) disk, a digital versatile disc (DVD), a Blu-ray disc (registered trademark), a magnetic disk, a semiconductor memory, or a memory card. Such a removable recording medium can be provided as so-called packaged software.

Furthermore, such a program can be installed from a removable recording medium to a personal computer or the like, or can be downloaded from a download site via a network such as a local area network (LAN) or the Internet.

In addition, such a program is suitable for providing the display processing unit 34a and the display processing unit 32a of the embodiment in a wide range. For example, by downloading the program to a personal computer, a portable information processing device, a mobile phone, a game device, a video device, a personal digital assistant (PDA), or the like, the personal computer or the like can be caused to function as a device that realizes processing as the display processing unit 34a or the display processing unit 32a of the present disclosure.

Note that the effects described in the present specification are merely examples and are not limited, and other effects may be provided.

### 11. Present Technology

Note that the present technology can also have the following configurations.
(1) An information processing device comprising:
   a display processing unit that performs processing of displaying a screen indicating, by filtering, camerawork information corresponding to input information of a user among a plurality of pieces of camerawork information, as a camerawork designation screen that receives designation operation of camerawork information that is information indicating at least a movement trajectory of a viewpoint in a free viewpoint image.
(2) The information processing device according to (1), in which
   the display processing unit
   performs processing of filtering and displaying camerawork information according to a keyword as the input information on the camerawork designation screen.
(3) The information processing device according to (1) or (2), in which
   filtering condition information indicating a filtering condition of camerawork information is displayed on the camerawork designation screen, and
   the display processing unit
   performs processing of filtering and displaying the camerawork information according to the filtering condition indicated by the selected filtering condition information as the input information.
(4) The information processing device according to any one of (1) to (3), in which
   the display processing unit
   performs processing of displaying information obtained by visualizing a movement trajectory of the viewpoint on the camerawork designation screen.
(5) The information processing device according to any one of (1) to (4), in which
   the display processing unit
   performs processing of displaying, on the camerawork designation screen, camera arrangement position information indicating arrangement positions of a plurality of cameras that performs imaging for generating a free viewpoint image.
(6) The information processing device according to (5), in which
   the display processing unit
   performs processing of displaying, on the camerawork designation screen, start point arrangement position information and end point arrangement position information indicating respective positions of a camera serving as a movement start point and a camera serving as a movement end point of the viewpoint among the plurality of cameras.
(7) The information processing device according to (6), in which
   the display processing unit
   performs processing of displaying the start point arrangement position information and the end point arrangement position information, and arrangement position information of cameras other than the camera serving as the movement start point and the camera serving as the movement end point among the plurality of cameras in different modes.
(8) The information processing device according to any one of (4) to (7), in which
   the display processing unit
   performs processing of displaying information obtained by visualizing the moving speed of the viewpoint on the camerawork designation screen.
(9) The information processing device according to (8), in which
   the display processing unit
   performs processing of displaying information indicating a period in which the moving speed decreases as information obtained by visualizing the moving speed of the viewpoint.
(10) The information processing device according to any one of (4) to (9), in which
   the display processing unit
   performs processing of displaying information obtained by visualizing a field of view from the viewpoint on the camerawork designation screen.
(11) The information processing device according to any one of (4) to (10), in which
   the display processing unit
   performs processing of displaying a target that defines a line-of-sight direction from the viewpoint on the camerawork designation screen.
(12) The information processing device according to (11), further including
   a camerawork editing processing unit that updates information on the position of the target in camerawork information according to a change in the position of the target on the camerawork designation screen.
(13) The information processing device according to any one of (1) to (12), in which
   the display processing unit
   performs processing of displaying an image obtained by observing a three-dimensional space from the viewpoint on the camerawork designation screen.
(14) The information processing device according to (13), in which
   the display processing unit
   performs processing of displaying not a three-dimensional model generated from a captured image of a real space, but an image obtained by rendering a virtual three-dimensional model of a real space as an image obtained by observing a three-dimensional space from the viewpoint.
(15) The information processing device according to (5), in which
   the display processing unit
   performs processing of displaying information notifying a camera in which a change in the field of view has been detected among the plurality of cameras.
(16) An information processing method in which
   an information processing device
   performs processing of displaying a screen indicating, by filtering, camerawork information corresponding to input information of a user among a plurality of pieces of camerawork information specifiable, as a camerawork designation screen that receives designation operation of camerawork information that is information indicating at least a movement trajectory of a viewpoint in a free viewpoint image.
(17) A program readable by a computer device, the program causing the computer device to implement a function of performing processing of displaying a screen indicating, by filtering, camerawork information corresponding to input information of a user among a plurality of pieces of camerawork information specifiable, as a camerawork designation screen that receives designation operation of camerawork information that is information indicating at least a movement trajectory of a viewpoint in a free viewpoint image.

### REFERENCE SIGNS LIST

| | |
|---|---|
| 2 | Free viewpoint image server |
| 8 | Utility server |
| 10 | Imaging device |
| 21 | Section identification processing unit |
| 22 | Target image transmission control unit |
| 23 | Output image generating unit |
| 31 | Target image acquisition unit |
| 32 | Image generation processing unit |
| 32 a | Display processing unit |
| 32 b | Camerawork editing processing unit |
| 33 | Transmission control unit |
| Gs | Camerawork designation screen |
| 41 | Scene window |
| 42 | Scene list display unit |
| 43 | Camerawork window |
| 44 | Camerawork list display unit |
| 70 | Information processing device |
| 71 | CPU |
| 72 | ROM |
| 73 | RAM |
| 74 | Bus |
| 75 | Input/output interface |
| 76 | Input unit |
| 77 | Display unit |
| 78 | Sound output unit |
| 79 | Storage unit |
| 80 | Communication unit |
| 81 | Removable recording medium |
| 82 | Drive |
| Tg | Target |
| Mc | Camera position mark |
| Fv | Field of view information |
| Mt | Target mark |
| Mm | Movement trajectory information |
| Mv | Via-point mark |
| Mtn | Target position designation mark |
| Mtt | Additional target mark |
| Mem | Arrival target timing mark |
| Mst | Target initial position mark |
| Rf | Field of view |
| Dg | Line-of-sight direction |
| 48 | Filtering operation unit |
| 48 a | Pull-down list |
| 48 b | keyword input unit |
| B33 | Reproduction button |
| B34 | Pause button |
| B35 | Stop button |
| B36 | X-axis viewpoint button |
| B37 | Y-axis viewpoint button |
| B38 | Z-axis viewpoint button |
| B39 | Ca viewpoint button |
| B40 | Pe viewpoint button |
| B43 | Pull-down button |
| B44 | Reset button |

1. An information processing device comprising:
a display processing unit that performs processing of displaying a screen indicating, by filtering, camerawork information corresponding to input information of a user among a plurality of pieces of camerawork information, as a camerawork designation screen that receives designation operation of camerawork information that is information indicating at least a movement trajectory of a viewpoint in a free viewpoint image.

2. The information processing device according to claim 1, wherein
the display processing unit
performs processing of filtering and displaying camerawork information according to a keyword as the input information on the camerawork designation screen.

3. The information processing device according to claim 1, wherein
filtering condition information indicating a filtering condition of camerawork information is displayed on the camerawork designation screen, and
the display processing unit
performs processing of filtering and displaying the camerawork information according to the filtering condition indicated by the selected filtering condition information as the input information.

4. The information processing device according to claim 1, wherein
the display processing unit
performs processing of displaying information obtained by visualizing a movement trajectory of the viewpoint on the camerawork designation screen.

5. The information processing device according to claim 1, wherein
the display processing unit
performs processing of displaying, on the camerawork designation screen, camera arrangement position information indicating arrangement positions of a plurality of cameras that performs imaging for generating a free viewpoint image.

6. The information processing device according to claim 5, wherein
the display processing unit
performs processing of displaying, on the camerawork designation screen, start point arrangement position information and end point arrangement position information indicating respective positions of a camera serving as a movement start point and a camera serving as a movement end point of the viewpoint among the plurality of cameras.

7. The information processing device according to claim 6, wherein
the display processing unit
performs processing of displaying the start point arrangement position information and the end point arrangement position information, and arrangement position information of cameras other than the camera serving as the movement start point and the camera serving as the movement end point among the plurality of cameras in different modes.

8. The information processing device according to claim 4, wherein
the display processing unit
performs processing of displaying information obtained by visualizing the moving speed of the viewpoint on the camerawork designation screen.

9. The information processing device according to claim 8, wherein
the display processing unit
performs processing of displaying information indicating a period in which the moving speed decreases as information obtained by visualizing the moving speed of the viewpoint.

10. The information processing device according to claim 4, wherein
the display processing unit
performs processing of displaying information obtained by visualizing a field of view from the viewpoint on the camerawork designation screen.

11. The information processing device according to claim 4, wherein
the display processing unit
performs processing of displaying a target that defines a line-of-sight direction from the viewpoint on the camerawork designation screen.

12. The information processing device according to claim 11, further comprising:
a camerawork editing processing unit that updates information on the position of the target in camerawork information according to a change in the position of the target on the camerawork designation screen.

13. The information processing device according to claim 1, wherein
the display processing unit
performs processing of displaying an image obtained by observing a three-dimensional space from the viewpoint on the camerawork designation screen.

14. The information processing device according to claim 13, wherein
the display processing unit
performs processing of displaying an image obtained by rendering a virtual three-dimensional model of a real space as an image obtained by observing a three-dimensional space from the viewpoint.

15. The information processing device according to claim 5, wherein
the display processing unit
performs processing of displaying information notifying a camera in which a change in the field of view has been detected among the plurality of cameras.

16. An information processing method in which
an information processing device
performs processing of displaying a screen indicating, by filtering, camerawork information corresponding to input information of a user among a plurality of pieces of camerawork information, as a camerawork designation screen that receives designation operation of camerawork information that is information indicating at least a movement trajectory of a viewpoint in a free viewpoint image.

17. A program readable by a computer device,
the program causing the computer device to implement a function of performing processing of displaying a screen indicating, by filtering, camerawork information corresponding to input information of a user among a plurality of pieces of camerawork information, as a camerawork designation screen that receives designation operation of camerawork information that is information indicating at least a movement trajectory of a viewpoint in a free viewpoint image.
